(19) United States
(12) Patent Application Publication
(10) Pub. No.: US 2026/0155057 A1
(43) Pub. Date: Jun. 4, 2026

(54) AUDIO-VISUAL BASED SYSTEM FOR INTERACTIVE DIGITAL LEARNING MATERIAL WITH EXERCISES AND ASSESSMENTS

(71) Applicants: Sarath Kakumanu, CHENNAI (IN); Nisha Kakumanu, CHENNAI (IN); Tara Keerthi Kakumanu, CHENNAI (IN)

(72) Inventors: Sarath Kakumanu, CHENNAI (IN); Nisha Kakumanu, CHENNAI (IN); Tara Keerthi Kakumanu, CHENNAI (IN)

(21) Appl. No.: 18/964,737

(22) Filed: Dec. 2, 2024

(51) Int. Cl. G09B 5/06; G09B 7/00

(52) U.S. Cl. CPC G09B 5/065; G09B 7/00

(57) ABSTRACT

Presented is a method and system for digital learning materials that offer an advanced audio-visual interactive experience tailored for foundation courses, language speaking courses, and similar educational contexts. The core aspect of this invention is the integration of audio-visual elements to enhance the learning experience, students can engage with multimedia resources that combine auditory and visual stimuli. This approach caters to diverse learning preferences and promotes better comprehension and retention. To reinforce learning and gauge comprehension, the system includes various exercises and self-assessment tools like quizzes, interactive puzzles, word games, and speaking exercises for language learners. Exercises are designed to be engaging and interactive, encouraging active participation. A key innovation is the integration of audio prompts and feedback within the exercises. Students may listen to audio instructions and record their answers using a microphone. Similarly, audio feedback is provided immediately after completing an exercise, offering reinforcement and guidance.

### TECHNICAL FIELD

The current invention pertains to digital learning materials, specifically focusing on a system and method designed for accessing advanced audio-visual interactive learning content for foundation courses, language speaking courses and the like. This includes audio-enabled learning sessions accompanied by various types of exercises and self-assessment features.

### BACKGROUND OF THE INVENTION

In the current rigorous and thought-provoking educational landscape, students face challenges in thoroughly understanding/comprehending all subjects. Finding teachers with the right pronunciation to teach, Instant answer for the exercise from the digital textbook, time constraints and various other factors hinder their ability to fully engage with the content in digital textbooks. The complexity of certain subject's matters and exercises compels struggling students to revisit the material repeatedly for improved comprehension. Limited learning resources further deepen the difficulty for students in truly having a good foundation in the early stages of learning like kinder garden class and 1,2,3 standard classes.

Over time, the purpose and methods of education have evolved, placing us exactly in the digital age. Consequently, there arises a necessity for an educational system that embraces technological advancements such as digitized audio on touch enabled learning material with different types of audio format for various types of content in the digital learning material which includes text content, picture reading, exercise and assessments. These innovations offer an overabundance of options, benefiting not only learners but also educators and parents. The integration of audio interactive exercises and assessments in foundation class books enhances student engagement and encourages active participation in studies.

In the current scenario, it's noteworthy that some students face learning challenges. Those with learning disabilities often require special education, and a few may find it challenging to adapt to various teaching methodologies or learning features continuously. One notable solution is the incorporation of on touch audio-enabled digital textbooks, accompanied by engaging exercises and assessments. This approach is designed to captivate the attention of children, including those with diverse learning needs and also help the teachers of under developed country to teach their students.

A multitude of students fall into different categories regarding their reading habits: some are enthusiastic readers, some are in the process of developing their reading skills, and others may have lost confidence in their ability to read. Online digital audio books or learning material equipped with the feature of embedded audio reader provide a valuable resource for the latter group, digitalized audio reader enabled learning material helps them to enhance their reading proficiency by remembering sounds better and get proper pronunciations.

Listening to a digital learning material before reading serves as a primer, enhancing students understanding of the subject. The auditory experience aids in learning proper pronunciation, and exposure to different accents sharpens the ear's ability to discern tonal variations. This practice also contributes to maintaining a student's vocabulary beyond their current reading level, fostering improved comprehension of the material.

Audio-embedded learning materials play a crucial role in helping students and teachers overcome pronunciation differences that may exist due to geographical variations. By providing audio embedded subject materials ensure that students receive consistent and accurate pronunciation guidance regardless of their location or the accent of their teacher. This brings up an encouraging learning environment where students can develop proper language skills and pronunciation, ultimately enhancing their comprehension and communication abilities.

This solution addresses the challenge of learning a subject with accurate pronunciation independently, eliminating the need for external assistance and enhancing overall comprehension. Its flexibility allows usage at any time and place. Moreover, the invention introduces a user-friendly mechanism, emphasizing that listening to the complete audio content reinforces the material already read, creating a comprehensive learning experience.

Additionally, engaging in audio interactive exercises and assessments repeatedly is an effective strategy for students to become familiar with the subject content and develop a thorough understanding of the material. Repetition is key to reinforcing learning and retention. By participating in audio interactive activities multiple times, students reinforce their comprehension and reinforce key concepts more effectively. Moreover, the interactive nature of these exercises in the audio embedded digital learning material keeps students engaged and actively involved in the learning process, leading to deeper understanding and mastery of the subject matter.

In the existing landscape, there are audio readers for online documents or application. But all the applications lack the ability to create advanced audio interactive digital textbooks with most advanced features. Notably, there's a gap in addressing the learning needs of students with disabilities or providing anticipatory learning content for upcoming sessions. While some tools allow learning through external Text to Speech readers, they lack built-in support. Most applications predominantly offer visual content, which falls short of solving the diverse needs of students.

Students require multiple methods and options tailored to their unique capabilities. For instance, visually impaired students or those more inclined to auditory learning need audio readers to swiftly grasp and memorize content, improving pronunciation. Even traditionally abled students can benefit from audio readers for a leisurely understanding of topics. A robust education system should accommodate diverse student needs without bias, emphasizing customization in an era where individual comfort levels are paramount.

In many applications, the audio content of the digital textbook is stored separately, lacking a visual connection with the digital book content. Furthermore, there is an absence of features such as instant feedback during exercises, which is instrumental in fostering greater student interaction, enhancing subject understanding, and facilitating immediate learning correction in case of incorrect answers. The applications also lack a mechanism to highlight words in different color based on the accuracy of responses while reading the content. Additionally, there is no provision to listen to the audio of specific content within the book.

Therefore, there is a need for a user-friendly mechanism to address the challenges faced by education stakeholders, including students, teachers, and parents especially at the foundation level of education. This solution involves providing interactive digital learning materials or textbooks with a proficient on touch audio reader facility and audio-visual interaction features. This comprehensive approach aims to enhance pronunciation, enrich vocabulary, improve students reading skills, facilitate better understanding, and promote easy learning, irrespective of the time and location.

Based on the foregoing, it is believed that a need exists for an improved digital learning material which serves a dual-purpose catering not only to academically oriented students, learning-disabled students but also, teachers, and parents who can conveniently listen to the content of the digital textbook to help the students in learning their subject. Especially at the foundation level of education, preparing for the upcoming class allowing teachers to familiarize themselves with the lesson beforehand or assisting parents in guiding their children through a quick revision before scheduled classes. For visually impaired and mute students, this feature provides the flexibility to learn at their convenience. Additionally, it accommodates students who excel at auditory learning, ensuring that diverse needs across the educational spectrum are met and satisfied.

Certainly, there is a demand for an interactive audio on touch and audio-visual enabled digital learning material that should encompass vibrant and varied color formats, offering diverse internal exercises and assessments. These activities may involve interactive methods such as matching of the content using drag and drop method, answer as a text input for the questions with instant audio feedback and check system to confirm the correct answer, enhancing visual observation through see-and-draw exercises, fostering creativity through independent drawing.

And also, there also a need for a digital learning material with integrated visual features such as circling words with color variation and providing audio feedback which enhances comprehension and reinforces learning. Similarly, using color variation for numbers and matching them with relevant pictures, along with instant audio feedback, promotes understanding and retention. Additionally, allowing students to select the correct visual images through radio buttons and providing options to answer as text or numbers while viewing pictures with a check option offers versatility and accommodates different learning preferences. This multifaceted approach is designed to cater to diverse learning styles and maximize student engagement, ultimately fostering a more effective and enriching learning experience especially in foundation level schooling and also which helps to learn a new language.

Moreover, there is a need to enhance students'mathematical skills and support those who may struggle with mathematical abilities. This can be achieved by incorporating a calculator feature in the digital book that facilitates quick and accurate calculations of numbers. This tool serves as a valuable resource in aiding students with various levels of mathematical proficiency.

Further there is a need for finding out the words in the cross-word puzzle digitally in the digital textbook which helps the students to stimulate and challenge the mind and give the mental agility. It increases the problem-solving skill, and most importantly memory recall.

There also a need for picture colouring activities in the digital book as per the questions given that stimulates intellectual functions such as visual perception, spatial awareness, and pattern recognition for the students. Recognizing shapes and color, as well as identifying relationships between objects, can support cognitive development in children or student. Colouring the pictures in and out, up and down, selective portion of the picture fine tunes the motor skills of the student. Engaging in colouring activities promotes focus and concentration. It requires attention to detail and staying within the lines, which can improve concentration and mindfulness. Colouring requires precise hand movements and coordination, which helps develop fine motor skills, particularly in children. Holding and manoeuvring colouring tools strengthens hand muscles and improves dexterity.

There is a need available for the digital learning material with the audio descriptions of the picture or drawing which helps in the active engagement of the students with the learning material.

In most of the existing learning material the virtual keyboard feature is not readily available, which can create a language barrier for users. Without access to a virtual keyboard, learners may feel less engaged and involved in the subject content, particularly if they are more comfortable using a language other than the default language of the learning material.

Based on the foregoing there is also a need for embedded keyboard with multi lingual facility which increases accessibility and convenience for learners with physical disabilities or limitations that affect their ability to use a physical keyboard, an embedded keyboard in the digital learning material provides an accessible alternative. It helps learners or students to engage in their known or own language which cannot happen in physical keyboard. It allows the students to participate fully in digital learning activities without barriers. It offers convenience for students who may be accessing the digital learning material on devices without physical keyboards, such as tablets or smartphones. It eliminates the need for external input devices and streamlines the learning experience. This dynamic and visually engaging approach not only makes learning more attractive but also fosters an easy and effective learning experience for users. Additionally, there is a need for users to easily answer questions by selecting the appropriate response from a drop-down list provided.

Based on the foregoing, there is a growing demand for online digital learning materials equipped with audio-enabled exercises and assessments featuring advanced voice-based question answering capabilities. This innovative feature empowers users to respond to questions using their microphone, enhancing interactivity, engagement, and accessibility in the learning process.

### SUMMARY OF THE INVENTION

The following summary is provided to facilitate an understanding of some of the innovative features unique to the disclosed embodiment and is not intended to be a full description.

It is an object of the disclosed embodiment aims to offer a digitized audio-visual embedded learning material featuring interactive exercises and self-assessment capabilities. This resource can be accessed repeatedly until students achieve familiarity or thorough understanding of the subject content. The invention encourages active student engagement by providing multiple interactive features within the on-touch audio-embedded digital learning material or book. The “On Click” or “On Touch” over the text content functionality enables students to easily access audio content, allowing them to listen to the subject material multiple times and engage with various question-answer formats to assess their understanding. This approach promotes flexible learning and comprehensive understanding of the subject matter.

Another object of a disclosed embodiment is to provide a digitized learning material embedded with different kind of audios on touch for the subject content with multi type of exercises and assessments which includes interactive exercises such as learning from pictures, match the relevant content by drag and drop methods, connecting the lines by viewing the picture. Confirm answer for the question by instant audio feedback, inbuilt calculator for solving the problems and more.

Yet, another object of the disclosed embodiment helps the educators with the Interactive exercises which captures children's attention and maintain their interest throughout the lesson. This engagement is crucial for effective learning as it keeps them actively involved with the digital learning material.

Another object of the disclosed embodiments is to offer an audio embedded digital learning material capable of adapting to individual learning styles and paces. Through interactive exercises, students can advance at their preferred speed, thereby facilitating a personalized learning experience tailored to their unique needs with instant audio feedback. This adaptability enhances engagement and comprehension, empowering students to learn effectively according to their abilities and preferences.

One more object of the disclosed embodiment is to provide instant audio feedback within the interactive exercises and assessments in audio enabled digital learning material. This feature enables students to promptly assess their performance, identify areas for improvement, and reinforce their understanding of the lesson. Instant feedback enhances the learning process by providing students with timely guidance and reinforcement, thereby promoting continuous improvement and mastery of the subject matter.

Furthermore, an object of the disclosed embodiments is to provide on touch audio interactive content within the digital learning material that integrates audio, visuals, and hands-on activities. This multisensory approach caters to diverse learning styles, appealing to auditory, visual, and kinaesthetic learners alike. By engaging multiple senses, this approach enhances comprehension and retention of the subject material, making the learning experience more effective and enjoyable for young students.

Another object of the disclosed embodiments is to offer an interactive on touch audio learning material featuring engaging exercises and assessments that incorporate gamification elements. By integrating playful and interactive components, such as puzzles, challenges, and rewards, the learning process is transformed into a fun and rewarding experience. This approach not only motivates students to actively participate but also fosters a positive association with learning, making it more enjoyable memorable.

Another aspect of the disclosed embodiments is to provide an audio-embedded “on click” or “one touch” digital learning material which is accessible across various devices, including laptop computers, desktop computers, mobile communication devices, tablet computers, and more. This versatility enables students to access the material anytime and anywhere, accommodating different schedules and preferences. Whether at home, in transit, or in a classroom setting, students can engage with the learning material conveniently, providing flexibility and opportunities for additional practice as needed.

One more aspect of the disclosed embodiments is to provide quizzes and assessments presented in a digital format with audio-visual enhancements offer immediate feedback to students. This interactive approach not only evaluates their understanding of the material but also reinforces their learning. By receiving instant feedback on their performance, students can quickly identify areas of strength and weakness, helping them to focus their efforts on subject content that need improvement. This real-time audio and visual feedback enhance the learning process, promoting deeper comprehension and retention of the study material.

Another aspect of the disclosed embodiments is to offer picture drawing exercises accompanied by audio and visual guidance. This feature assists students in enhancing their creativity and grasping skills. By providing step-by-step instructions and audio cues, students can effectively visualize and execute their drawings, fostering creativity and improving their ability to comprehend and replicate visual information. This multisensory approach encourages active engagement and skill development, enriching the learning experience for students.

Another aspect of the disclosed embodiments is to offer voice feedback and visual responses to confirm or appreciate the correct answer, or to allow students to select or write the correct answer. This feature enhances the interactive learning experience by providing immediate feedback and reinforcement. When students provide the correct answer, they receive positive affirmation through voice feedback and visual cues, which reinforces their understanding and boosts their confidence. Additionally, when students select or write the correct answer, they receive confirmation through both auditory and visual channels, facilitating comprehension and learning. Overall, this aspect of the disclosed embodiments enhances student engagement and promotes effective learning outcomes.

Another aspect of the disclosed embodiments is to offer an option for students to circle the correct word/images/pictures with coloured lines or select the correct word by clicking a radio button, with confirmation provided through audio feedback. This feature enhances interactivity and engagement by allowing students to actively participate in the learning process. When students select the correct word and circle it with coloured lines, they receive auditory confirmation, which reinforces their understanding and encourages further interaction with the material. This interactive approach promotes comprehension and retention of the subject matter.

Another aspect of the disclosed embodiments is to provide a facility for performing mathematical calculations using the embedded calculator. This feature enhances the learning experience by enabling students to engage in mathematical exercises and problem-solving activities directly within the digital learning material. By integrating a calculator into the platform, students can perform calculations efficiently and accurately.

Another aspect of the disclosed embodiments is to provide picture descriptions for images within the digital learning material. When clicked, these descriptions provide detailed information about the picture, aiding students in understanding its context and relevance to the subject matter. This feature enhances comprehension and promotes deeper engagement with the content by offering additional insights and explanations.

One more aspect of the disclosed embodiments is to facilities students to gain a better understanding of the visual elements(pictures/images) presented in the audio embedded digital learning material, facilitating their learning process and reinforcing key concepts. This aspect enriches the learning experience through visual and audio guidance which promotes a more comprehensive understanding of the subject matter.

Another aspect of the disclosed embodiments is to offer audio-embedded digital learning material with the option for Picture Color Filling, enhancing student involvement and engagement. This aspect of the feature allows students to interact with visual content by selecting and applying color to pictures within the material. By providing audio guidance along with the color filling option, students receive instructions and feedback as they engage with the activity.

Another aspect of the disclosed embodiments is to provide an inbuilt language keyboard facility for students to complete exercises or assessments in their preferred language in the digital learning material. This feature complements the audio-embedded learning material's support for multi-lingual learning by enabling students to input text or responses in their known language directly within the digital platform. The Inbuilt keyboard enhances accessibility and inclusivity by accommodating learners from diverse linguistic backgrounds, ensuring that all students can fully engage with the material in their preferred language. This aspect promotes a more personalized and effective learning experience for students, fostering comprehension and retention of the subject matter.

Another aspect of the disclosed embodiments is to offer word puzzles within the digital learning material, where hidden words stimulate concentration and cognitive skills for the students. These puzzles challenge students to search for specific words hidden within a grid of letters, requiring focused attention and problem-solving abilities to identify and locate each word. By engaging in word puzzles, students enhance their concentration, visual perception, and cognitive processing skills while reinforcing vocabulary and spelling knowledge. This aspect adds an interactive and enjoyable dimension to the digital learning experience, promoting active engagement and mental stimulation.

Another aspect of the disclosed embodiments is to offer an option for students to select correct or incorrect objects, distinguish between in and out objects, or make other similar distinctions based on visual cues presented in pictures. This feature enhances interactive learning by prompting students to analyse visual content and make decisions based on predetermined criteria. By engaging in activities that require them to identify and categorize objects, students develop critical thinking skills, visual perception, and problem-solving abilities. This aspect adds an engaging and educational component to the digital learning material, promoting active participation and comprehension of the subject matter.

Another aspect of the disclosed embodiments is to provide users with the option to answer questions in exercises and assessments through voice messages, with instant feedback provided based on the answers given by the user.

Another aspect of the disclosed embodiments is to offer users the option to select the correct answer from a drop-down list, with verification provided through audio feedback.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of the embodiments of the present disclosure will be more apparent in the following description taken in conjunction with the accompanying drawings.

FIG. 1 illustrates a graphical representation of the user(student) interface of the audio-visual interactive digital learning material with learning exercises and assessments. It showcases an option enabling users to listen to the audio of the subject content with a simple “single click” or “one touch” over the text content, in accordance with the disclosed embodiments.

FIG. 2 illustrates a graphical representation of the user(student) interface of the audio-visual interactive digital learning material with learning exercises and assessments. Here, the user can click on the subject content to initiate listening to the audio of the subject material with a straightforward “single click” or “one touch” over the text content, in accordance with the disclosed embodiments.

FIG. 3 illustrates a graphical representation of the user(student) interface of the audio-visual interactive digital learning material with learning exercises and assessments. In this illustration, the user can listen to the audio of the subject content by simply clicking or tapping once on the text, users can listen to the audio corresponding to the content, in accordance with the disclosed embodiments.

FIG. 4 illustrates a graphical representation of the user(student) interface of the audio-visual interactive digital learning material with learning exercises and assessments. In this depiction, the student can draw the picture in a step-by-step process with audio guidance accompanied by visual image support. The user clicks on the step 1 image to initiate drawing the picture and selects their favourite color to complete the drawing, in accordance with the disclosed embodiments.

FIG. 5 illustrates a graphical representation of the user(student) interface of the audio-visual interactive digital learning material with learning exercises and assessments. In this scenario, the student draws the picture as viewed in the step 1 process with the support of audio guidance, in accordance with the disclosed embodiments.

FIG. 6 illustrates a graphical representation of the user(student) interface of the audio-visual interactive digital learning material with learning exercises and assessments. Here, the user clicks on the step 2 image to proceed with drawing the picture after completing the step 1 process, in accordance with the disclosed embodiments.

FIG. 7 illustrates a graphical representation of the user(student) interface of the audio-visual interactive digital learning material with learning exercises and assessments. In this scenario, the student draws the picture as viewed in the step 2 process with the support of audio guidance after completing the step 1 process, in accordance with the disclosed embodiments.

FIG. 8 illustrates a graphical representation of the user(student) interface of the audio-visual interactive digital learning material with learning exercises and assessments. Here, the user clicks on the step 3 image to advance in drawing the picture after completing the step 2 process, in accordance with the disclosed embodiments.

FIG. 9 illustrates a graphical representation of the user(student) interface of the audio-visual interactive digital learning material with learning exercises and assessments. In this scenario, the student draws the picture as viewed in the step 3 process with the support of audio guidance after completing the step 2 process, in accordance with the disclosed embodiments.

FIG. 10 illustrates a graphical representation of the user(student) interface of the audio-visual interactive digital learning material with learning exercises and assessments. In this scenario, the student clicks the download icon to download the drawn picture either in actual size or in A4 format, in accordance with the disclosed embodiments.

FIG. 11 illustrates a graphical representation of the user(student) interface of the audio-visual interactive digital learning material with learning exercises and assessments. In this scenario, the student views the downloaded picture in actual size format, in accordance with the disclosed embodiments.

FIG. 12 illustrates a graphical representation of the user(student) interface of the audio-visual interactive digital learning material with learning exercises and assessments. In this scenario, students can access the picture on the drawing pad. Users who prefer not to draw directly on the pad can choose to download the image, draw and color it manually and subsequently upload their completed drawing. Here, the user is preparing to download the diagram from the drawing pad with the intention of completing the drawing manually as per the question raised, in accordance with the disclosed embodiments.

FIG. 13 illustrates a graphical representation of the user(student) interface of the audio-visual interactive digital learning material with learning exercises and assessments. In this scenario, students have the option to access the downloaded picture from their device, enabling them to take a printout for manual drawing, colouring, and decoration, in accordance with the disclosed embodiments.

FIG. 14 illustrates a graphical representation of the user(student) interface of the audio-visual interactive digital learning material with learning exercises and assessments. In this depiction, the student has successfully completed the drawing manually, adding colouring and decoration. The user can now view the fully drawn, coloured, and decorated image on their device, in accordance with the disclosed embodiments.

FIG. 15 illustrates a graphical representation of the user(student) interface of the audio-visual interactive digital learning material with learning exercises and assessments. In this scenario, students utilize the upload button on the drawing pad within the digital learning material interface to upload the manually drawn, coloured, and decorated picture, as per the instructions provided, in accordance with the disclosed embodiments.

FIG. 16 illustrates a graphical representation of the user(student) interface of the audio-visual interactive digital learning material with learning exercises and assessments. In this scenario, students proceed to upload the digital copy of the manually completed drawing, following the instructions within the audio-visual interactive digital learning material interface, in accordance with the disclosed embodiments.

FIG. 17 illustrates a graphical representation of the user(student) interface of the audio-visual interactive digital learning material with learning exercises and assessments. In this scenario, students can view the manually drawn picture in the digital pad. If requires the user can do changes or modification in the drawing, in accordance with the disclosed embodiments.

FIG. 18 illustrates a graphical representation of the user(student) interface of the audio-visual interactive digital learning material with learning exercises and assessments. Here, the student can access the drawing board embedded within the audio interactive digital learning material. The user can draw pictures, color them, undo and redo actions while drawing, and erase parts of the pictures. Additionally, the drawn pictures can be downloaded in the required format, in accordance with the disclosed embodiments.

FIG. 19 illustrates a graphical representation of the user (student) interface of the audio-visual interactive digital learning material with learning exercises and assessments. In this depiction, the student has begun drawing on the drawing board, selecting interesting color to enhance the illustration, in accordance with the disclosed embodiments.

FIG. 20 illustrates a graphical representation of the user (student) interface of the audio-visual interactive digital learning material with learning exercises and assessments. In this depiction, the student clicks the undo button to remove the last action taken in the picture, in accordance with the disclosed embodiments.

FIG. 21 illustrates a graphical representation of the user (student) interface of the audio-visual interactive digital learning material with learning exercises and assessments. In this depiction, here, the student can observe the drawing after utilizing the undo function. Additionally, the user clicks the erase button to activate it, allowing for the erasure of any mistakes or errors in the diagram, in accordance with the disclosed embodiments.

FIG. 22 illustrates a graphical representation of the user (student) interface of the audio-visual interactive digital learning material with learning exercises and assessments. In this depiction, the student erases mistakes in the drawing that was previously made, in accordance with the disclosed embodiments.

FIG. 23 illustrates a graphical representation of the user (student) interface of the audio-visual interactive digital learning material with learning exercises and assessments. In this depiction, the student completed the drawing erases mistakes in the drawing that was previously made, in accordance with the disclosed embodiments.

FIG. 24 illustrates a graphical representation of the user(student) interface of the audio-visual interactive digital learning material with learning exercises and assessments. In this scenario, the student clicks the download icon to download the drawn picture, either in actual size or in A4 format. Here, the user selects the A4 size option to download the drawn picture, in accordance with the disclosed embodiments.

FIG. 25 illustrates a graphical representation of the user(student) interface of the audio-visual interactive digital learning material with learning exercises and assessments. In this scenario, the student views the downloaded picture in A4 size format, in accordance with the disclosed embodiments.

FIG. 26 illustrates a graphical representation of the user(student) interface of the audio-visual interactive digital learning material with learning exercises and assessments. In this scenario, the student clicks the download icon to download the drawn picture, either in actual size or in A4 format. Here, the user selects the actual size option to download the drawn picture, in accordance with the disclosed embodiments.

FIG. 27 illustrates a graphical representation of the user(student) interface of the audio-visual interactive digital learning material with learning exercises and assessments. In this scenario, the student views the downloaded picture in actual size format, in accordance with the disclosed embodiments.

FIG. 28 illustrates a graphical representation of the user(student) interface of the audio-visual interactive digital learning material with learning exercises and assessments. In this depiction, the student can observe the picture alongside the text content. Questions have been formulated based on both the text content and the provided picture. This setup aids students in thinking logically before answering the questions, based on the provided picture, in accordance with the disclosed embodiments.

FIG. 29 illustrates a graphical representation of the user(student) interface of the audio-visual interactive digital learning material with learning exercises and assessments, the student has started filling colours in the picture according to the question raised, in accordance with the disclosed embodiments.

FIG. 30 illustrates a graphical representation of the user(student) interface of the audio-visual interactive digital learning material with learning exercises and assessments, here the student has finished filling in the colours in the picture according to the question raised, according to the question raised, in accordance with the disclosed embodiments.

FIG. 31 illustrates a graphical representation of the user(student) interface of the audio-visual interactive digital learning material with learning exercises and assessments. In this scenario, the student clicks the download icon to download the coloured picture as per the question raised, either in actual size or in A4 format. Here, the user selects the actual size option to download the drawn picture, in accordance with the disclosed embodiments.

FIG. 32 illustrates a graphical representation of the user(student) interface of the audio-visual interactive digital learning material with learning exercises and assessments. In this scenario, the student views the downloaded picture in actual format, in accordance with the disclosed embodiments.

FIG. 33 illustrates a graphical representation of the user(student) interface of the audio-visual interactive digital learning material with learning exercises and assessments. In this scenario, the student clicks the download icon to download the coloured picture as per the question raised, either in actual size or in A4 format. Here, the user selects the A4 size option to download the drawn picture, in accordance with the disclosed embodiments.

FIG. 34 illustrates a graphical representation of the user(student) interface of the audio-visual interactive digital learning material with learning exercises and assessments. In this scenario, the student views the downloaded picture in A4 size format, in accordance with the disclosed embodiments.

FIG. 35 illustrates a graphical representation of the user(student) interface of the audio-visual interactive digital learning material with learning exercises and assessments. In this illustration, the student can observe the picture alongside questions relevant to it, aiding logical thinking before answering. The picture depicts items both inside and outside of the illustrations (here the picture shows the flowers present both inside and outside of the basket, and the girl sitting inside the car and a man standing outside the car), the task is to select the items (flower or girl) inside the illustration. In this scenario, the user clicks on an item(flower) outside the basket in the picture, in accordance with the disclosed embodiments.

FIG. 36 illustrates a graphical representation of the user(student) interface of the audio-visual interactive digital learning material with learning exercises and assessments. The selection of answers is visually distinct, with different color and geometric patterns used for correct and incorrect answers. In this scenario, an item outside the illustration was selected. The selected answer is displayed inside an oval shape in red, indicating that the answer is incorrect. Additionally, an audio message accompanies the selection, providing positive reinforcement such as “well done” or “correct answer” for right answers, and guidance like “try again” or “wrong answer” for incorrect ones. In this instance, the audio message indicates either “try again” or “wrong answer”, in accordance with the disclosed embodiments.

FIG. 37 illustrates a graphical representation of the user(student) interface of the audio-visual interactive digital learning material with learning exercises and assessments. In this scenario, the user clicks on an item(flower) inside the illustration(basket) in the picture, in accordance with the disclosed embodiments.

FIG. 38 illustrates a graphical representation of the user(student) interface of the audio-visual interactive digital learning material with learning exercises and assessments. In this scenario, upon recognizing that the previously chosen answer was incorrect, the student has made a subsequent attempt to select the correct answer. The selected answer is displayed inside a round shape in green, indicating that the answer is correct. Additionally, an audio message accompanies the selection, providing positive reinforcement such as “well done” or “correct answer” for correct answer, in accordance with the disclosed embodiments.

FIG. 39 illustrates a graphical representation of the user(student) interface of the audio-visual interactive digital learning material with learning exercises and assessments. In this illustration, the student is tasked with identifying the odd items out by selecting the correct one. The selection of answers is visually distinguished, with different color and geometric patterns used for correct and incorrect answers. The correctly selected answer is displayed inside a circle in green, while the wrong answer is displayed inside an oval in red, indicating that it is incorrect. Furthermore, an audio message accompanies the selection, offering positive reinforcement such as “well done” or “correct answer” for correct responses, and guidance like “try again” or “wrong answer” for incorrect ones, in accordance with the disclosed embodiments.

FIG. 40 illustrates a graphical representation of the user(student) interface of the audio-visual interactive digital learning material with learning exercises and assessments. In this illustration, the student can observe the picture alongside question relevant to it, aiding logical thinking before answering. The user is in the process of selecting an item from a row in the picture. In this particular scenario, the user clicks on an incorrect item, as denoted by the item being encircled in red within an oval shape. Additionally, an accompanying audio message communicates feedback, such as “try again” or “wrong answer”, in accordance with the disclosed embodiments.

FIG. 41 illustrates a graphical representation of the user(student) interface of the audio-visual interactive digital learning material with learning exercises and assessments. In this illustration, the student can observe the picture alongside question relevant to it, aiding logical thinking before answering. Upon recognizing that the previously selected item for the answer was incorrect, the student has made a subsequent attempt to select the correct item for the answer. The user is in the process of selecting an item from a row in the picture. In this particular scenario, the user clicks on a correct item, as denoted by the item being encircled in green within a circle. Additionally, an accompanying audio message communicates feedback, such as “well done” or “correct answer”, in accordance with the disclosed embodiments.

FIG. 42 illustrates a graphical representation of the user(student) interface of the audio-visual interactive digital learning material with learning exercises and assessments. Here, the student can observe the answers (pictures) alongside corresponding questions. The task for the student is to select the correct answer from the options provided. This setup facilitates logical thinking before answering the questions, based on the presented pictures, in accordance with the disclosed embodiments.

FIG. 43 illustrates a graphical representation of the user(student) interface of the audio-visual interactive digital learning material with learning exercises and assessments. In this particular scenario, the user clicks on an incorrect item. An audio message communicates feedback, such as “try again” or “wrong answer”, in accordance with the disclosed embodiments.

FIG. 44 illustrates a graphical representation of the user(student) interface of the audio-visual interactive digital learning material with learning exercises and assessments. In this particular scenario, upon recognizing that the previously selected item for the answer was incorrect, the student has made a subsequent attempt to select the correct item for the answer and the user clicks on a correct item. An audio message communicates feedback, such as “well done” or “correct answer”, in accordance with the disclosed embodiments.

FIG. 45 illustrates a graphical representation of the user(student) interface of the audio-visual interactive digital learning material with learning exercises and assessments. In this scenario, the user is tasked with matching items on both sides correctly. The user can drag and drop the images on the right side to the relevant content on the left side. This interactive exercise enhances engagement and comprehension as students actively participate in matching items, aligning them with the corresponding content, in accordance with the disclosed embodiments.

FIG. 46 illustrates a graphical representation of the user(student) interface of the audio-visual interactive digital learning material with learning exercises and assessments. Upon recognizing that the previously selected answer was incorrect, the student has made a subsequent attempt to select the correct answer. In this depiction, the user is dragging one of the images on the right side to place it next to the corresponding content on the left side. This interactive drag-and-drop exercise encourages active participation and reinforces learning by aligning images with their related content, enhancing comprehension and retention, in accordance with the disclosed embodiments.

FIG. 47 illustrates a graphical representation of the user(student) interface of the audio-visual interactive digital learning material with learning exercises and assessments. Here, the user has successfully dropped an image on the right side next to the corresponding content on the left side. Upon completing the matching exercise, the user receives immediate audio feedback indicating whether the match is correct or incorrect, encouraging active participation and providing real-time reinforcement of learning. In this case, the user received audio feedback stating “try again” or “wrong answer” for matching the content and image incorrectly. This immediate feedback helps guide the user to correct their mistake and reinforces the learning process, in accordance with the disclosed embodiments.

FIG. 48 illustrates a graphical representation of the user(student) interface of the audio-visual interactive digital learning material with learning exercises and assessments. In this depiction, the user is dragging one of the images on the right side to place it next to the corresponding content on the left side, in accordance with the disclosed embodiments.

FIG. 49 illustrates a graphical representation of the user(student) interface of the audio-visual interactive digital learning material with learning exercises and assessments. Here, the user has successfully dropped an image on the right side next to the corresponding content on the left side. Upon completing the matching exercise, the user receives immediate audio feedback indicating whether the match is correct or incorrect. In this case, the user received audio feedback stating “well done” or “correct answer” for matching the content and image incorrectly. This immediate feedback helps and guide the user to correct their mistake and reinforces the learning process, in accordance with the disclosed embodiments.

FIG. 50 illustrates a graphical representation of the user(student) interface of the audio-visual interactive digital learning material with learning exercises and assessments. In this scenario, the user is tasked with drawing a line inside the box according to the question prompt, without touching or crossing the line. Here, the user is asked to draw the line from the smallest number to the largest number, where the numbers are arranged in a shuffled manner within the box. This activity aims to engage the user in a logical thinking exercise while practicing numerical sequencing, in accordance with the disclosed embodiments.

FIG. 51 illustrates a graphical representation of the user(student) interface of the audio-visual interactive digital learning material with learning exercises and assessments. In this illustration, the user is actively engaged in drawing a line inside the box as instructed by the question prompt, ensuring that the line does not intersect or touch itself. The task requires the user to draw the line from the smallest number to the largest number, with the numbers arranged randomly within the box in accordance with the disclosed embodiments.

FIG. 52 illustrates a graphical representation of the user(student) interface of the audio-visual interactive digital learning material with learning exercises and assessments. In this depiction, the user has successfully completed the task of drawing a line from the smallest number to the largest number inside the box, adhering to the instructions provided. The user's ability to accurately execute the task demonstrates their understanding of numerical sequencing and spatial awareness, thereby enhancing their problem-solving skills within the interactive digital learning environment. Users have the option to download their completed work in various file formats enhances their experience and allows them to keep a record of their progress, in accordance with the disclosed embodiments.

FIG. 53 illustrates a graphical representation of the user(student) interface of the audio-visual interactive digital learning material with learning exercises and assessments. In this scenario, the user can access the calculator tool embedded within the digital learning material interface, allowing them to perform calculations conveniently as part of their learning experience, in accordance with the disclosed embodiments.

FIG. 54 illustrates a graphical representation of the user(student) interface of the audio-visual interactive digital learning material with learning exercises and assessments. In this depiction, the user is utilizing the embedded calculator within the digital learning material interface to solve a mathematical question, demonstrating the practical application of mathematical concepts within the interactive learning environment, in accordance with the disclosed embodiments.

FIG. 55 illustrates a graphical representation of the user(student) interface of the audio-visual interactive digital learning material with learning exercises and assessments. In this illustration, the user has successfully completed the calculations using the embedded calculator within the digital learning material interface and has found the solution for the question, showcasing the efficacy of interactive tools in facilitating mathematical problem-solving within the learning environment, in accordance with the disclosed embodiments.

FIG. 56 illustrates a graphical representation of the user(student) interface of the audio-visual interactive digital learning material with learning exercises and assessments. In this representation, the user navigates through the interactive puzzle box to reveal hidden words, an engaging feature of the learning material designed to enhance problem-solving skills and cognitive abilities, in accordance with the disclosed embodiments.

FIG. 57 illustrates a graphical representation of the user(student) interface of the audio-visual interactive digital learning material with learning exercises and assessments. In this illustration, the user successfully identifies and marks the hidden words within the puzzle box based on the question presented and if required the user can click the download button to download the solved puzzle for further reference, in accordance with the disclosed embodiments.

FIG. 58 illustrates a graphical representation of the user(student) interface of the audio-visual interactive digital learning material with learning exercises and assessments. In this depiction, the user engages with the picture and provides answers to questions raised based on the content of the pictures. The user can provide answers either by typing them in or by using voice input. This interactive activity fosters engagement and comprehension within the learning material, in accordance with the disclosed embodiments.

FIG. 59 illustrates a graphical representation of the user(student) interface of the audio-visual interactive digital learning material with learning exercises and assessments. In this depiction, users are prompted to respond to a question related to the picture content. The flexibility is provided for users to input their answer using either numerical characters or express the numbers in words (alphabetical characters). Here, the user inputs the answer to the question using numerical characters. The system provides immediate interactive audio feedback. If the answer is correct, the user receives positive feedback such as “well done” or “correct answer.” If the answer is incorrect, the system prompts the user to try again with messages like “try again” or “wrong answer.” In this case, the user received audio feedback stating “well done” or “correct answer”. This interactive approach accommodates different learning styles and enhances user engagement with the learning material, in accordance with the disclosed embodiments.

FIG. 60 illustrates a graphical representation of the user(student) interface of the audio-visual interactive digital learning material with learning exercises and assessments. In this depiction, users are prompted to respond to a question related to the picture content. Here, the user inputs the numerical answer using words (alphabetical characters). The system provides immediate interactive audio feedback. In this case, the user received audio feedback stating “well done” or “correct answer”, in accordance with the disclosed embodiments.

FIG. 61 illustrates a graphical representation of the user(student) interface of the audio-visual interactive digital learning material with learning exercises and assessments. In this depiction, the user engages with the learning material by clicking on the microphone icon to answer a question using voice mode. This feature enables users to interact with the material in a hands-free manner, facilitating a more dynamic and immersive learning experience, in accordance with the disclosed embodiments.

FIG. 62 illustrates a graphical representation of the user(student) interface of the audio-visual interactive digital learning material with learning exercises and assessments. In this illustration, the user has the option to stop recording their voice message by clicking on the stop icon after answering a question. They can then proceed to send the recorded voice message as their answer, providing a convenient and interactive way to engage with the learning material., in accordance with the disclosed embodiments.

FIG. 63 illustrates a graphical representation of the user(student) interface of the audio-visual interactive digital learning material with learning exercises and assessments. In this depiction, the user can view the typed answer generated from the voice message they sent. The user clicks the answer verification icon to get the feedback of the answer immediately. This feature also allows users to verify the accuracy of their spoken response and provides additional support for understanding and reviewing their answers within the interactive learning environment, in accordance with the disclosed embodiments.

FIG. 64 illustrates a graphical representation of the user(student) interface of the audio-visual interactive digital learning material with learning exercises and assessments. In this case, the user received audio feedback stating “try again” or “wrong answer” for filling the incorrect answer. Additionally, a visual notification icon accompanies the audio feedback, further emphasizing the incorrect response. This prompt and direct feedback mechanism aids the user in identifying and correcting mistakes, thereby facilitating the learning process effectively within the digital learning environment., in accordance with the disclosed embodiments.

FIG. 65 illustrates a graphical representation of the user(student) interface of the audio-visual interactive digital learning material with learning exercises and assessments. In this depiction, the user engages with the learning material by clicking on the microphone icon to answer a question using voice mode. This feature enables users to interact with the material in a hands-free manner, facilitating a more dynamic and immersive learning experience, in accordance with the disclosed embodiments.

FIG. 66 illustrates a graphical representation of the user(student) interface of the audio-visual interactive digital learning material with learning exercises and assessments. In this depiction, the user engages with the picture and provides answers to questions raised based on the content of the pictures. The user has the option to stop recording their voice message by clicking on the stop icon after answering a question. They can then proceed to send the recorded voice message as their answer, This interactive activity fosters engagement and comprehension within the learning material, in accordance with the disclosed embodiments.

FIG. 67 illustrates a graphical representation of the user(student) interface of the audio-visual interactive digital learning material with learning exercises and assessments. In this depiction, the user can view the typed answer generated from the voice message they sent. The user clicks the answer verification icon to get the feedback of the answer immediately. This feature also allows users to verify the accuracy of their spoken response and provides additional support for understanding and reviewing their answers within the interactive learning environment, in accordance with the disclosed embodiments.

FIG. 68 illustrates a graphical representation of the user(student) interface of the audio-visual interactive digital learning material with learning exercises and assessments. In this case, the user received audio feedback stating “well done” or “correct answer” for filling the correct answer. Additionally, a visual notification icon accompanies the audio feedback, further emphasizing the correct response thereby facilitating the learning process effectively within the digital learning environment., in accordance with the disclosed embodiments.

FIG. 69 illustrates a graphical representation of the user(student) interface of the audio-visual interactive digital learning material with learning exercises and assessments. Here, users are presented with a picture, and questions relevant to the picture are raised for the user to answer. This interactive approach engages students by connecting visual content with corresponding inquiries, promoting deeper understanding and retention of the subject matter, in accordance with the disclosed embodiments.

FIG. 70 illustrates a graphical representation of the user(student) interface of the audio-visual interactive digital learning material with learning exercises and assessments. In this illustration, the student is tasked with selecting the correct answer from the multiple options given. The selection of answers is visually distinguished, with different colours used for correct and incorrect answers. The correctly selected answer is displayed inside a green circle, while the wrong answer is displayed inside a red circle, indicating that it is incorrect. Furthermore, an audio message accompanies the selection, offering positive reinforcement such as “well done” or “correct answer” for correct responses, and guidance like “try again” or “wrong answer” for incorrect ones, in accordance with the disclosed embodiments.

FIG. 71 illustrates a graphical representation of the user(student) interface of the audio-visual interactive digital learning material with learning exercises and assessments. In this illustration, the student can observe the picture alongside question relevant to it, aiding logical thinking before answering. The user is in the process of selecting the correct answer for the question raised relevant to the picture. In this particular scenario, the user clicks on an incorrect answer, as denoted by the answer being encircled in red circle. Additionally, an accompanying audio message communicates feedback, such as “try again” or “wrong answer”, in accordance with the disclosed embodiments.

FIG. 72 illustrates a graphical representation of the user(student) interface of the audio-visual interactive digital learning material with learning exercises and assessments. In this illustration, the student can observe the picture alongside question relevant to it, aiding logical thinking before answering. The user is in the process of selecting the correct answer from the multiple options given. In this particular scenario, the user clicks on a correct answer, as denoted by the item being encircled in green circle. Additionally, an accompanying audio message communicates feedback, such as “well done” or “correct answer”, in accordance with the disclosed embodiments.

FIG. 73 illustrates a graphical representation of the user(student) interface of the audio-visual interactive digital learning material with learning exercises and assessments. Here, the student engages with a picture within the learning material interface. By clicking on the picture, the user triggers an audio feature that provides a detailed explanation of the picture's content. This functionality enhances the user's understanding by offering auditory support alongside visual stimuli, thereby facilitating a comprehensive learning experience, in accordance with the disclosed embodiments.

FIG. 74 illustrates a graphical representation of the user(student) interface of the audio-visual interactive digital learning material with learning exercises and assessments. Here, the student encounters a set of questions presented alongside various answering options. One available method for responding to these questions involves selecting the answer from a drop-down list. This feature offers users a structured and convenient way to provide their responses, contributing to an efficient and engaging learning experience within the digital platform., in accordance with the disclosed embodiments.

FIG. 75 illustrates a graphical representation of the user(student) interface of the audio-visual interactive digital learning material with learning exercises and assessments. Here, the student selects one of the answers from the drop-down list, in accordance with the disclosed embodiments.

FIG. 76 illustrates a graphical representation of the user(student) interface of the audio-visual interactive digital learning material with learning exercises and assessments. In this illustration, an audio message accompanies the selection, offering positive reinforcement such as “well done” or “correct answer” for correct responses, and guidance like “try again” or “wrong answer” for incorrect ones. Here the accompanying audio message communicates feedback, such as “try again” or “wrong answer”, in accordance with the disclosed embodiments.

FIG. 77 illustrates a graphical representation of the user(student) interface of the audio-visual interactive digital learning material with learning exercises and assessments. Upon recognizing that the previously chosen answer was incorrect, the student has made a subsequent attempt to select the correct answer from the drop-down list, demonstrating a commitment to learning and improving their comprehension within the interactive educational platform, in accordance with the disclosed embodiments.

FIG. 78 illustrates a graphical representation of the user(student) interface of the audio-visual interactive digital learning material with learning exercises and assessments. Following the user's answer, an audio message provides feedback, affirming correct answers with messages like “well done” or “correct answer”, thereby encouraging and reinforcing learning outcomes within the interactive educational environment, in accordance with the disclosed embodiments.

FIG. 79 illustrates a graphical representation of the user(student) interface of the audio-visual interactive digital learning material with learning exercises and assessments. Here, in this depiction the user prefers to provide answer for the question, when users opt to answer a question, the virtual keyboard embedded within the interface becomes active, facilitating direct typing of responses. This feature is designed to enhance user engagement with the learning material, offering a convenient method for inputting answers without requiring physical keyboards, in accordance with the disclosed embodiments.

FIG. 80 illustrates a graphical representation of the user(student) interface of the audio-visual interactive digital learning material with learning exercises and assessments. In this depiction, the user interacts with the virtual keyboard to select multiple language options for typing their answer. This feature enables users to input responses in their preferred language, aligning with the content of the digital learning material. This functionality, enhancing accessibility and usability for users across different linguistic backgrounds, in accordance with the disclosed embodiments.

FIG. 81 illustrates a graphical representation of the user(student) interface of the audio-visual interactive digital learning material with learning exercises and assessments. The digital learning material is automatically enabled with the audiobook format, indicated by the toggle button being enabled by default. This feature allows users to listen to the audiobook by simply clicking or touching the text content or picture, in accordance with the disclosed embodiments.

FIG. 82 illustrates a graphical representation of the user(student) interface of the audio-visual interactive digital learning material with learning exercises and assessments. Here, the user has disabled the audiobook format by turning off the toggle button. As a result, annotations are now enabled. The user can access previously added annotations such as “Hyperlink,” “Highlighter,” and “Notes” by clicking on their respective icons. Additionally, new annotations can be added by selecting specific words, phrases, or sentences within the content. This feature enhances the interactive nature of the learning material, allowing users to engage with the content in a more personalized and dynamic manner providing flexibility and customization options for users, in accordance with the disclosed embodiments.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of different features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention is described herein as software including a user interface that provides the user with the ability to work device-independent within a network it is contemplated by the inventors that the invention may be implemented in various ways within the scope of the invention.

The invention addresses the challenge of learning by integrating an audio assistant feature for reading, comprehension, and completion of exercises and assessments within an advanced digital textbook/lecture note. This innovative solution is implemented in an audio interactive advanced digital textbook, accessible on various digital devices such as laptop computers, desktop computers, digital tablets, smartphones, etc.

It helps educators towards building a rich advanced digital learning experience. Audio interactive advanced digital learning material simplifies and helps the learning process of the students with audio embedded subject content which includes text, pictures, videos and the like. Audio Interactive Digital learning material or textbook content is always up-to-date and virtually with infinite videos, audio, and documents supporting a wide variety of interests and topics which prevents the students from referring to other websites and getting misled or lost in the maze of information available.

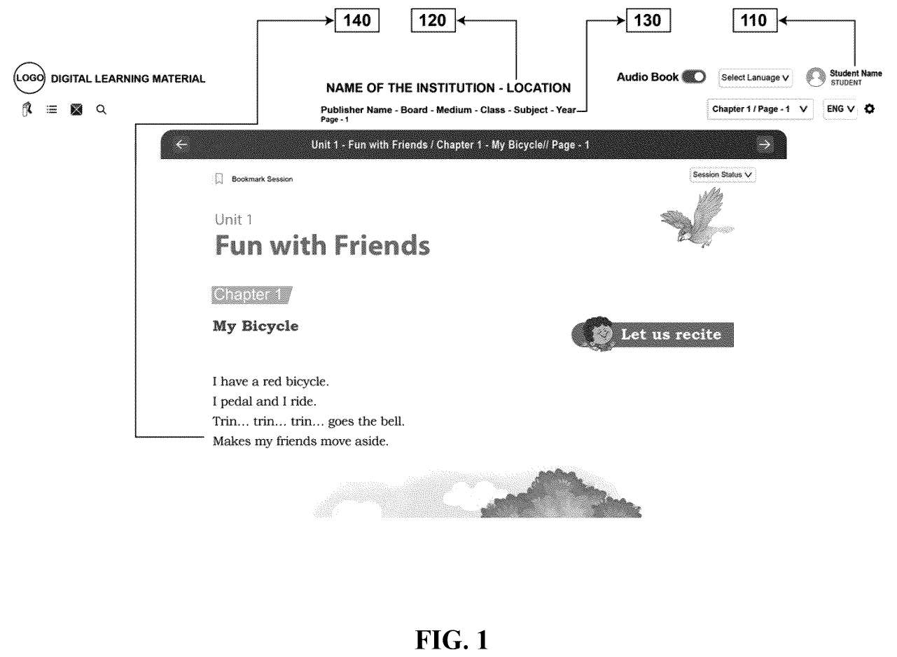

Referring to FIG. 1 the audio-visual interactive digital learning material with learning exercises and assessments (100) includes, (110) profile picture and name of the student (120) name of the educational institution, which may include school, college, tutorial, etc., (130) name of the publisher, board, medium, class, subject, year, and page number, (140) subject content for the selected page, with the current page number displayed as 1.

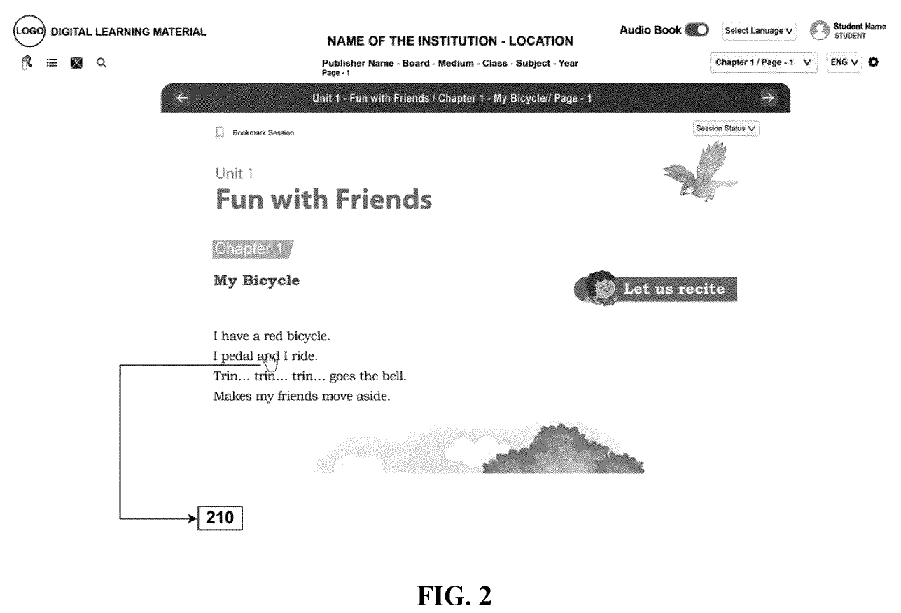

Referring to FIG. 2 the audio-visual interactive digital learning material with learning exercises and assessments (200) includes, (210) user clicks on particular text content within the subject material to listen to the corresponding audio.

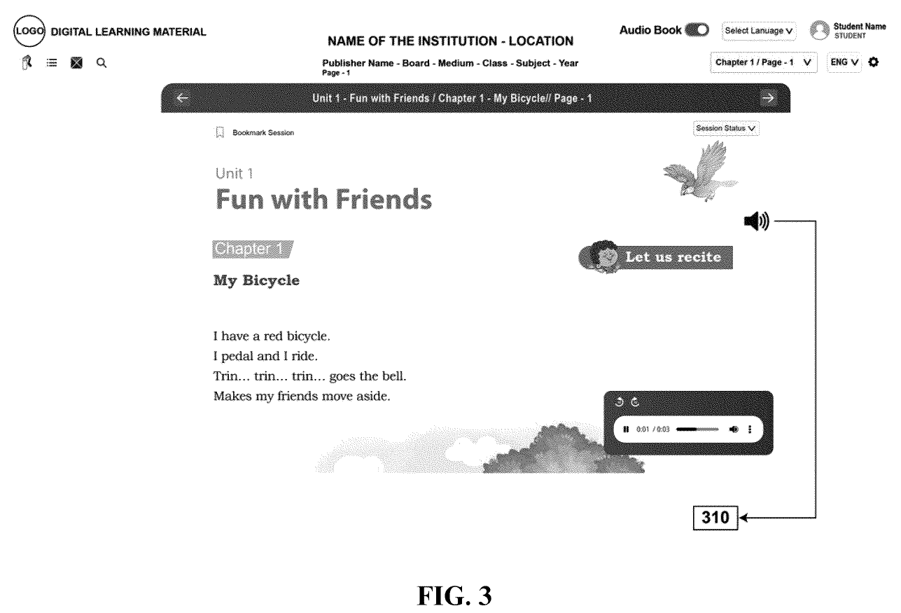

Referring to FIG. 3 the audio-visual interactive digital learning material with learning exercises and assessments (300) includes, (310) user listens to the audio corresponding to the particular text content upon clicking.

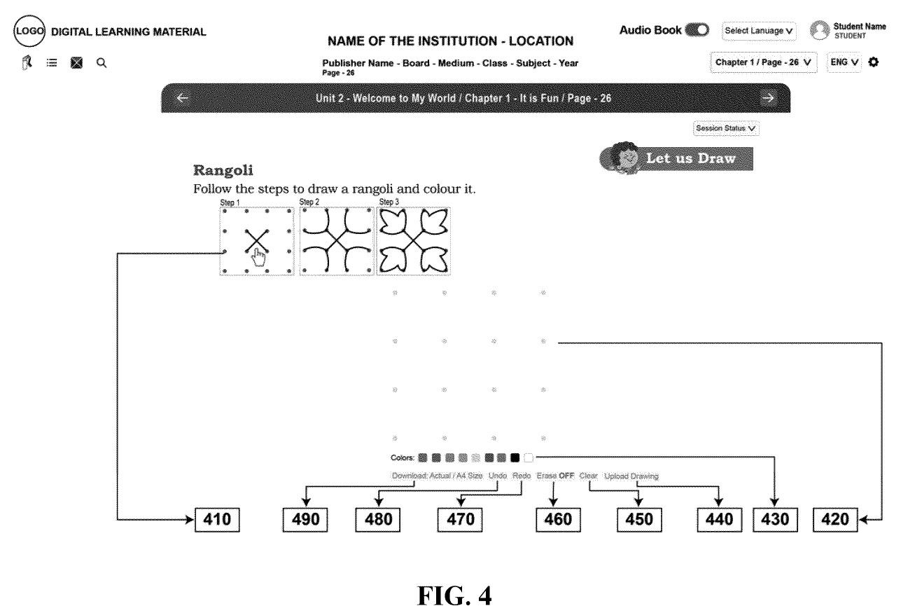

Referring to FIG. 4 the audio-visual interactive digital learning material with learning exercises and assessments (400) includes, (410) the user initiates the drawing process by clicking on the “Step 1” diagram, which triggers audio guidance to assist in drawing the picture in a step-by-step manner (420) dots to guide the user in drawing the diagram, (430) option to choose the required color for drawing the diagram, (440) button to upload the drawn diagram (450) button to clear the drawn diagram, (460) button to erase specific portions of the drawn diagram, (470) option to redo the drawn picture, (480) option to undo the drawn picture, (490) button to download the drawn diagram in actual size and in A4 format.

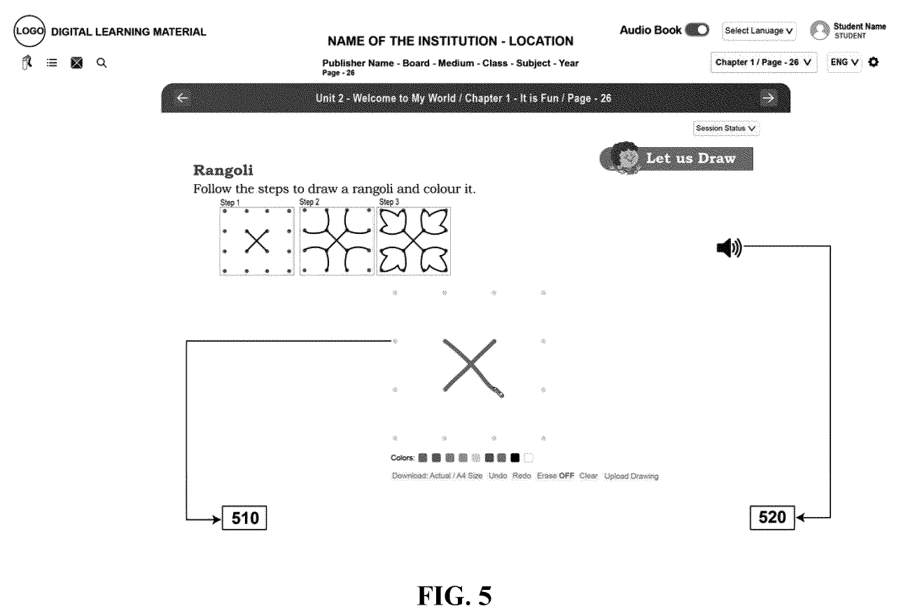

Referring to FIG. 5 the audio-visual interactive digital learning material with learning exercises and assessments (500) includes, (510) the user engages in drawing the diagram with the support of audio guidance, initiated by clicking on the “Step 1” process, (520) this action prompts the audio to begin playing.

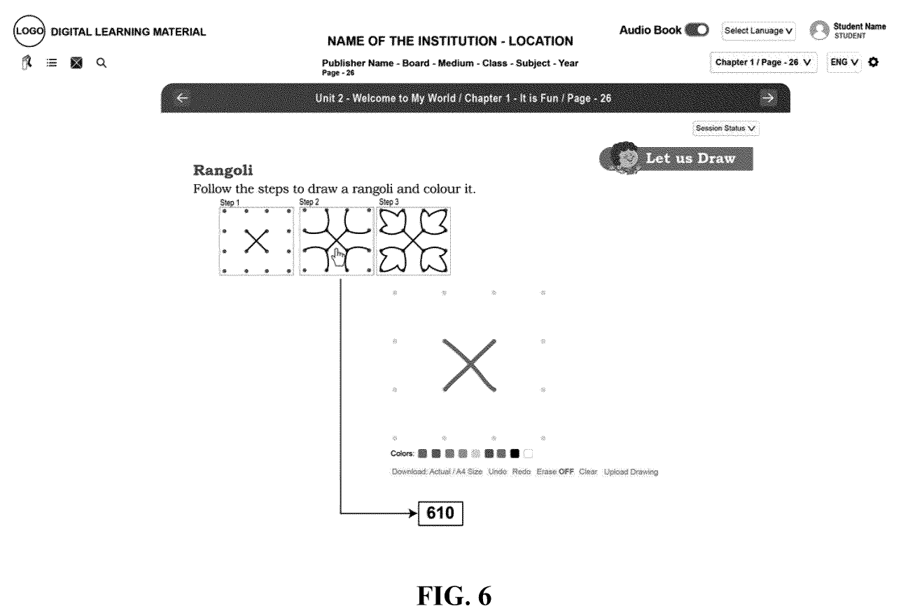

Referring to FIG. 6 the audio-visual interactive digital learning material with learning exercises and assessments (600) includes, (610) the user progresses with the drawing process by clicking on the “Step 2” button, which initiates audio guidance to support the step-by-step drawing of the picture.

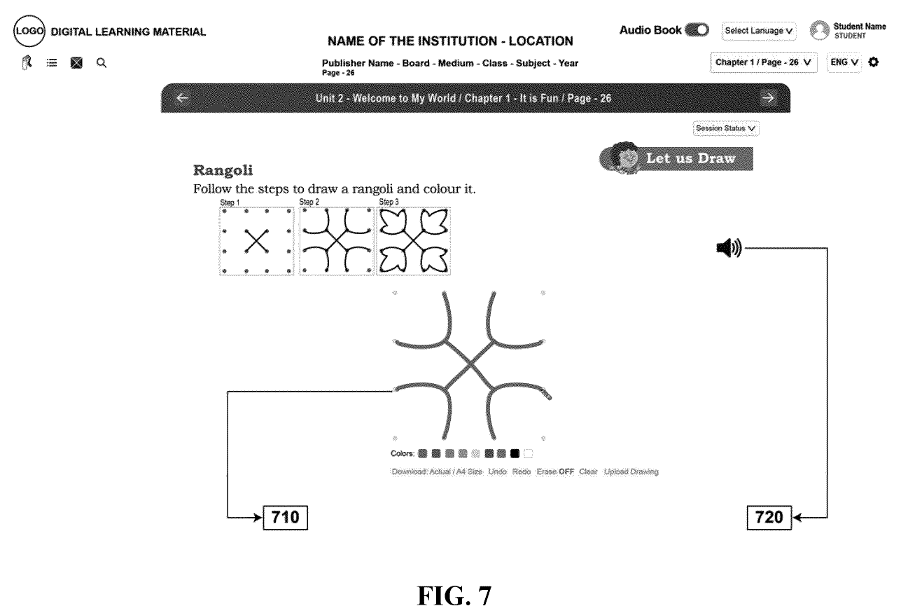

Referring to FIG. 7 the audio-visual interactive digital learning material with learning exercises and assessments (700) includes, (710) the user engages in drawing the diagram with the support of audio guidance, initiated by clicking on the “Step 2” process, (720) this action prompts the audio to begin playing.

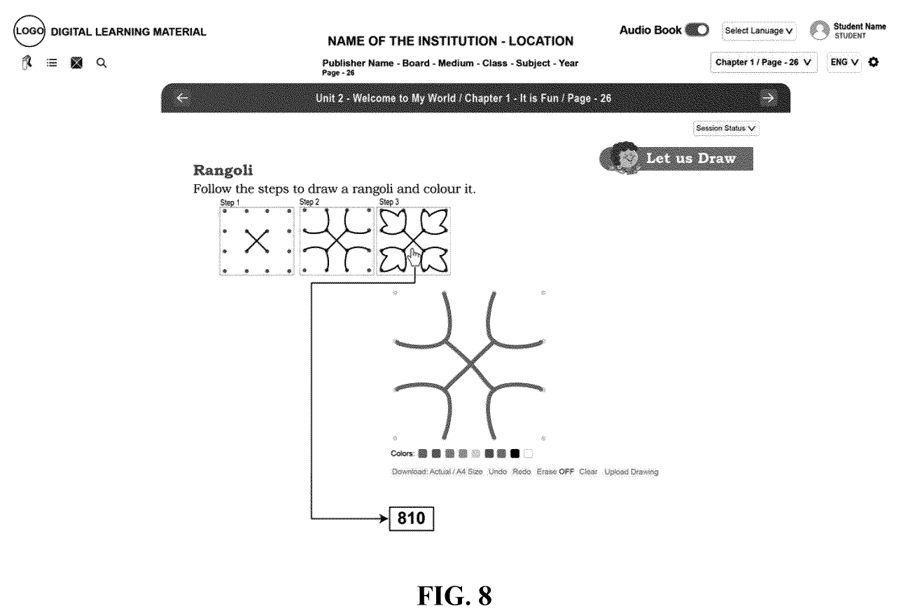

Referring to FIG. 8 the audio-visual interactive digital learning material with learning exercises and assessments (800) includes, (810) the user progresses with the drawing process by clicking on the “Step 3” button, which will initiate audio guidance to support the step-by-step drawing of the picture.

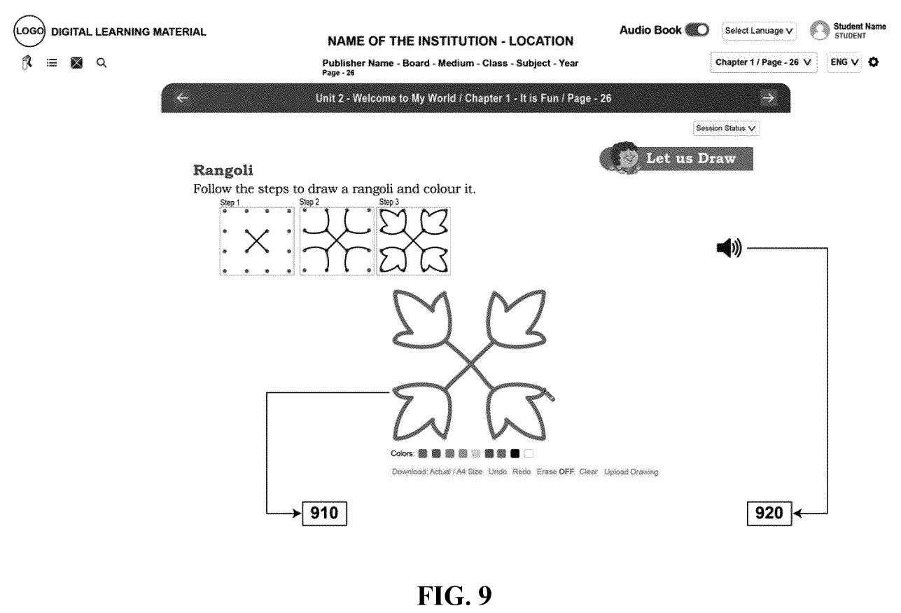

Referring to FIG. 9 the audio-visual interactive digital learning material with learning exercises and assessments (900) includes, (910) the user engages in drawing the diagram with the support of audio guidance, initiated by clicking on the “Step 3” process, (920) Upon clicking the “Step 3” process, audio begins to play, guiding the user through the final step of the drawing process.

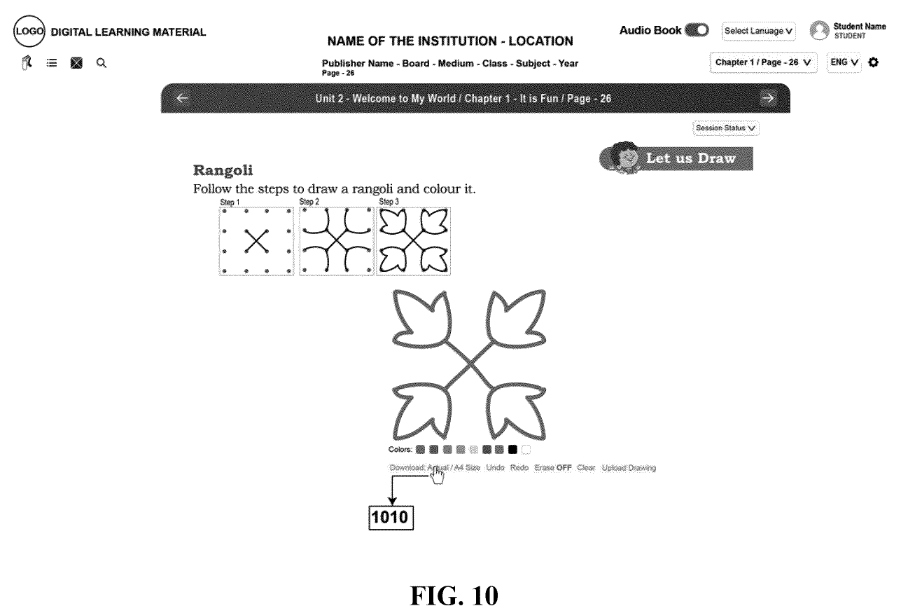

Referring to FIG. 10 the audio-visual interactive digital learning material with learning exercises and assessments (1000) includes, (1010) the user clicks the download icon to download the drawn picture in the required format. Here the user clicks the actual image format for download.

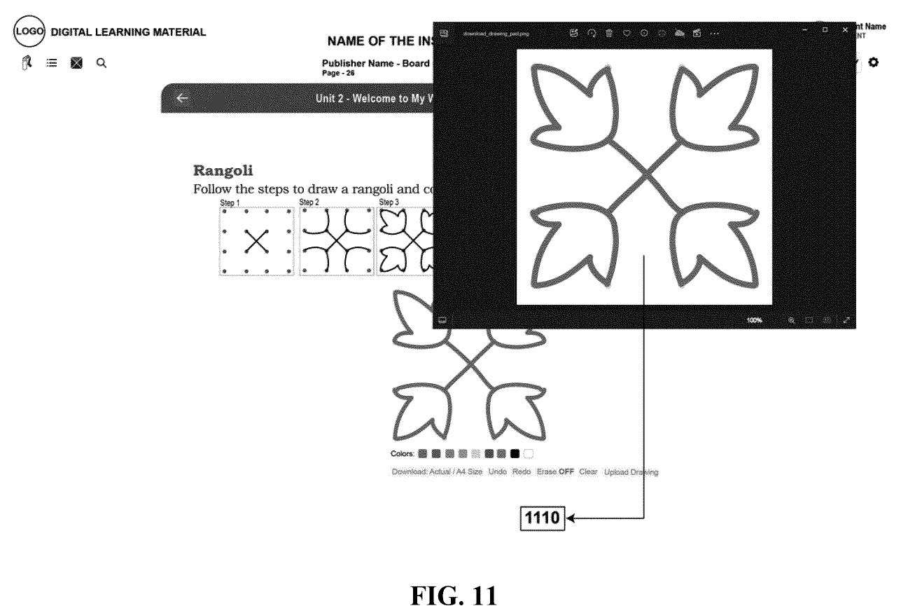

Referring to FIG. 11 the audio-visual interactive digital learning material with learning exercises and assessments (1100) includes, (1110) once the user clicks the download icon, the drawn picture is downloaded and saved to the user's device in the selected format.

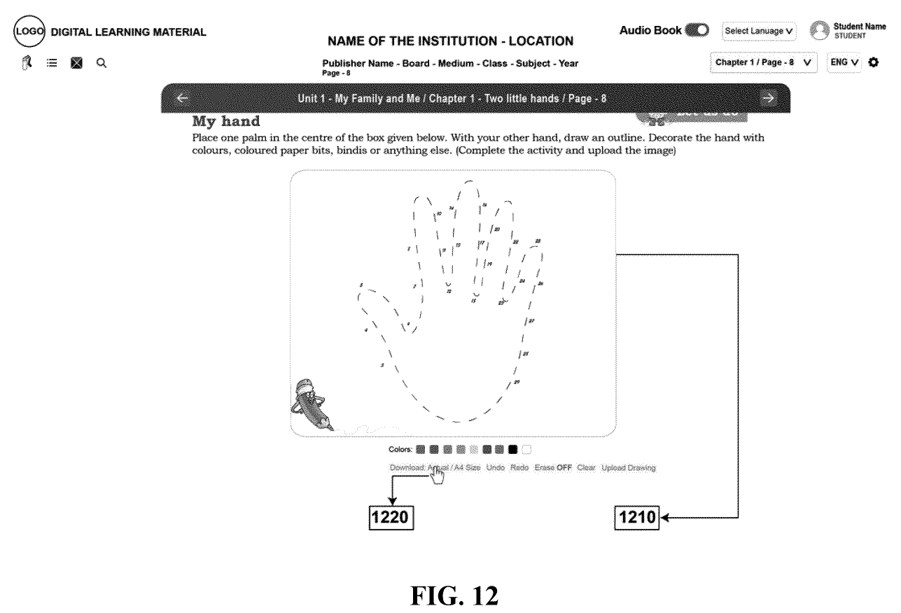

Referring to FIG. 12 the audio-visual interactive digital learning material with learning exercises and assessments (1200) includes, (1210) students are provided with the capability to access the picture directly on the drawing pad, (1220) users who prefer not to draw directly on the pad has the option to download the image, to draw and color it manually. Upon clicking the download icon, the picture displayed in the drawing pad is downloaded and saved to the user's device in the selected format.

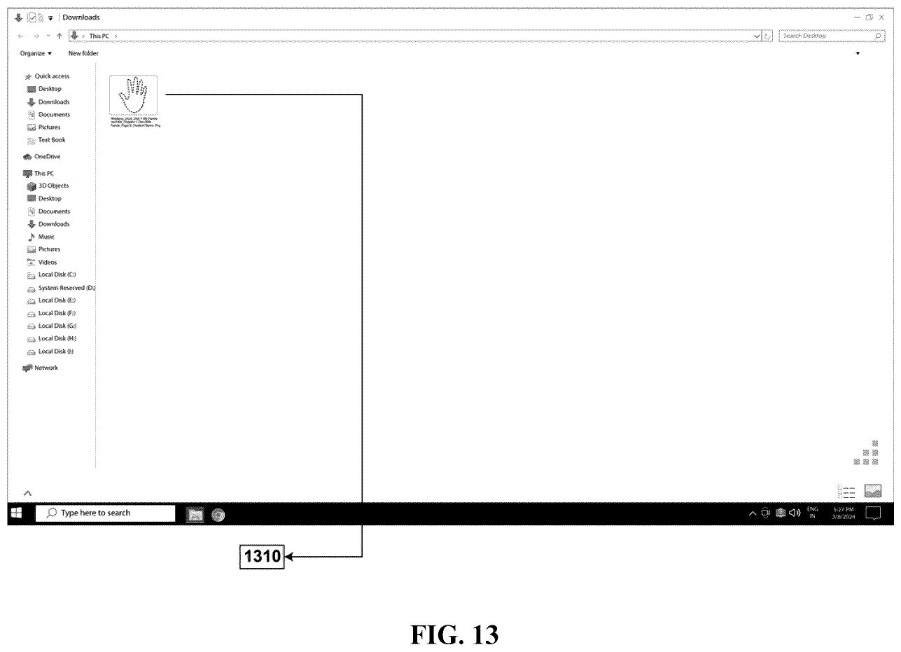

Referring to FIG. 13 the audio-visual interactive digital learning material with learning exercises and assessments (1300) includes, (1310) user access the downloaded picture from their device, enabling them to take a printout for manual drawing, colouring, and decoration.

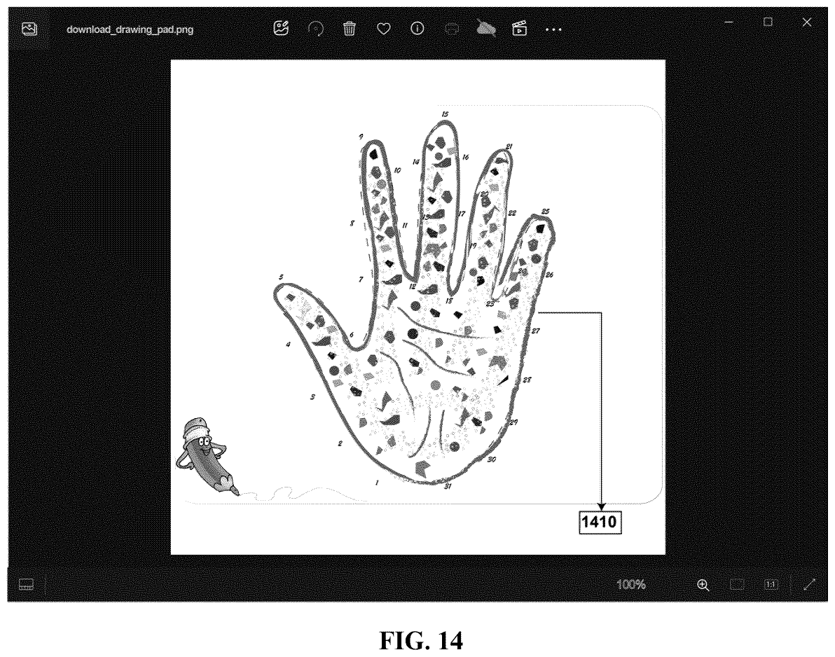

Referring to FIG. 14 the audio-visual interactive digital learning material with learning exercises and assessments (1400) includes, (1410) the student has effectively completed the drawing manually, incorporating colouring and decoration elements. Subsequently, the user can now access and view the fully drawn, coloured, and decorated image in digital format on their device.

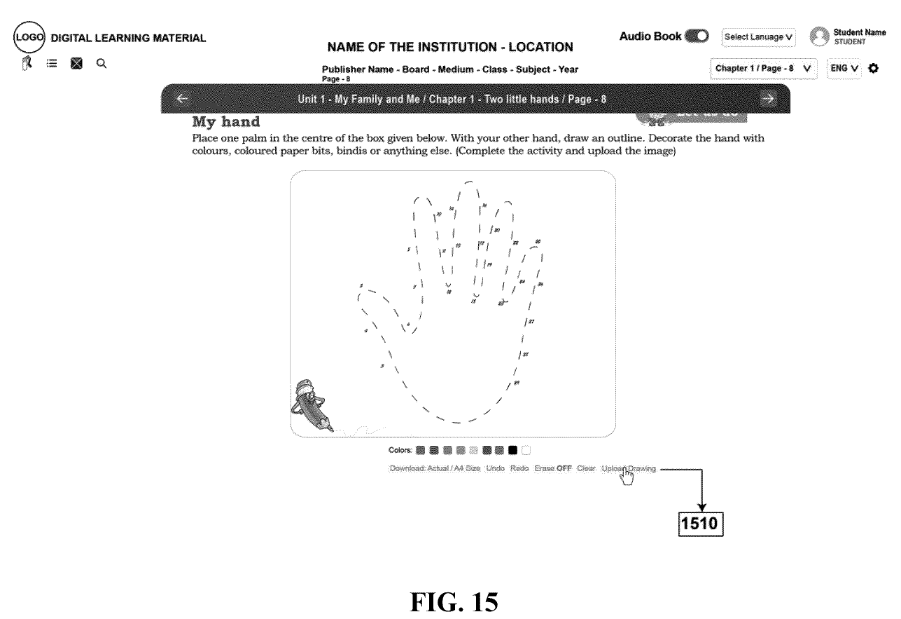

Referring to FIG. 15 the audio-visual interactive digital learning material with learning exercises and assessments (1500) includes, (1510) students utilize the upload button available on the drawing pad within the digital learning material interface to upload the manually drawn, coloured, and decorated picture.

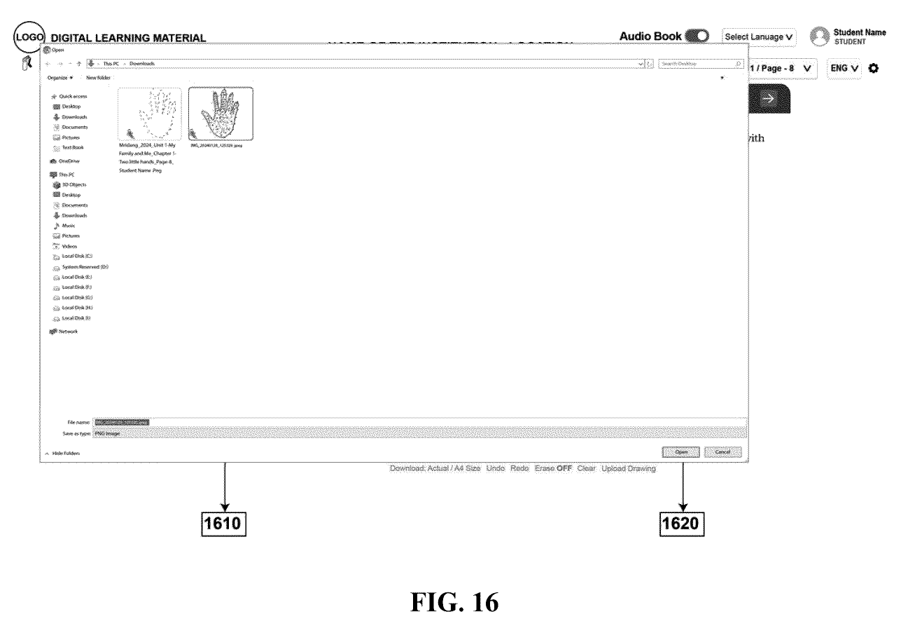

Referring to FIG. 16 the audio-visual interactive digital learning material with learning exercises and assessments (1600) includes, (1610) (1620) user proceeding to upload the digital copy of the manually completed drawing. It is the integration of offline work into the online platform.

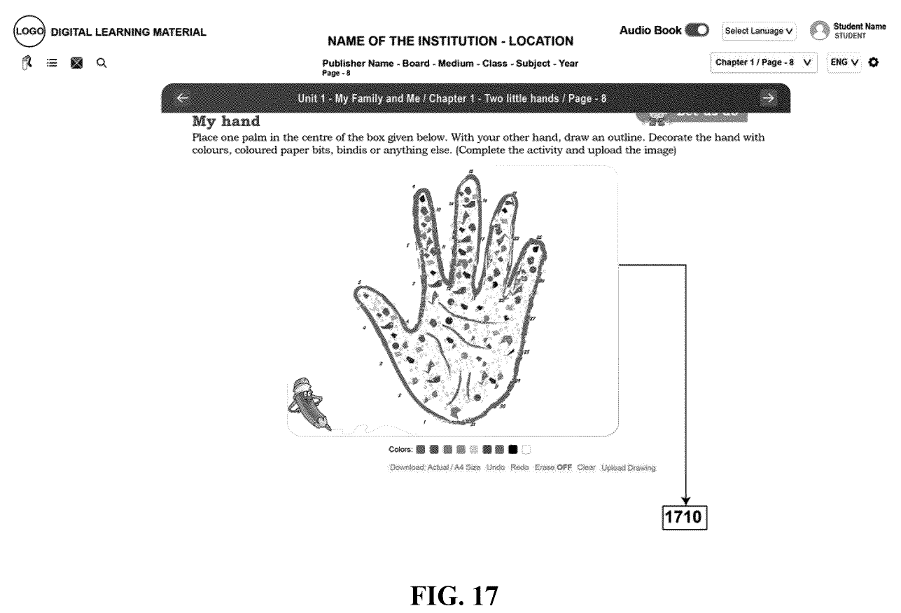

Referring to FIG. 17 the audio-visual interactive digital learning material with learning exercises and assessments (1700) includes, (1710) students can observe the manually drawn picture on the digital pad. Additionally, users have the capability to make changes or modifications to the drawing as needed.

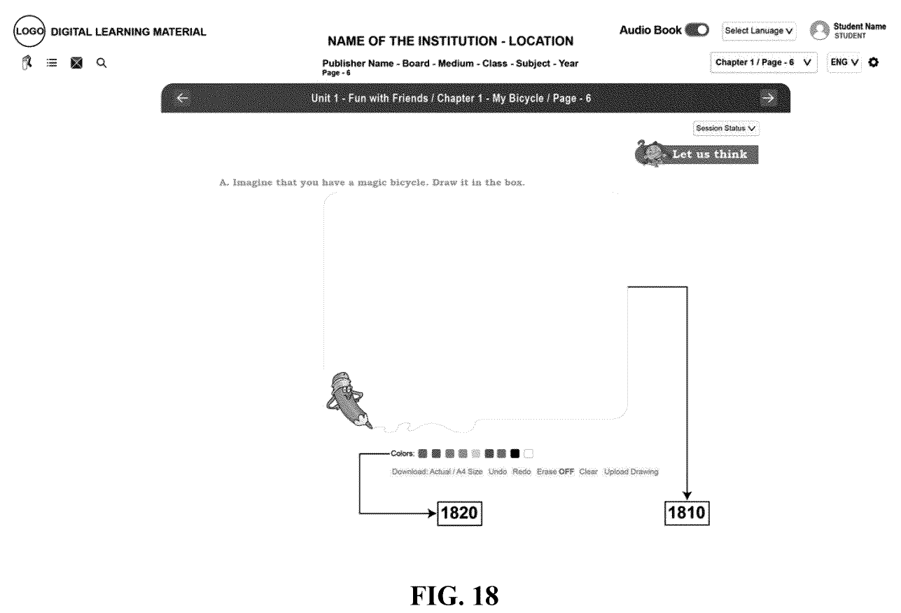

Referring to FIG. 18 the audio-visual interactive digital learning material with learning exercises and assessments (1800) includes, (1810) the drawing pad where users can create their drawings, (1820) a color palette for users to select the desired color for their drawings.

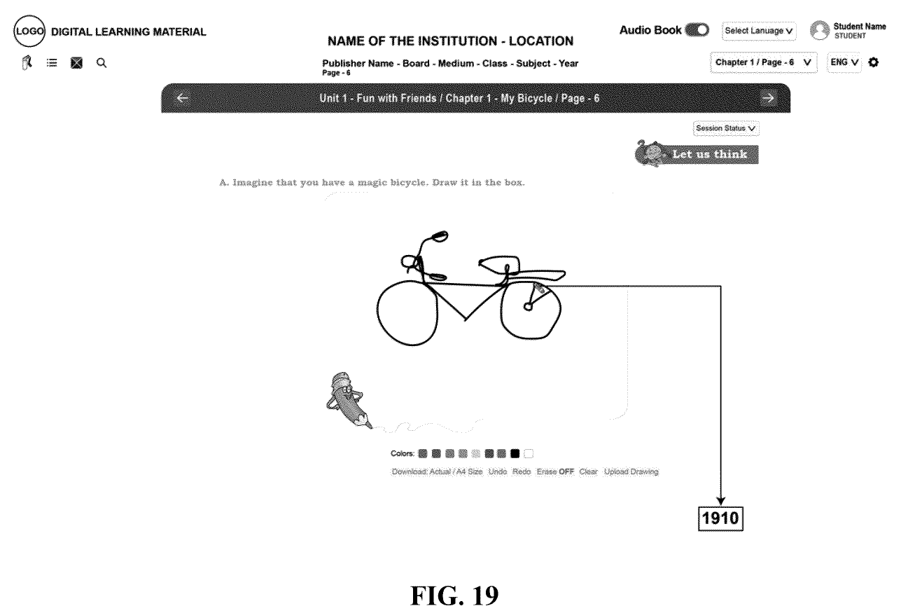

Referring to FIG. 19 the audio-visual interactive digital learning material with learning exercises and assessments (1900) includes, (1910) the user initiating the drawing process on the drawing pad. This feature allows users to create their diagrams within the digital learning material.

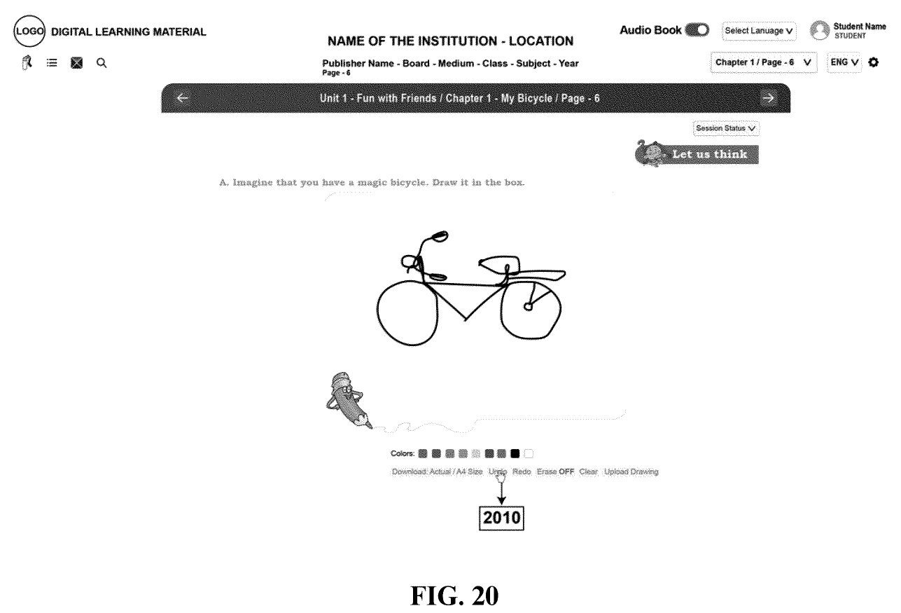

Referring to FIG. 20 the audio-visual interactive digital learning material with learning exercises and assessments (2000) includes, (2010) the user clicks the “Undo” button to reverse the most recent action made on the drawing pad while drawing. This functionality enables users to correct any mistakes made during the drawing process.

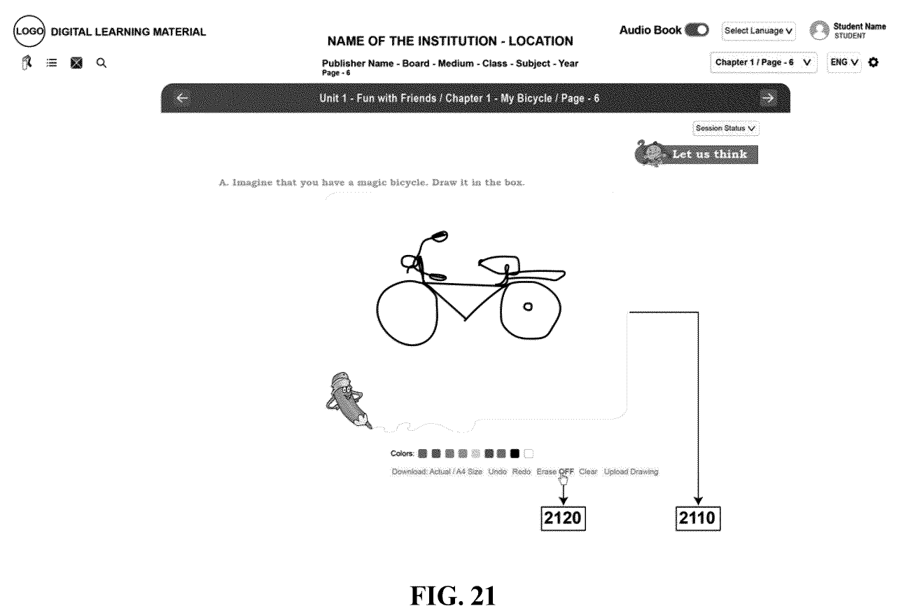

Referring to FIG. 21 the audio-visual interactive digital learning material with learning exercises and assessments (2100) includes, (2110) the user observes the diagram after using the “Undo” function to revert the recent action, (2120) the user clicks the “Erase” button to remove specific portions of the diagram where corrections are needed.

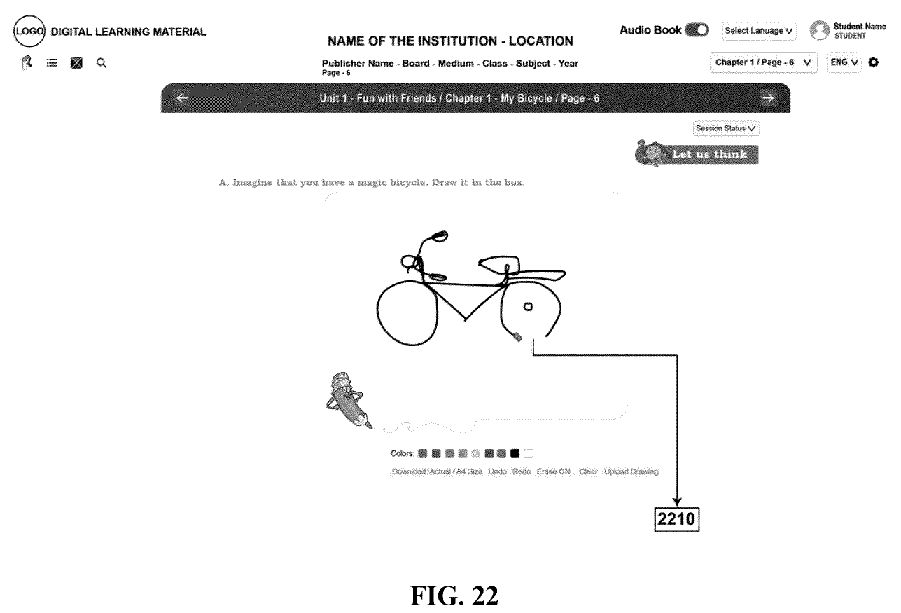

Referring to FIG. 22 the audio-visual interactive digital learning material with learning exercises and assessments (2200) includes, (2210) the user utilizes the eraser tool to remove specific parts of the drawing for making corrections or adjustments.

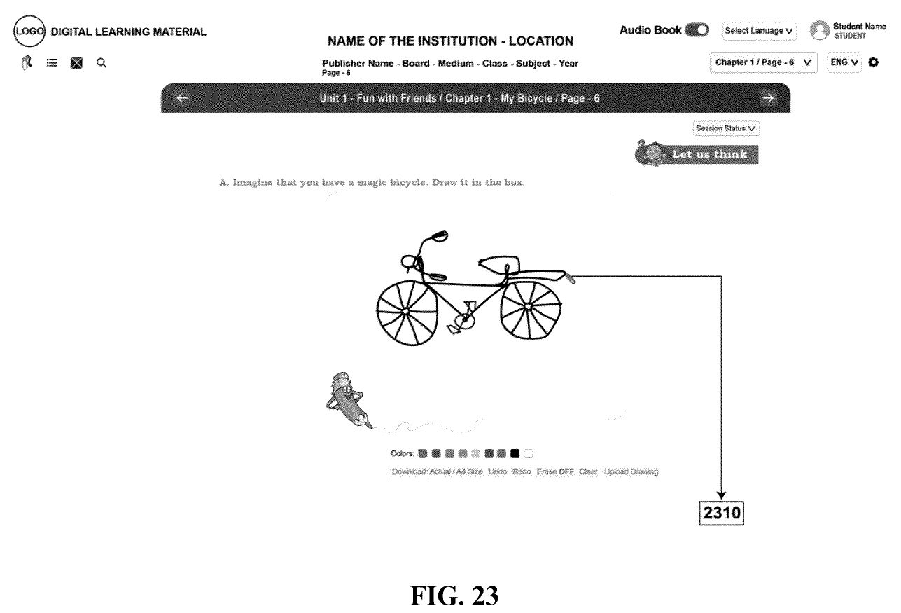

Referring to FIG. 23 the audio-visual interactive digital learning material with learning exercises and assessments (2300) includes, (2310) the user completed the drawing process on the drawing pad as per the question raised.

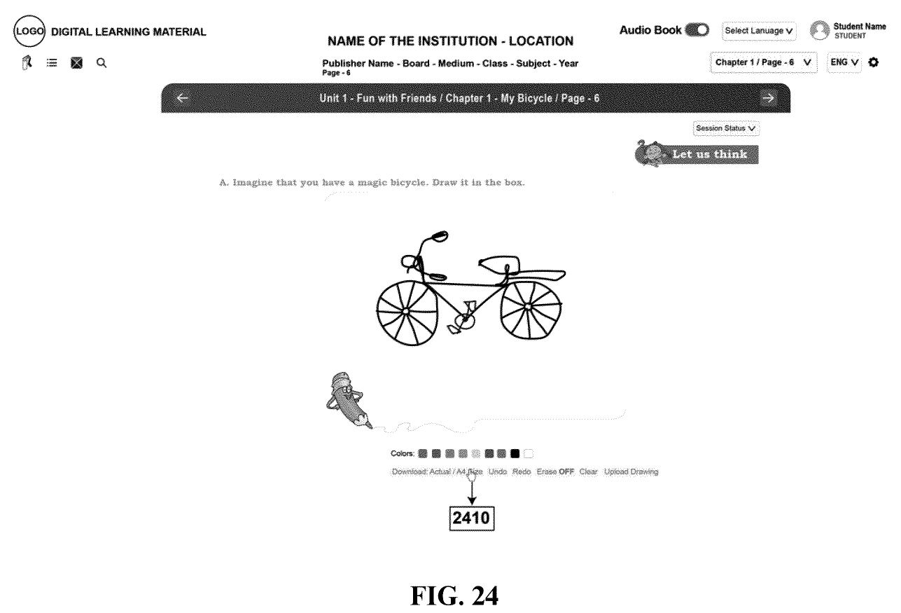

Referring to FIG. 24 the audio-visual interactive digital learning material with learning exercises and assessments (2400) includes, (2410) the user clicks the download icon to download the drawn picture in the required format. Here the user clicks the A4 format for download.

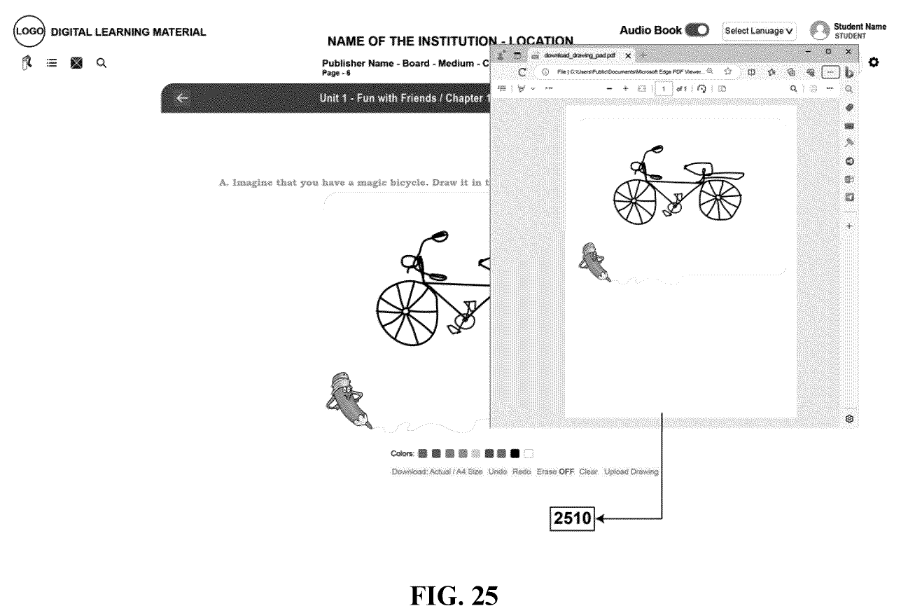

Referring to FIG. 25 the audio-visual interactive digital learning material with learning exercises and assessments (2500) includes, (2510) once the user clicks the download icon, the drawn picture is downloaded and saved to the user's device in the selected format.

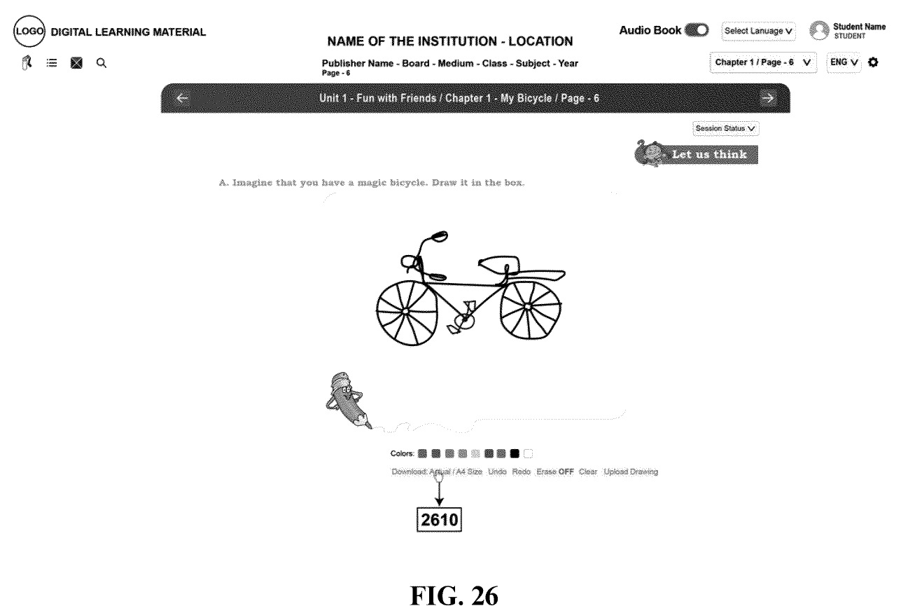

Referring to FIG. 26 the audio-visual interactive digital learning material with learning exercises and assessments (2600) includes, (2610) the user clicks the download icon to download the drawn picture in the required format. Here the user clicks the actual image format for download.

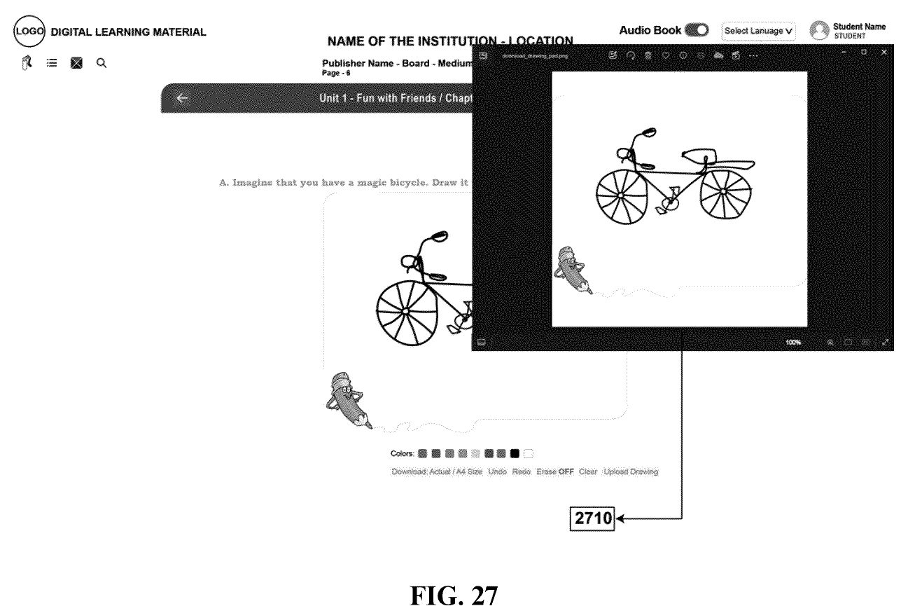

Referring to FIG. 27 the audio-visual interactive digital learning material with learning exercises and assessments (2700) includes, (2710) Once the user clicks the download icon, the drawn picture is downloaded and saved to the user's de vice in the selected format.

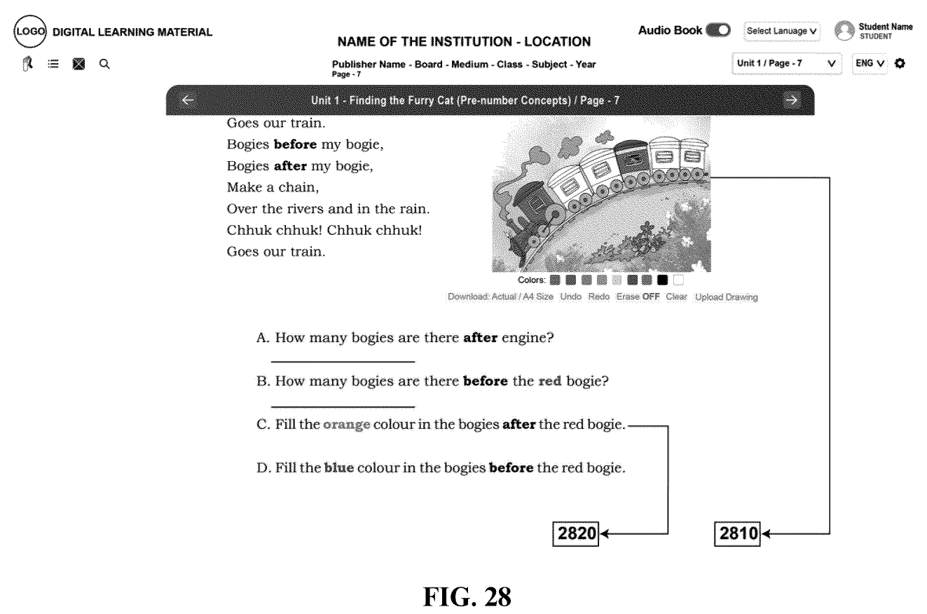

Referring to FIG. 28 the audio-visual interactive digital learning material with learning exercises and assessments (2800) includes, (2810) Users can interact with pictures, including colouring them as per the instructions or questions, (2820) Relevant questions are presented based on the subject content and the pictures displayed, fostering engagement and understanding, the user selects a question to answer from the provided options, they can engage directly with the learning material by providing their response.

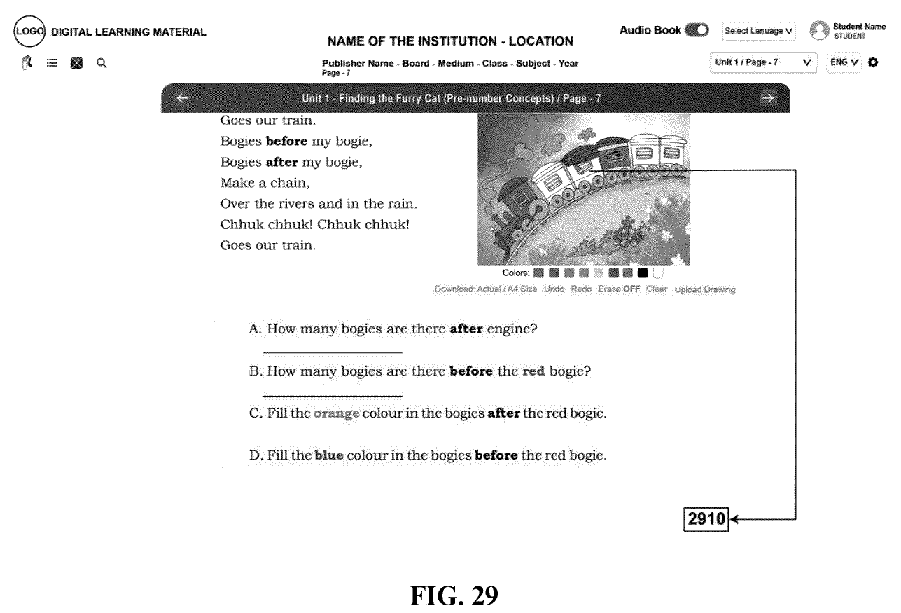

Referring to FIG. 29 the audio-visual interactive digital learning material with learning exercises and assessments (2900) includes, (2910) users begin to color the picture in response to the question posed.

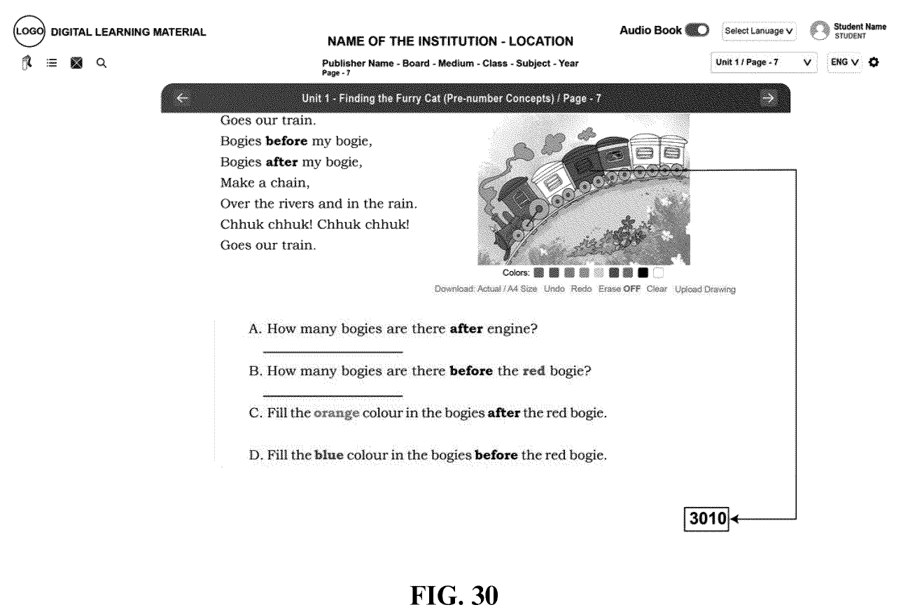

Referring to FIG. 30 the audio-visual interactive digital learning material with learning exercises and assessments (3000) includes, (3010) users have completed colouring the picture in accordance with the question presented.

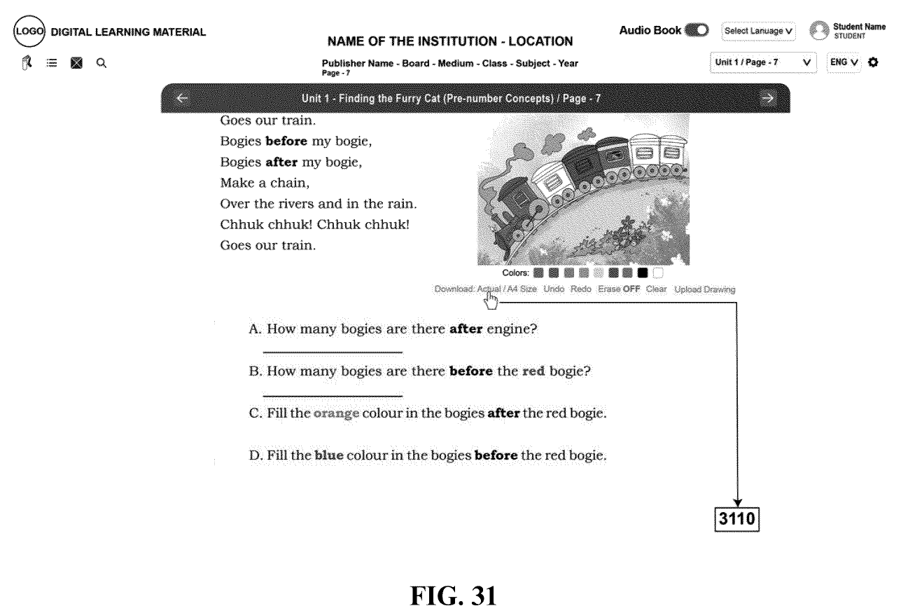

Referring to FIG. 31 the audio-visual interactive digital learning material with learning exercises and assessments (3100) includes, (3110) the user clicks the download icon to download the drawn picture in the required format. Here the user clicks the actual image format for download.

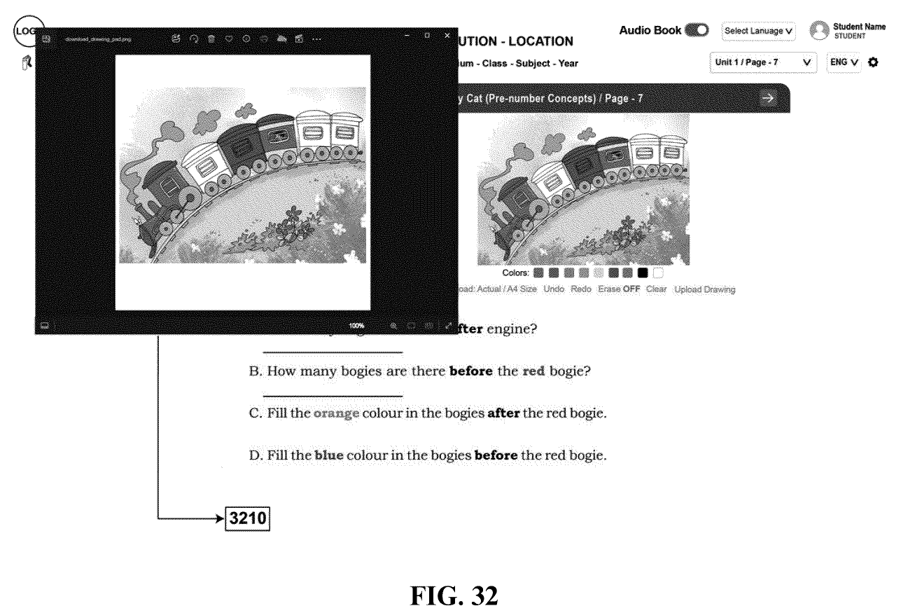

Referring to FIG. 32 the audio-visual interactive digital learning material with learning exercises and assessments (3200) includes, (3210) Once the user clicks the download icon, the drawn picture is downloaded and saved to the user's device in the selected format.

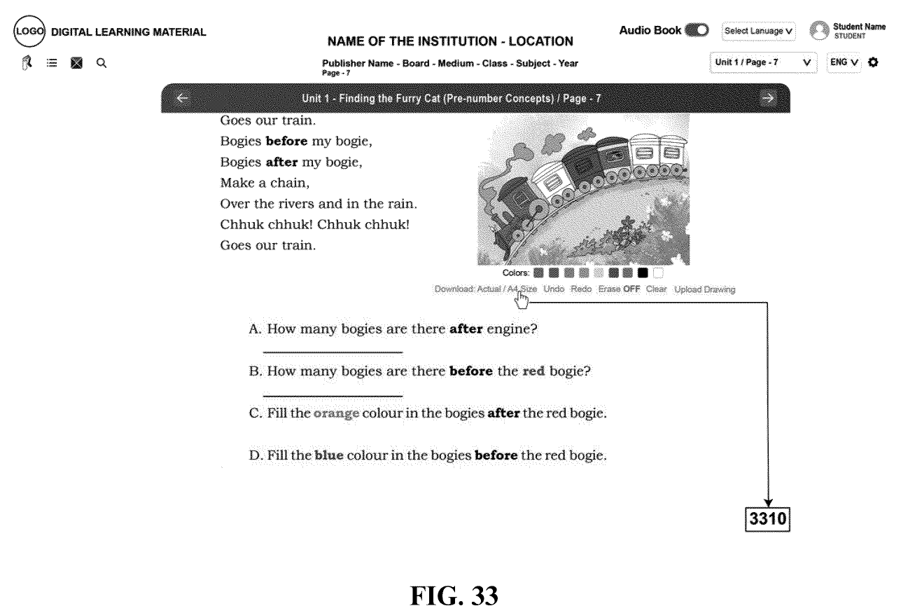

Referring to FIG. 33 the audio-visual interactive digital learning material with learning exercises and assessments (3300) includes, (3310) the user clicks the download icon to download the drawn picture in the required format. Here the user clicks the A4 size format for the picture to download.

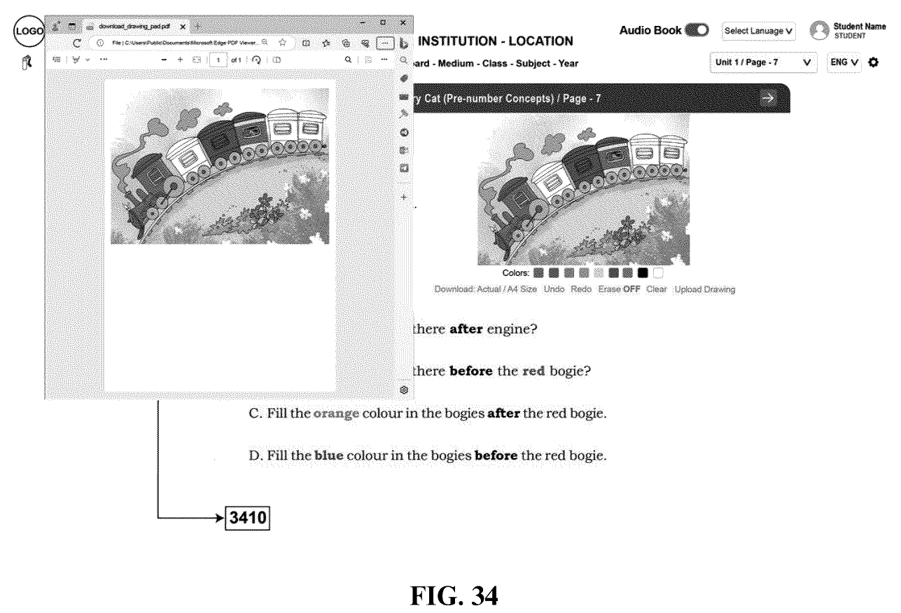

Referring to FIG. 34 the audio-visual interactive digital learning material with learning exercises and assessments (3400) includes, (3410) Once the user clicks the download icon, the drawn picture is downloaded and saved to the user's device in the selected format.

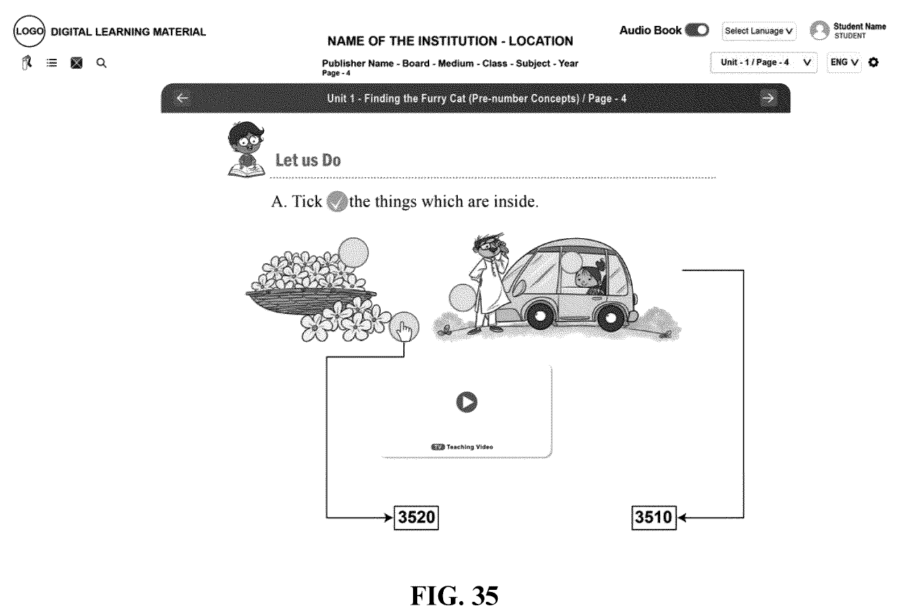

Referring to FIG. 35 the audio-visual interactive digital learning material with learning exercises and assessments (3500) includes, (3510) the user can observe the picture alongside questions relevant to it. The picture depicts items both inside and outside of the illustrations, the task is to select the items (flower or girl) inside the illustration, (3520) the user clicks on an item(flower) outside the basket in the picture.

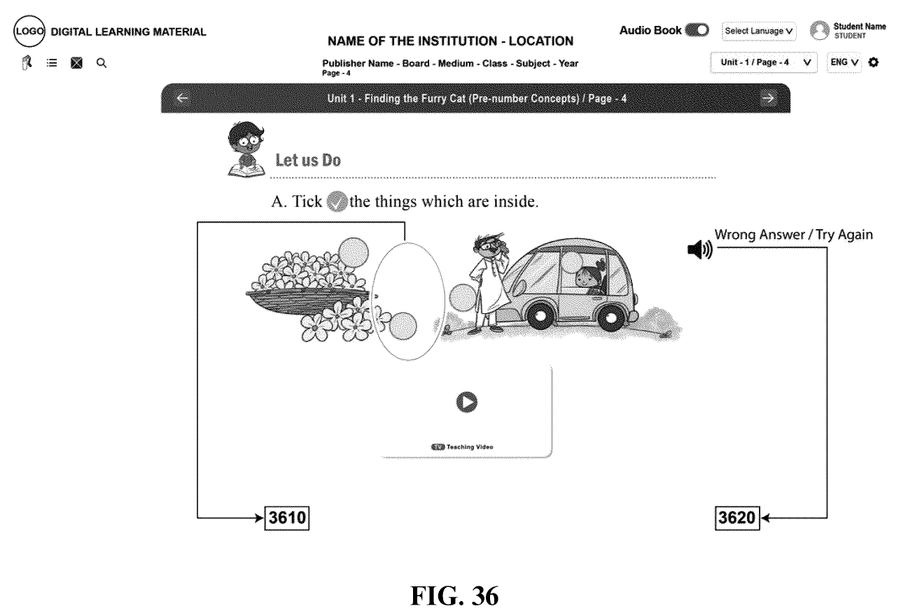

Referring to FIG. 36 the audio-visual interactive digital learning material with learning exercises and assessments (3600) includes, (3610) the item outside the illustration was selected and the selected answer is displayed inside an oval shape in red, indicating that the answer is incorrect. (3620) the audio message indicates “try again” or “wrong answer” as the selected answer is incorrect.

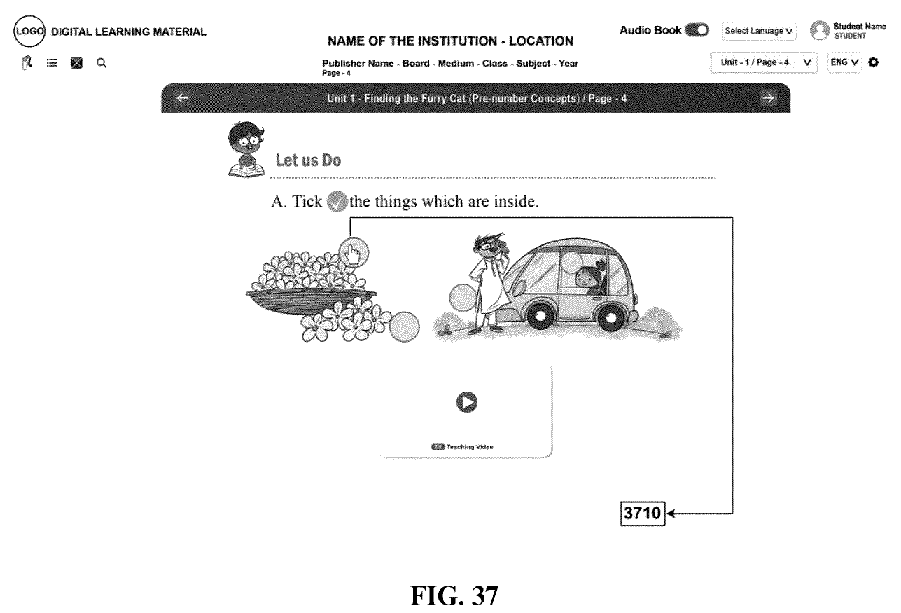

Referring to FIG. 37 the audio-visual interactive digital learning material with learning exercises and assessments (3700) includes, (3710) the user clicks on an item(flower) inside the illustration(basket) in the picture.

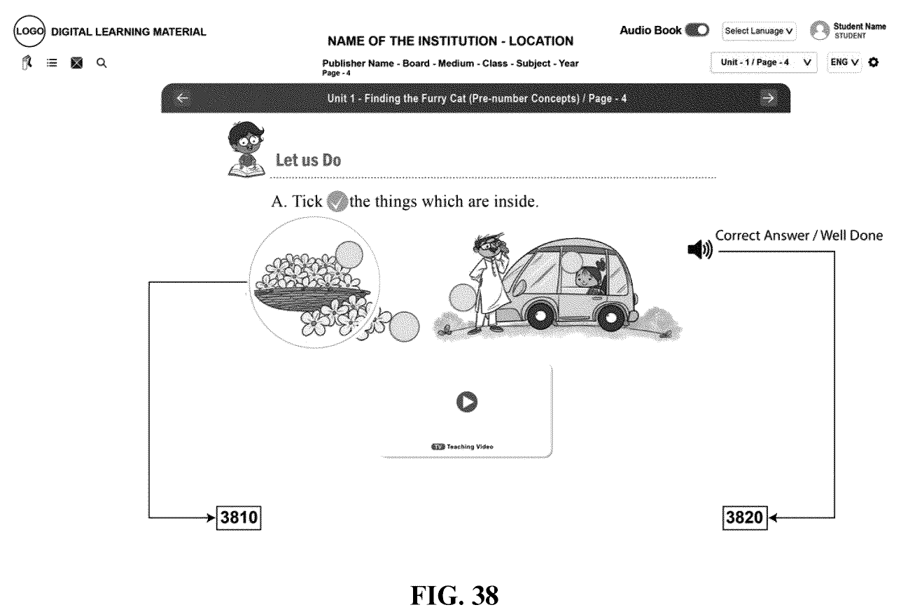

Referring to FIG. 38 the audio-visual interactive digital learning material with learning exercises and assessments (3800) includes, (3810) the student has made a subsequent attempt to select the correct answer and the selected answer is displayed inside a round shape in green, indicating that the answer is correct, (3820) an audio message can be heard providing positive reinforcement such as “well done” or “correct answer” for correct answer selected.

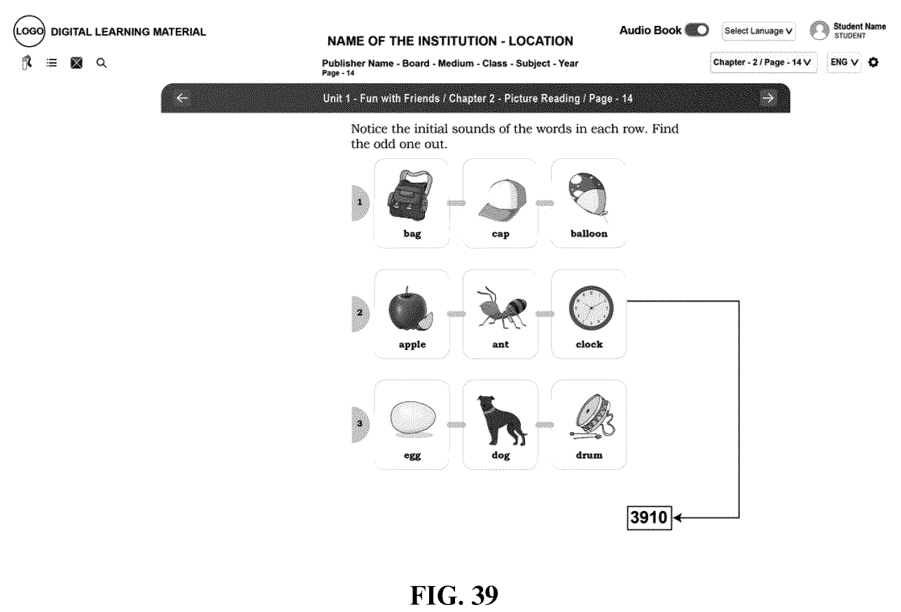

Referring to FIG. 39 the audio-visual interactive digital learning material with learning exercises and assessments (3900) includes, (3910) the student is tasked with identifying the odd items out by finding the correct one.

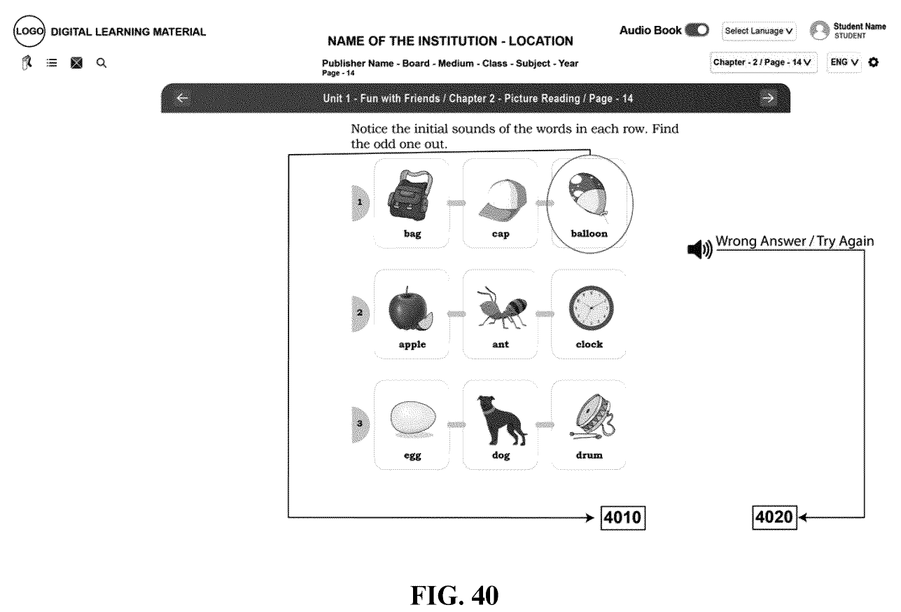

Referring to FIG. 40 the audio-visual interactive digital learning material with learning exercises and assessments (4000) includes, (4010) The user clicks on an incorrect item in the row, which is denoted by the item being encircled in red within an oval shape, (4020) an accompanying audio message communicates feedback, such as “try again” or “wrong answer”.

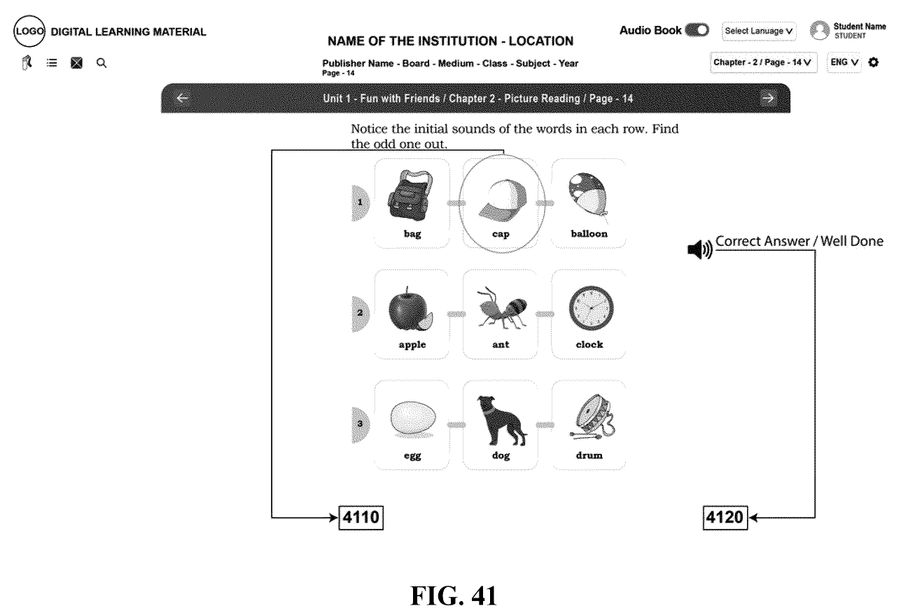

Referring to FIG. 41 the audio-visual interactive digital learning material with learning exercises and assessments (4100) includes, (4110) the user clicks on a correct item, as denoted by the item being encircled in green within a circle. (4120) an accompanying audio message communicates feedback, such as “well done” or “correct answer”.

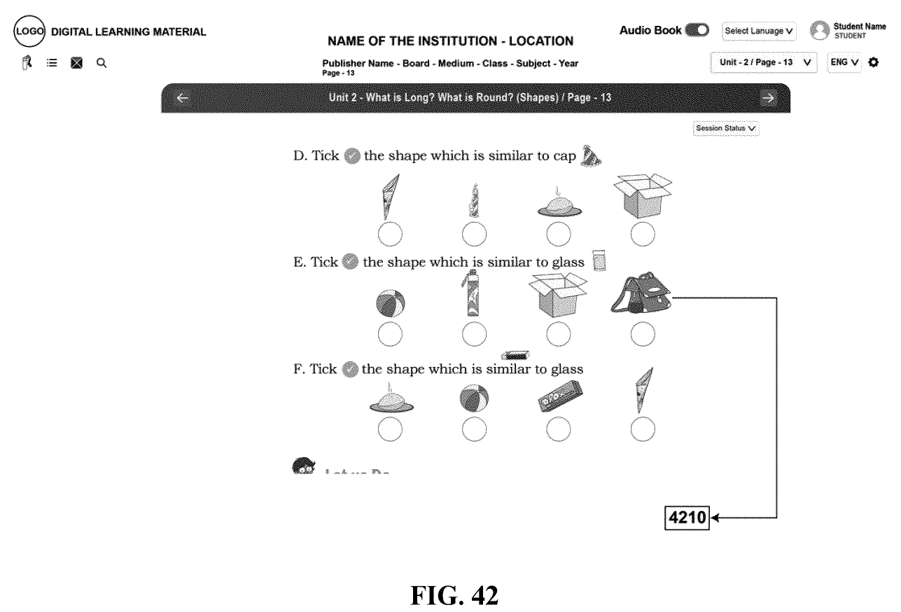

Referring to FIG. 42 the audio-visual interactive digital learning material with learning exercises and assessments (4200) includes, (4210) the student can observe the answers (pictures) alongside corresponding questions, here the task for the student is to select the correct answer from the options provided.

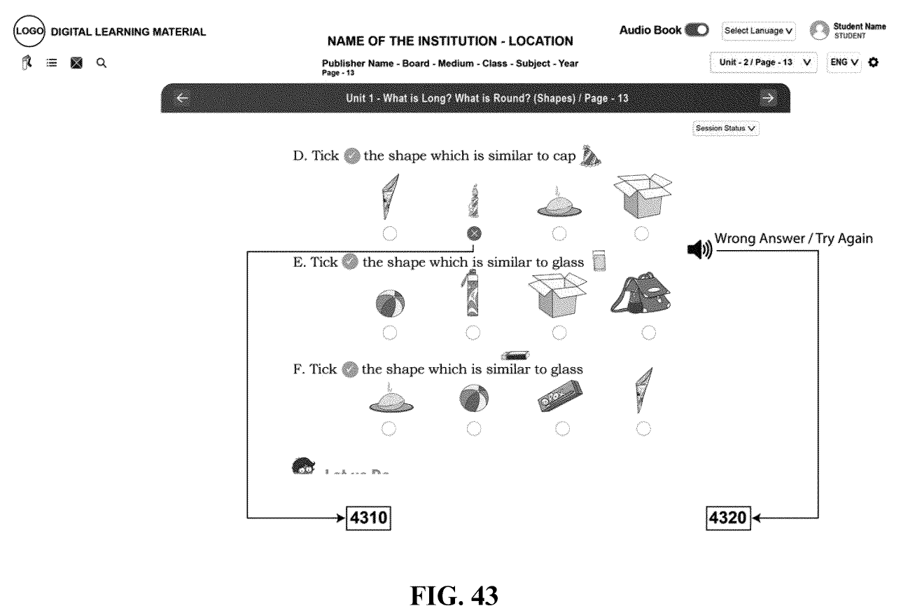

Referring to FIG. 43 the audio-visual interactive digital learning material with learning exercises and assessments (4300) includes, (4310) the user clicks on an incorrect item, it can be identified by the visual representation of the incorrect icon (4320) an audio message communicates feedback, such as “try again” or “wrong answer”.

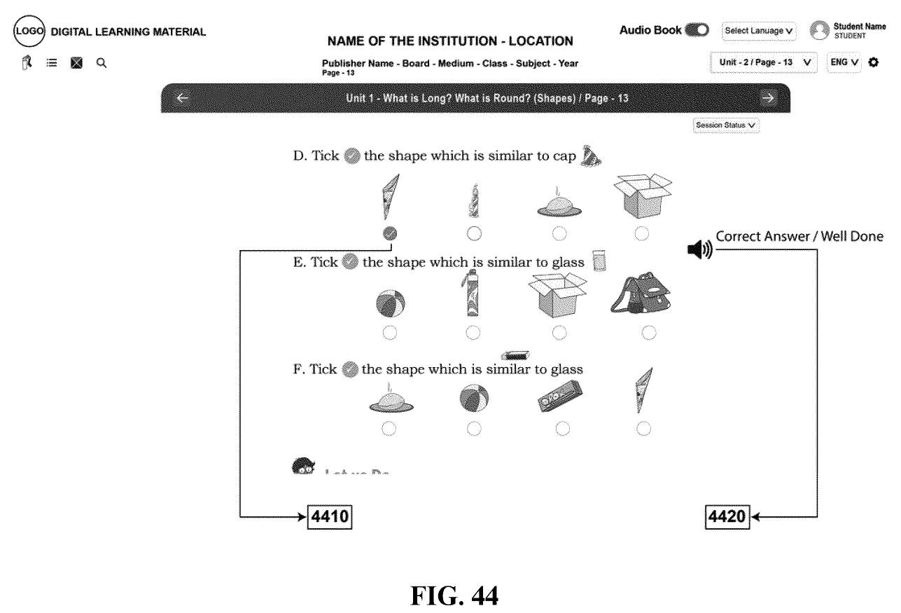

Referring to FIG. 44 the audio-visual interactive digital learning material with learning exercises and assessments (4400) includes, (4410) the student has made a subsequent attempt to select the correct item for the answer and the user clicks on a correct item, it can be identified by the visual representation of the correct icon, (4420) an audio message communicates feedback, such as “well done” or “correct answer”.

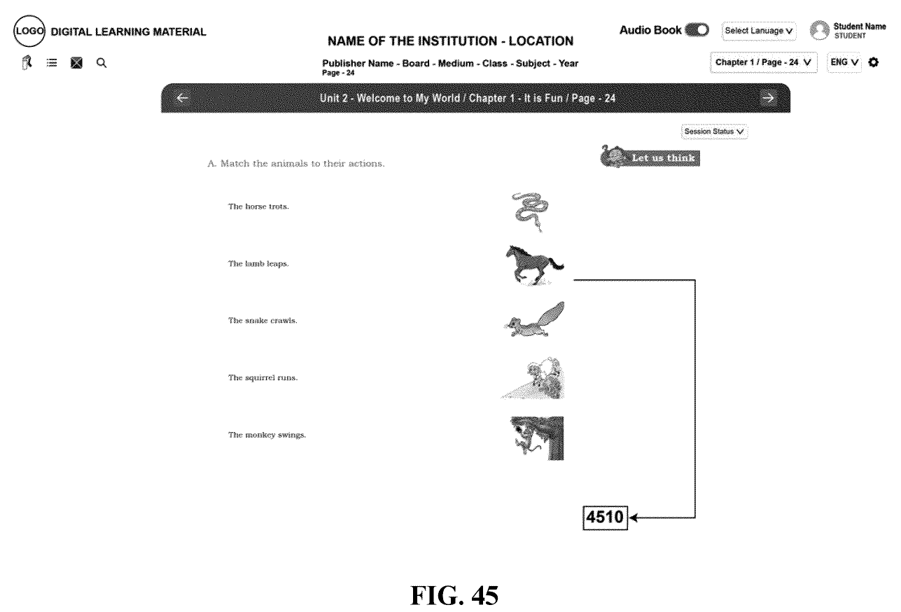

Referring to FIG. 45 the audio-visual interactive digital learning material with learning exercises and assessments (4500) includes, (4510) the user is tasked with matching items on both sides correctly. The user can drag and drop the images on the right side to the relevant content on the left side.

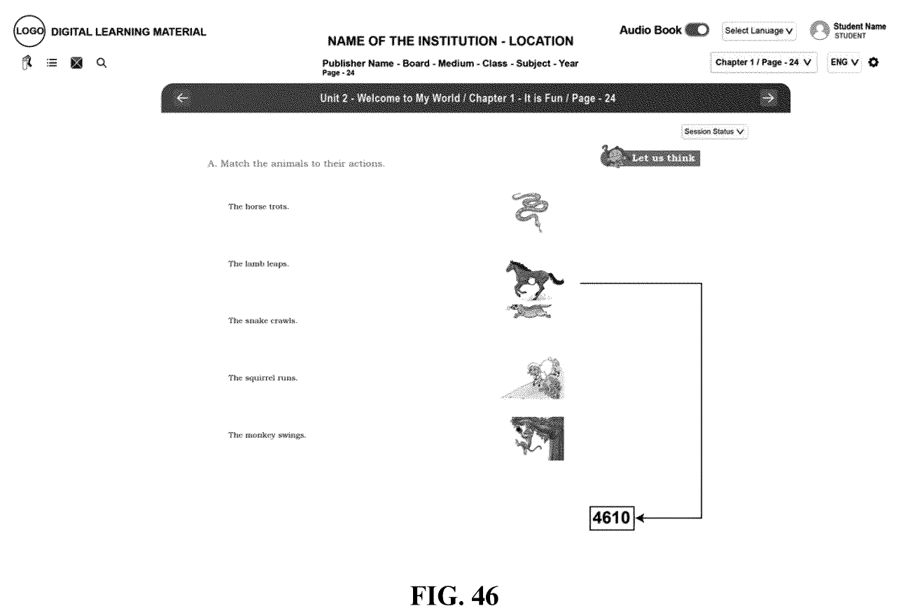

Referring to FIG. 46 the audio-visual interactive digital learning material with learning exercises and assessments (4600) includes, (4610) the user is dragging one of the images on the right side to place it next to the corresponding content on the left side.

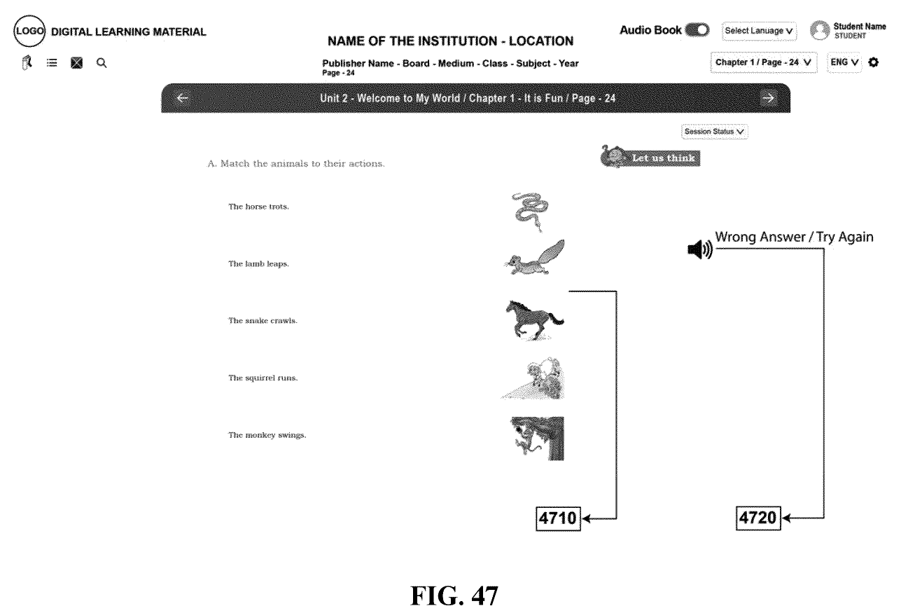

Referring to FIG. 47 the audio-visual interactive digital learning material with learning exercises and assessments (4700) includes, (4710) the user has successfully dropped an image on the right side next to the corresponding content on the left side, (4720) upon completing the matching exercise, the user received audio feedback stating “try again” or “wrong answer” for matching the content and image incorrectly.

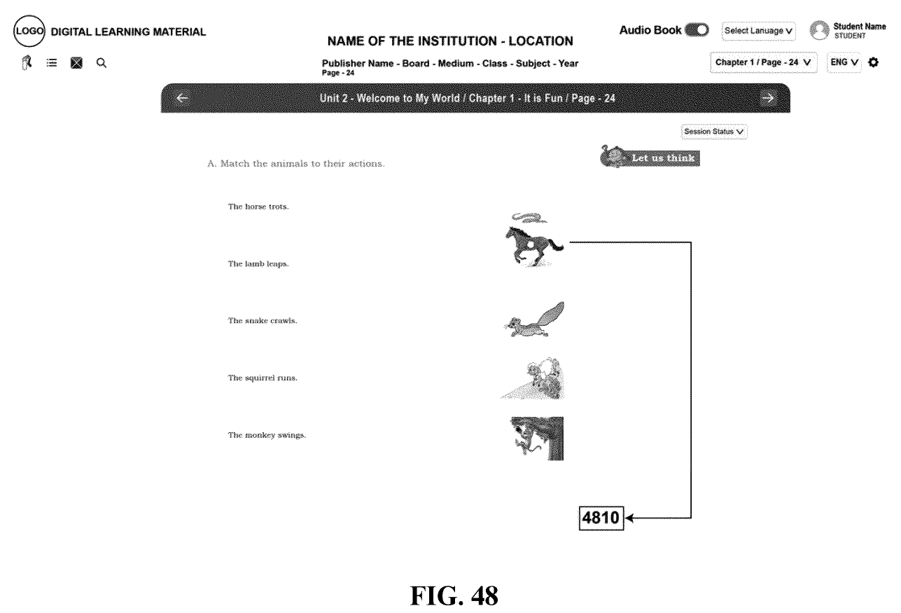

Referring to FIG. 48 the audio-visual interactive digital learning material with learning exercises and assessments (4800) includes, (4810) the user has made a subsequent attempt to select the correct answer by dragging one of the images on the right side to place it next to the corresponding content on the left side, upon recognizing that the previously selected answer was incorrect.

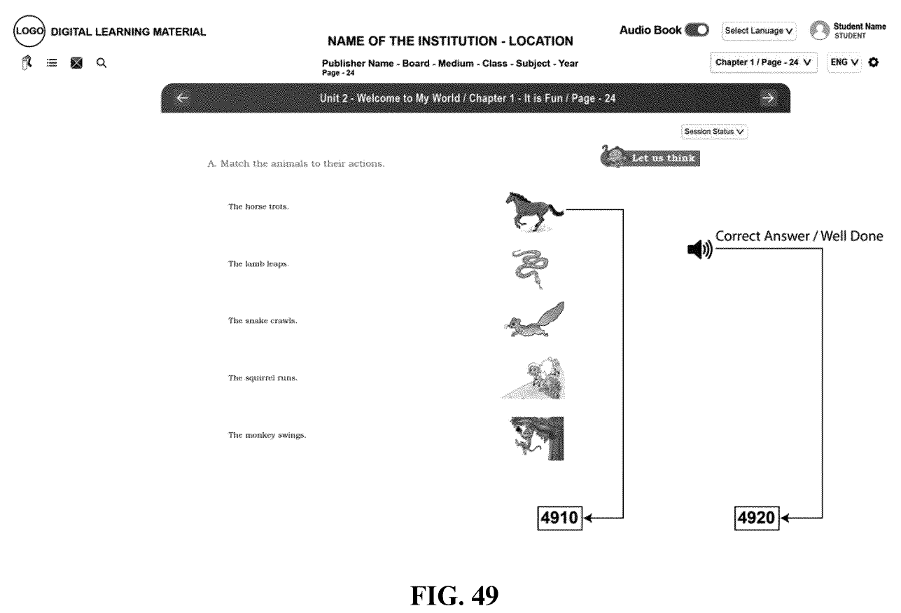

Referring to FIG. 49 the audio-visual interactive digital learning material with learning exercises and assessments (4900) includes, (4910) the user has successfully dropped an image on the right side next to the corresponding content on the left side, (4920) upon completing the matching exercise, the user received audio feedback stating “well done” or “correct answer” for matching the content and image correctly.

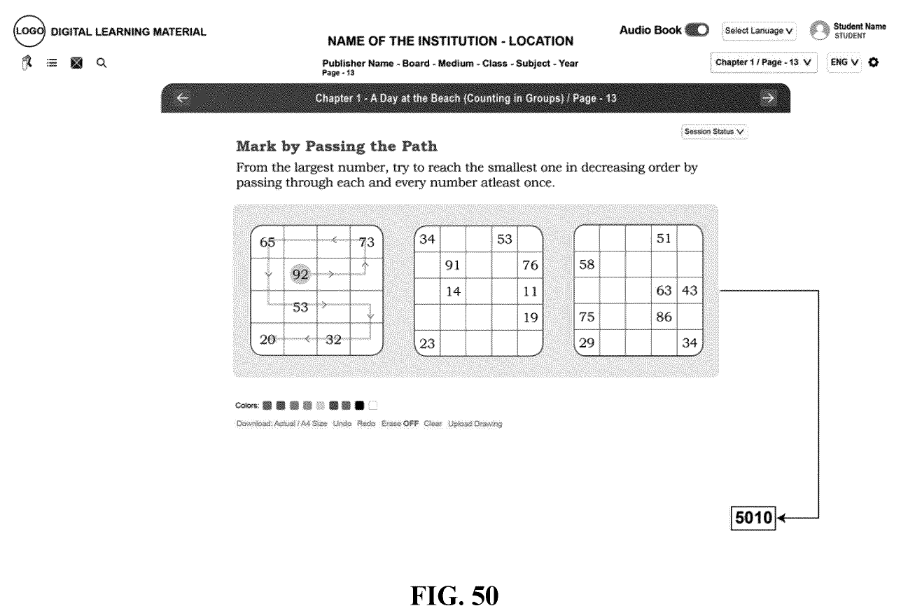

Referring to FIG. 50 the audio-visual interactive digital learning material with learning exercises and assessments (5000) includes, (5010) the user is tasked with drawing a line inside the box according to the question prompt, without touching or crossing the line, the user draws the line from the smallest number to the largest number, where the numbers are arranged in a shuffled manner within the box.

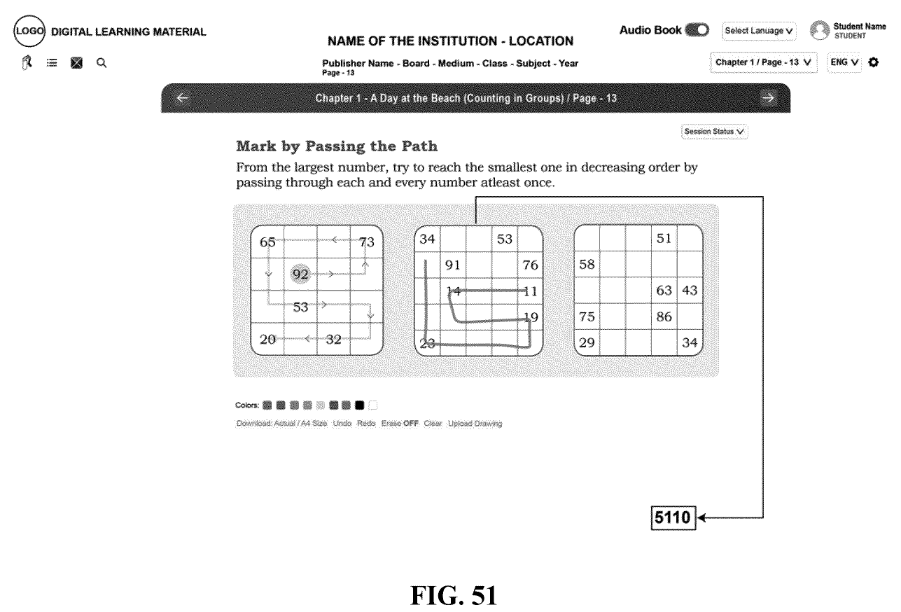

Referring to FIG. 51 the audio-visual interactive digital learning material with learning exercises and assessments (5100) includes, (5110) the user is actively engaged in drawing a line inside the box as instructed by the question prompt, ensuring that the line does not intersect or touch itself.

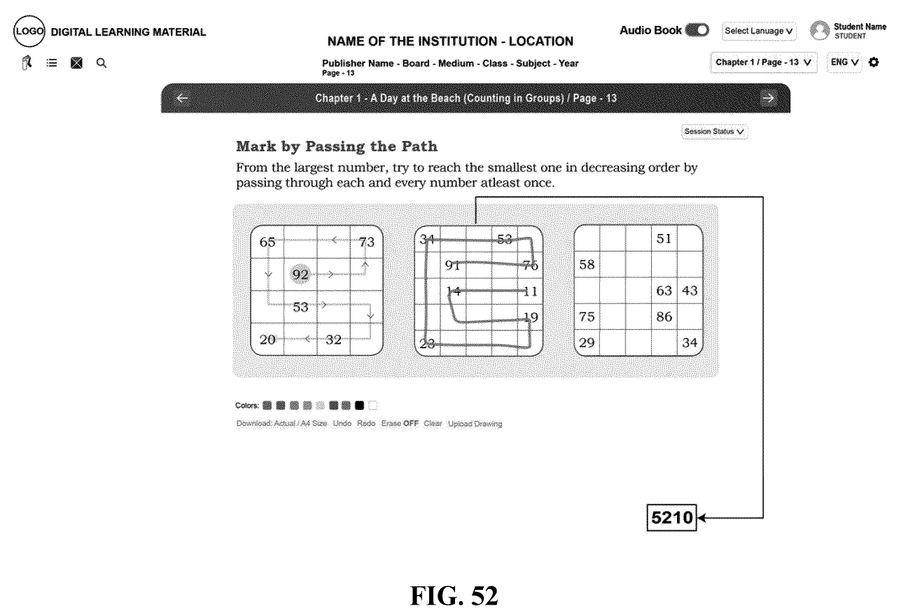

Referring to FIG. 52 the audio-visual interactive digital learning material with learning exercises and assessments (5200) includes, (5210) the user has successfully completed the task of drawing a line from the smallest number to the largest number inside the box, adhering to the instructions provided.

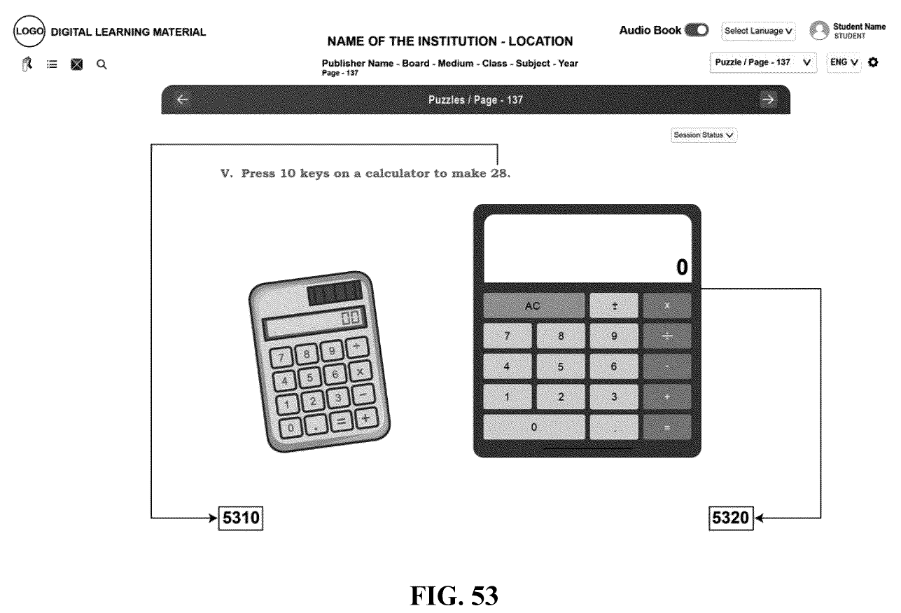

Referring to FIG. 53 the audio-visual interactive digital learning material with learning exercises and assessments (5300) includes, (5310) the user views the question to solve the problem, (5320) the user can access the calculator tool, allowing them to perform calculations and solve the problem.

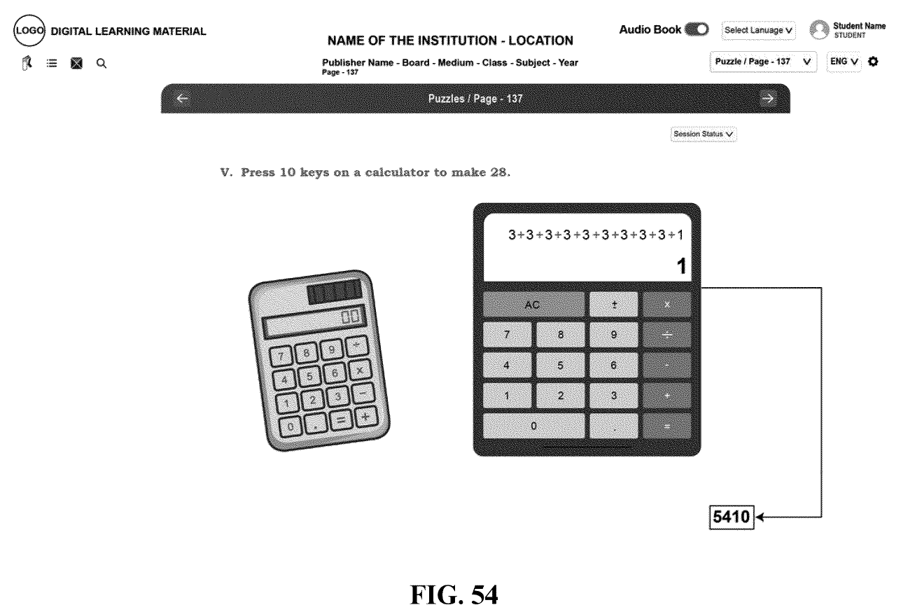

Referring to FIG. 54 the audio-visual interactive digital learning material with learning exercises and assessments (5400) includes, (5410) the user is utilizing the calculator to solve the mathematical question.

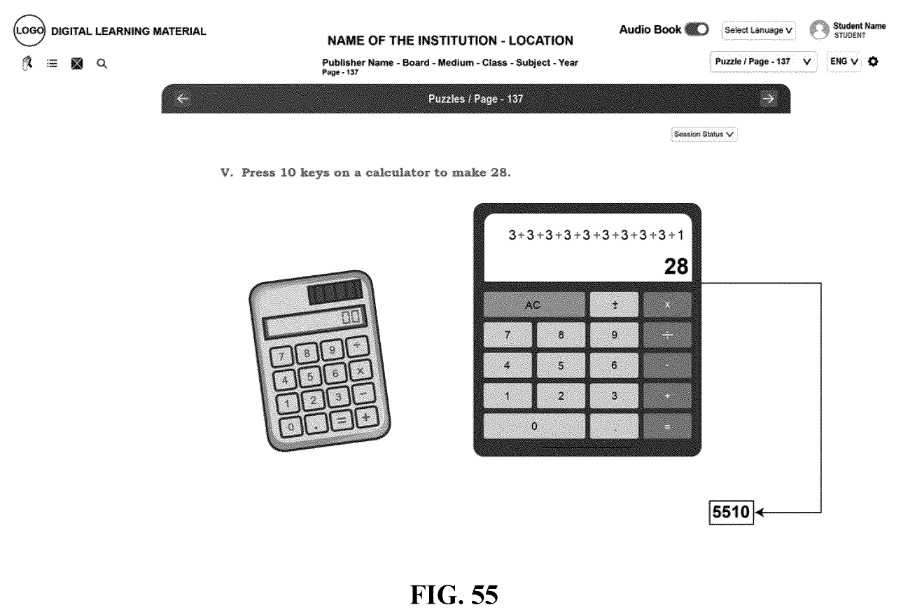

Referring to FIG. 55 the audio-visual interactive digital learning material with learning exercises and assessments (5500) includes, (5510) the user has successfully completed the calculations using the embedded calculator within the digital learning material interface and has found the solution for the question.

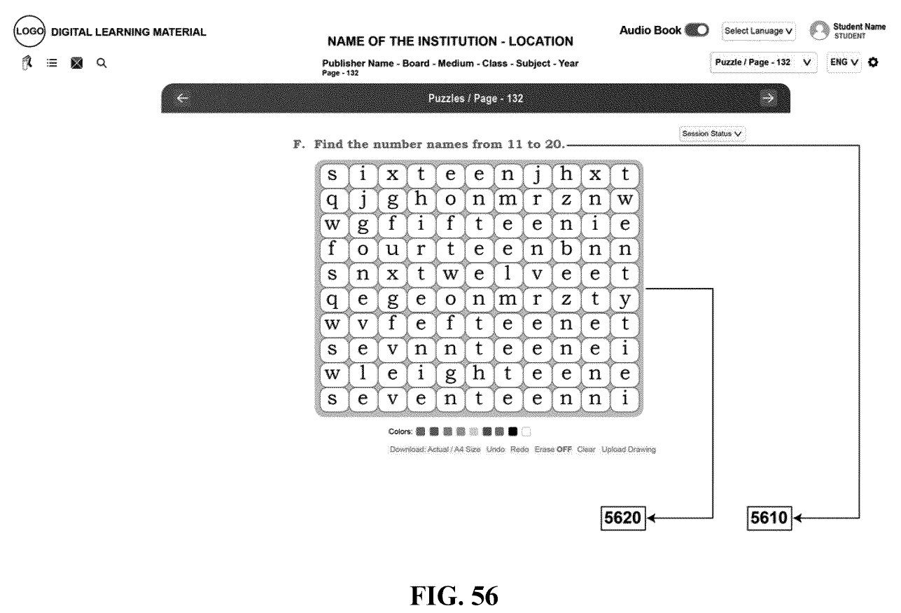

Referring to FIG. 56 the audio-visual interactive digital learning material with learning exercises and assessments (5600) includes, (5610) the user views the question to solve the puzzle, (5620) the user navigates through the interactive puzzle box to reveal the hidden words.

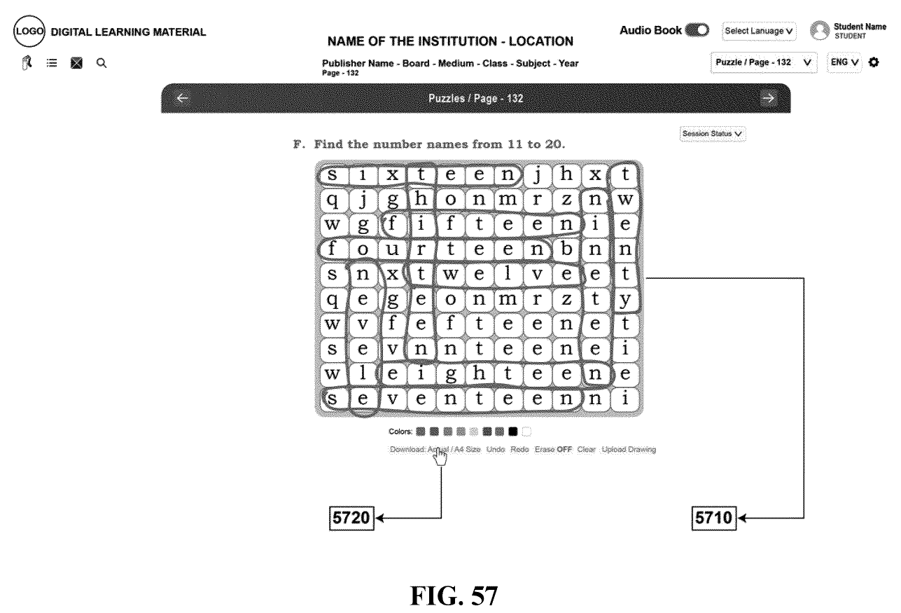

Referring to FIG. 57 the audio-visual interactive digital learning material with learning exercises and assessments (5700) includes, (5710) the user successfully identifies and marks the hidden words within the puzzle box based on the question presented, (5720) the user can click the download button to download the solved puzzle for further reference in the required format.

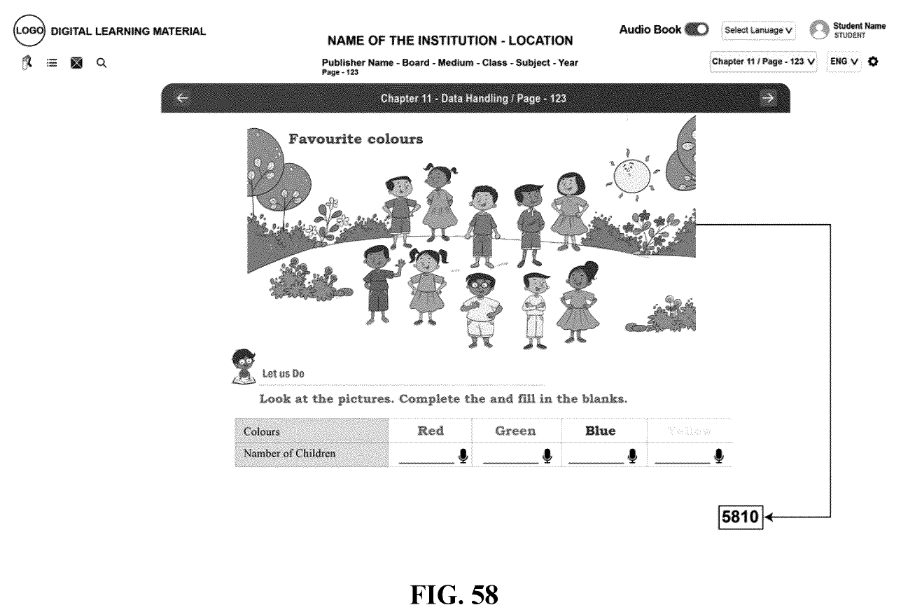

Referring to FIG. 58 the audio-visual interactive digital learning material with learning exercises and assessments (5800) includes, (5810) the user engages with the picture and will provides answers to questions raised based on the content of the pictures.

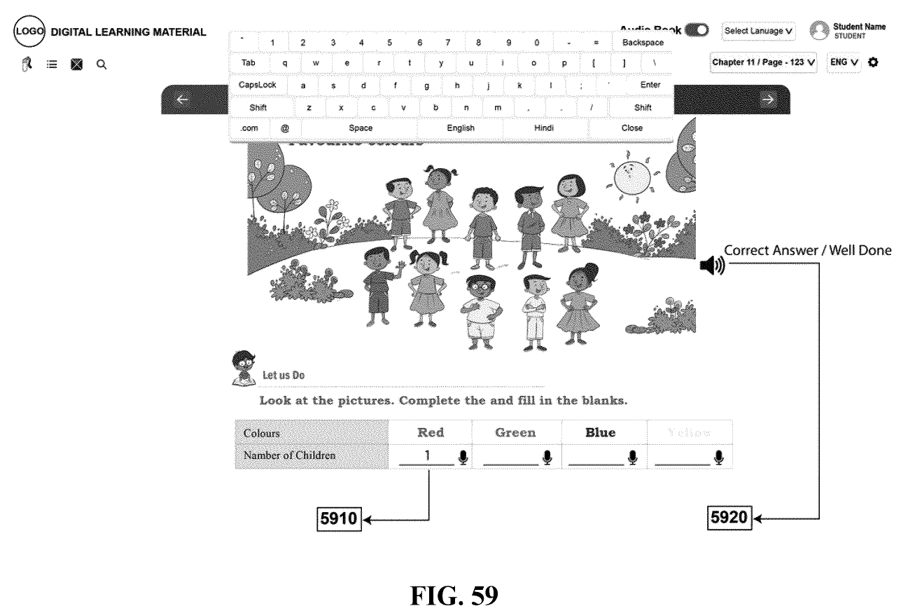

Referring to FIG. 59 the audio-visual interactive digital learning material with learning exercises and assessments (5900) includes, (5910) the user inputs the answer to the question using numerical characters, (5920) the user received audio feedback stating “well done” or “correct answer”.

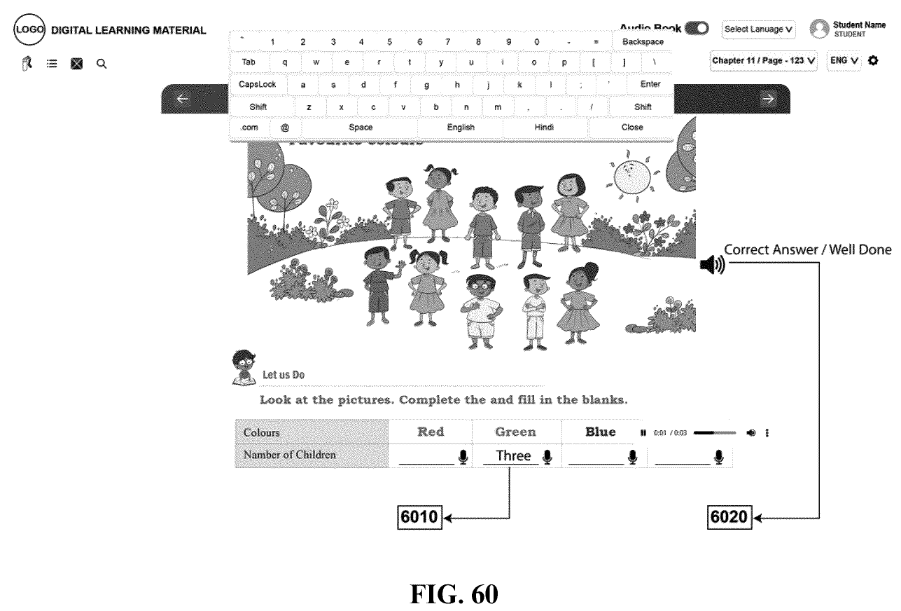

Referring to FIG. 60 the audio-visual interactive digital learning material with learning exercises and assessments (6000) includes, (6010) users are prompted to respond to a question related to the picture content, the user inputs the numerical answer using words (alphabetical characters), (6020) the user received audio feedback stating “well done” or “correct answer”.

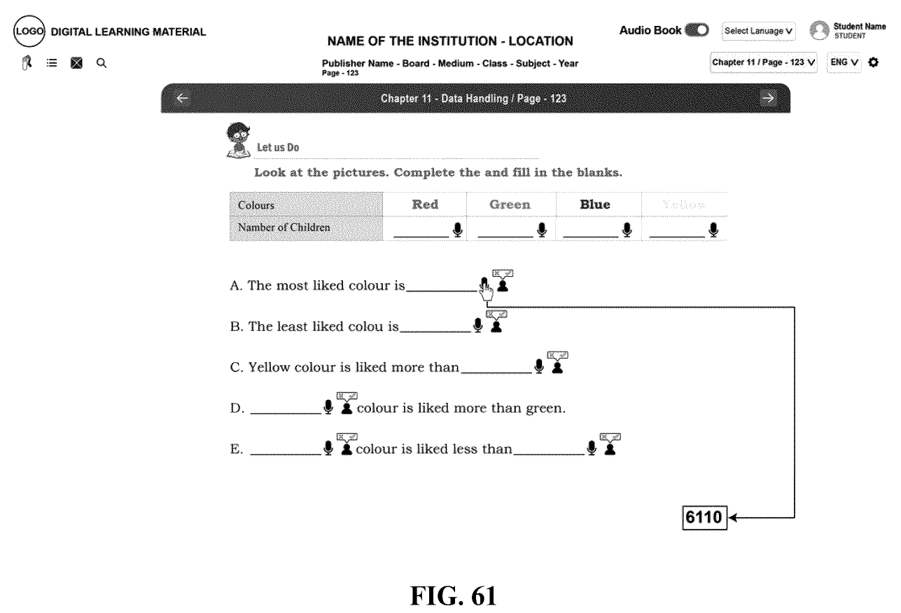

Referring to FIG. 61 the audio-visual interactive digital learning material with learning exercises and assessments (6100) includes, (6110) the user engages with the learning material by clicking on the microphone icon to answer a question using voice mode which helps users to interact with the material in a hands-free manner.

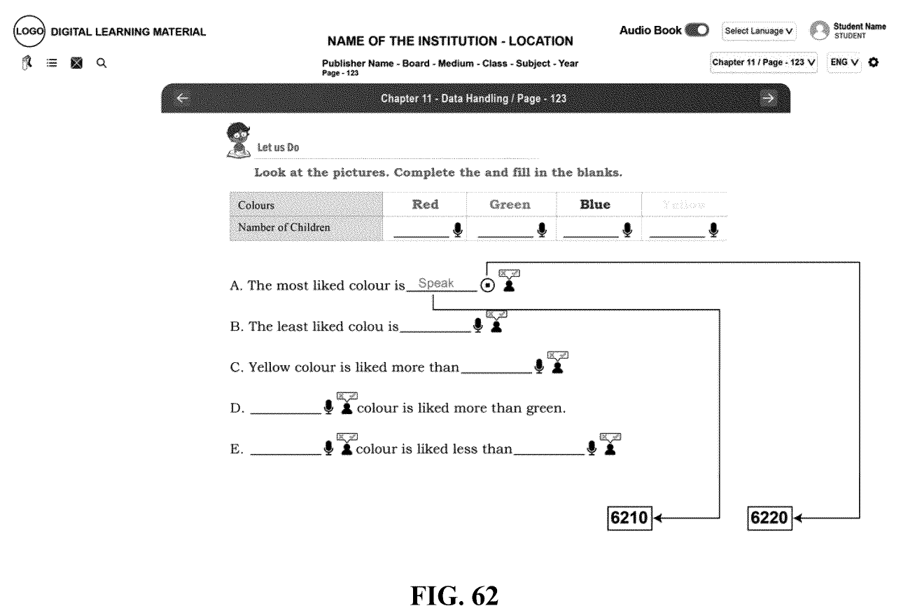

Referring to FIG. 62 the audio-visual interactive digital learning material with learning exercises and assessments (6200) includes, (6210) user can proceed to send the recorded voice message as their answer, (6220) the user has the option to stop recording their voice message by clicking on the stop icon after answering a question.

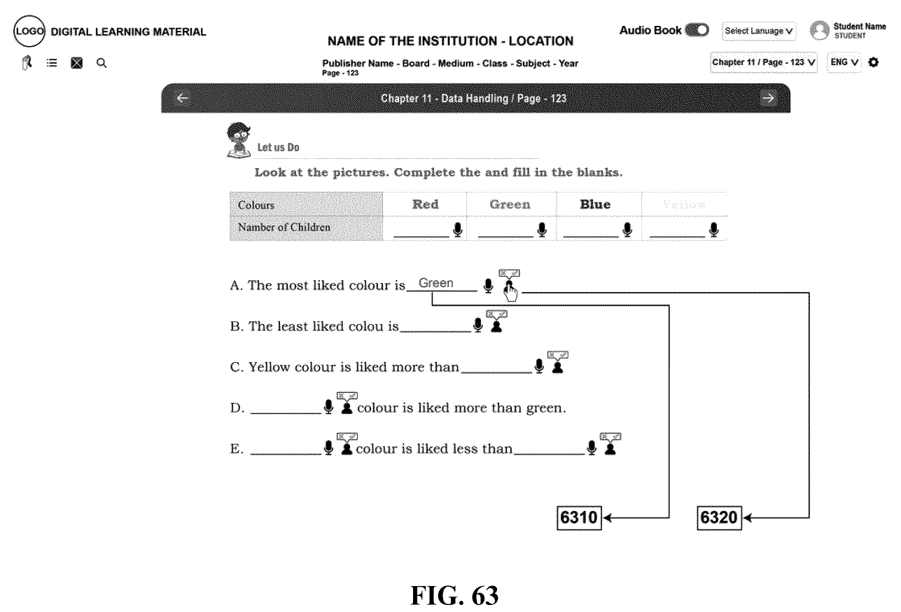

Referring to FIG. 63 the audio-visual interactive digital learning material with learning exercises and assessments (6300) includes, (6310) the user views the typed answer generated from the voice message they sent, (6320) the user clicks the answer verification icon to get the feedback of the answer immediately.

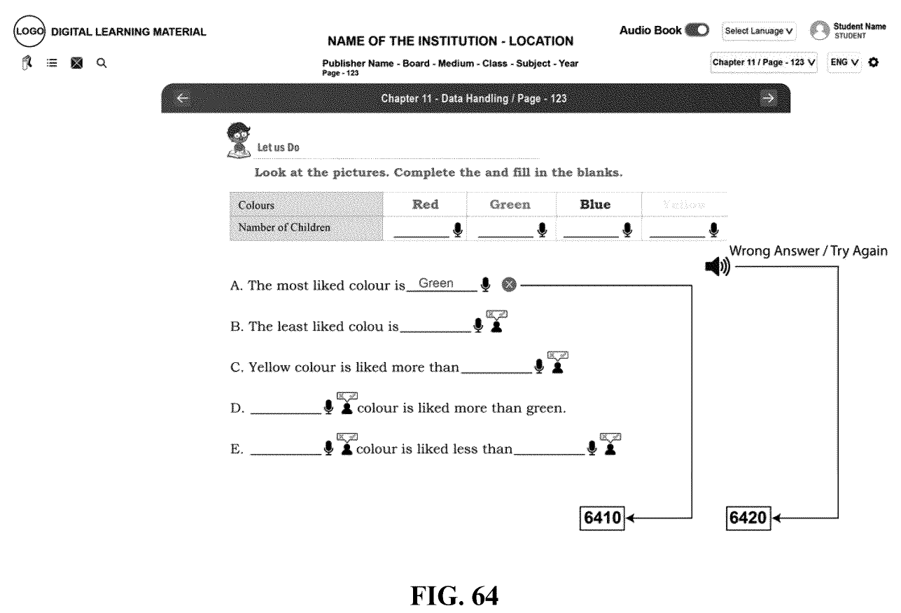

Referring to FIG. 64 the audio-visual interactive digital learning material with learning exercises and assessments (6400) includes, (6410) a visual notification icon emphasizing the incorrect response (6420) the user received audio feedback stating “try again” or “wrong answer” for filling the incorrect answer.

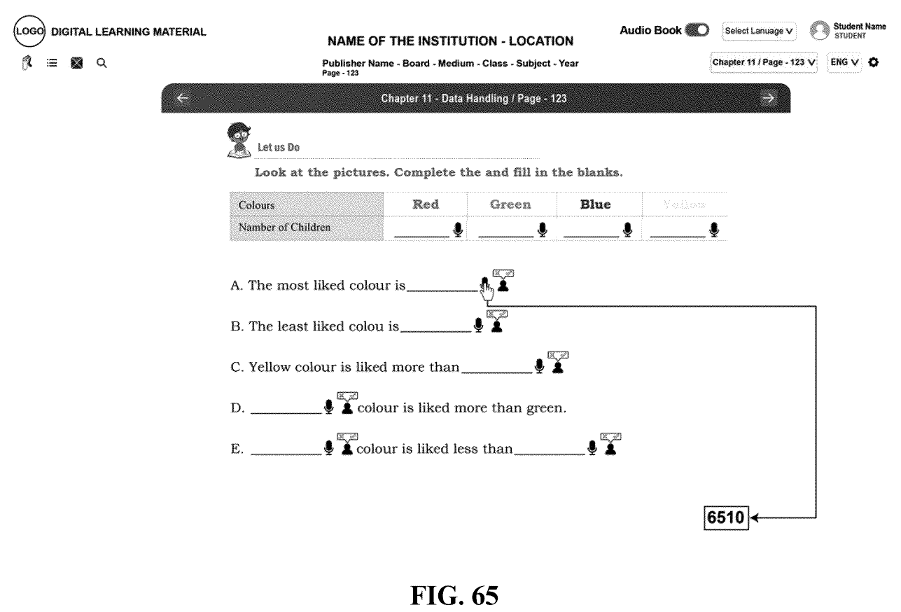

Referring to FIG. 65 the audio-visual interactive digital learning material with learning exercises and assessments (6500) includes, (6510) the user engages with the learning material by clicking on the microphone icon to answer the same question through voice mode.

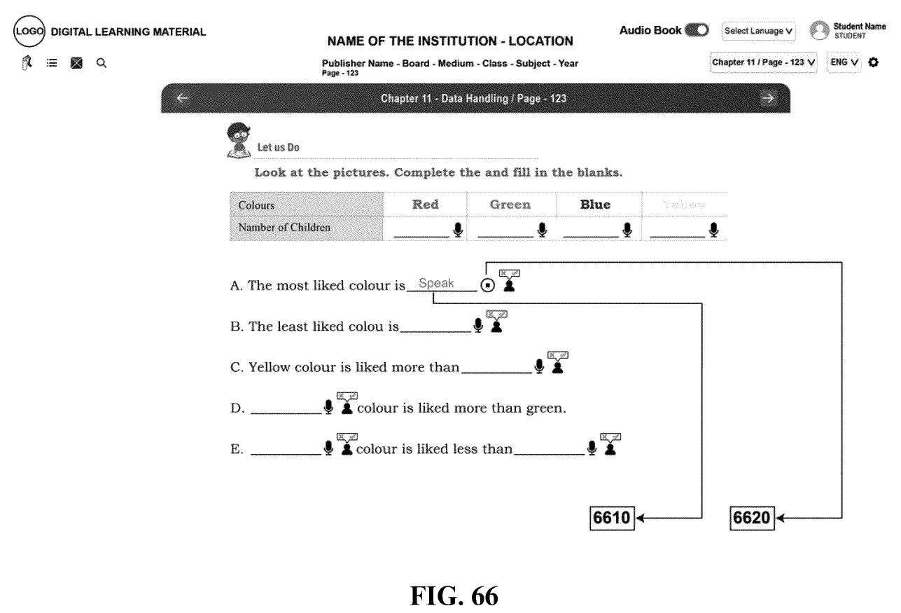

Referring to FIG. 66 the audio-visual interactive digital learning material with learning exercises and assessments (6600) includes, (6610) user can proceed to send the recorded voice message as their answer, (6620) the user has the option to stop recording their voice message by clicking on the stop icon after answering a question.

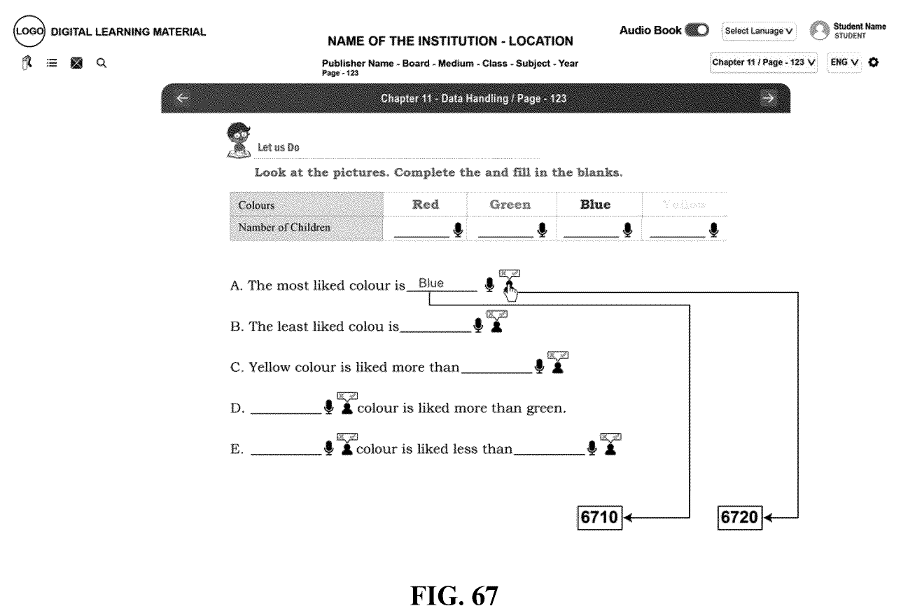

Referring to FIG. 67 the audio-visual interactive digital learning material with learning exercises and assessments (6700) includes, (6710) the user views the typed answer generated from the voice message they sent, (6720) the user clicks the answer verification icon to get the feedback of the answer immediately.

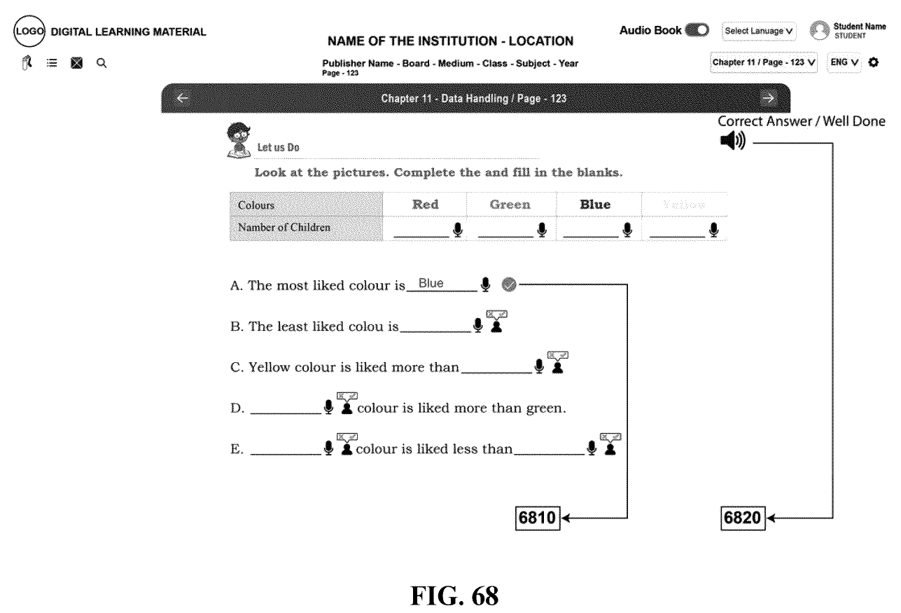

Referring to FIG. 68 the audio-visual interactive digital learning material with learning exercises and assessments (6800) includes, (6810) a visual notification icon emphasizing the correct response (6820) the user received audio feedback stating “well done” or “correct answer” for filling the correct answer.

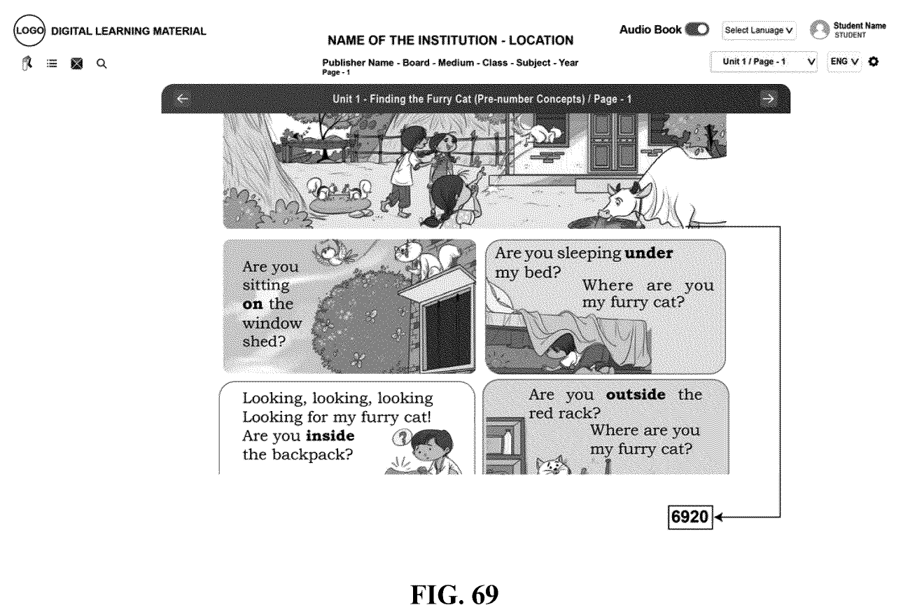

Referring to FIG. 69 the audio-visual interactive digital learning material with learning exercises and assessments (6900) includes, (6910) the student is tasked with selecting the correct answer from the multiple options given.

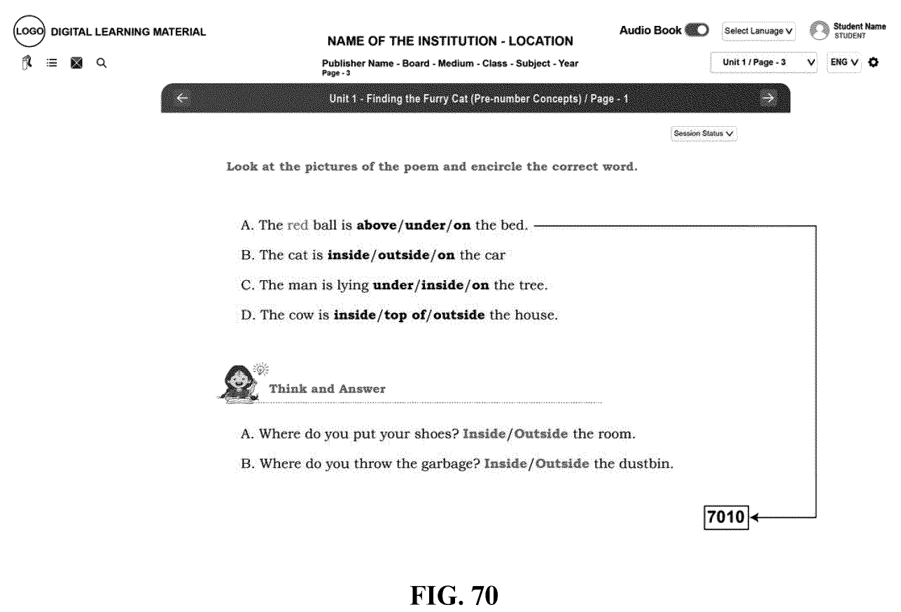

Referring to FIG. 70 the audio-visual interactive digital learning material with learning exercises and assessments (7000) includes, (7010) the user engages with the picture and will provides answers to questions raised based on the content of the pictures.

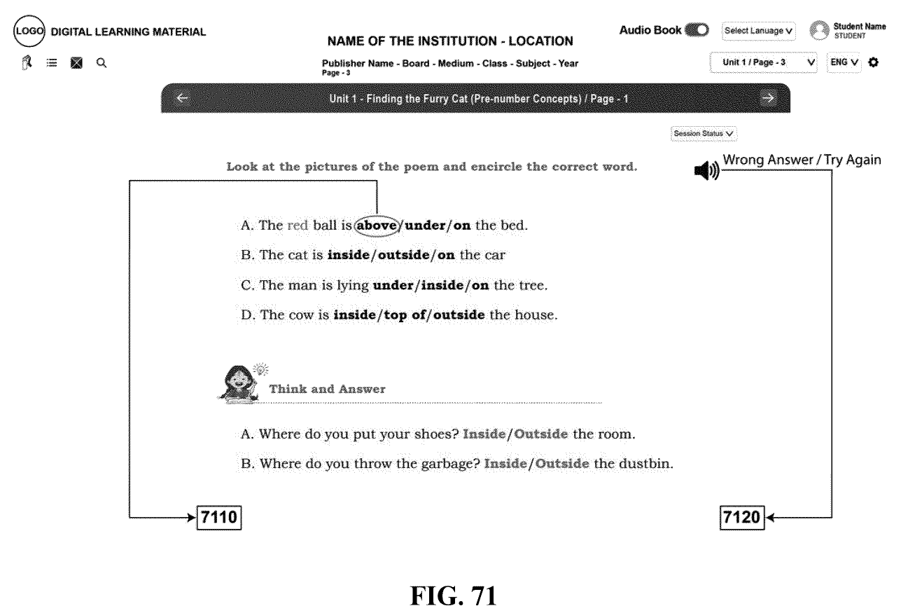

Referring to FIG. 71 the audio-visual interactive digital learning material with learning exercises and assessments (7100) includes, (7110) the user is in the process of selecting the correct answer for the question raised relevant to the picture, the user clicks on an incorrect answer, which is denoted by the answer being encircled in red circle, (7120) an audio message communicates feedback, such as “try again” or “wrong answer”, in accordance with the disclosed embodiments.

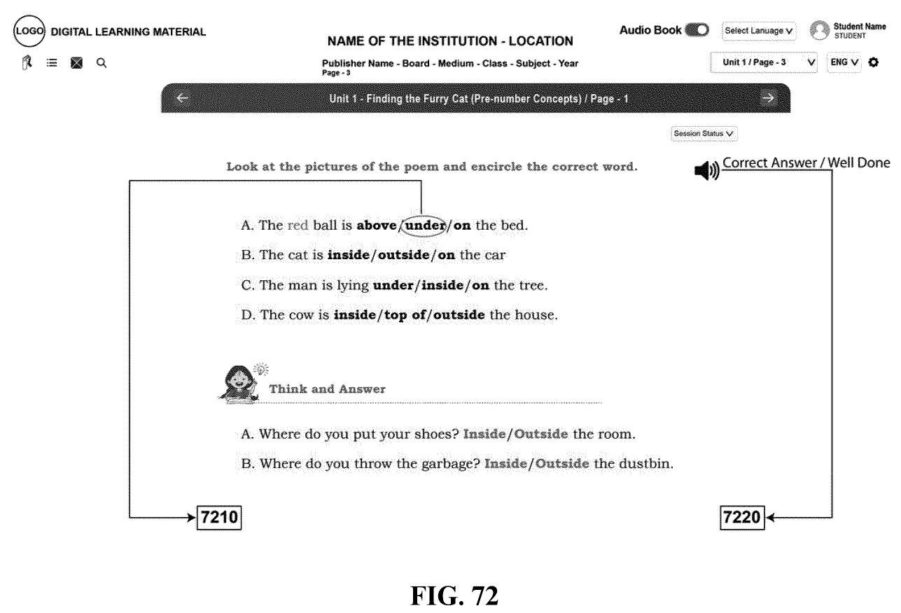

Referring to FIG. 72 the audio-visual interactive digital learning material with learning exercises and assessments (7200) includes, (7210) the user is in the process of selecting the correct answer from the multiple options given, the user clicks on a correct answer, as denoted by the item being encircled in green circle, (7220) an audio message communicates feedback, such as “well done” or “correct answer”.

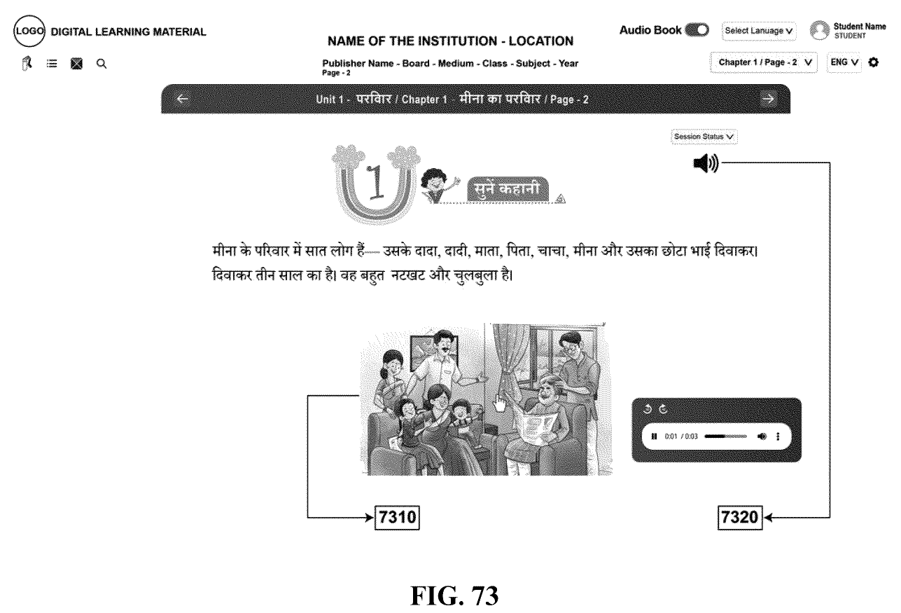

Referring to FIG. 73 the audio-visual interactive digital learning material with learning exercises and assessments (7300) includes, (7310) the student engages with a picture, on clicking the picture, (7320) the user triggers an audio feature that provides a detailed explanation of the picture's content.

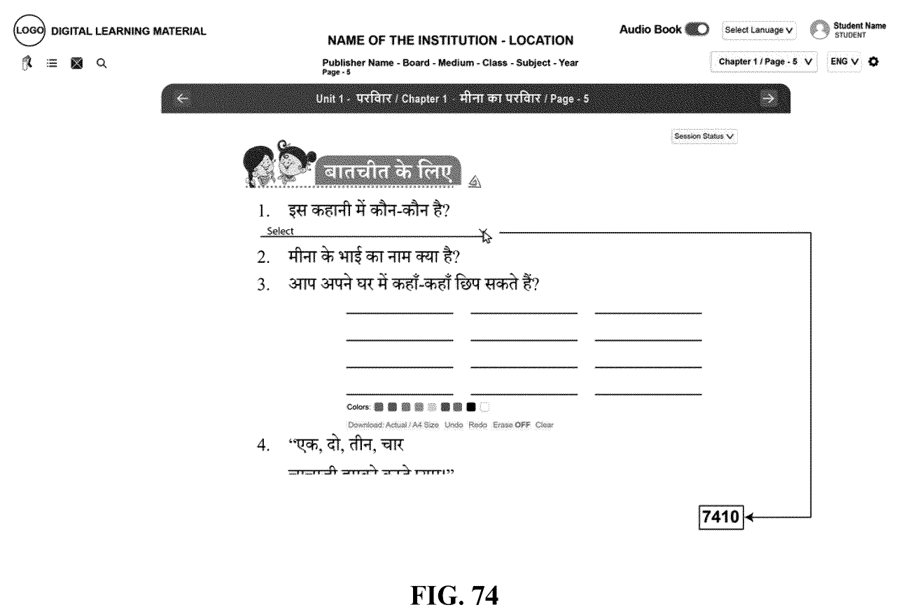

Referring to FIG. 74 the audio-visual interactive digital learning material with learning exercises and assessments (7400) includes, (7410) the student encounters a set of questions presented alongside various answering options, here user will involve in selecting the answer from a drop-down list.

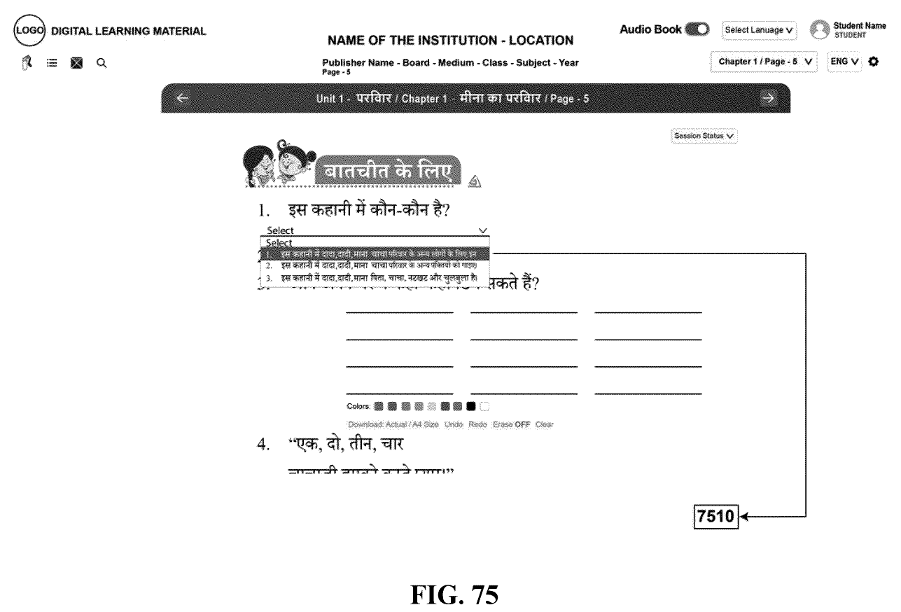

Referring to FIG. 75 the audio-visual interactive digital learning material with learning exercises and assessments (7500) includes, (7510) the student selects one of the answers from the drop-down list.

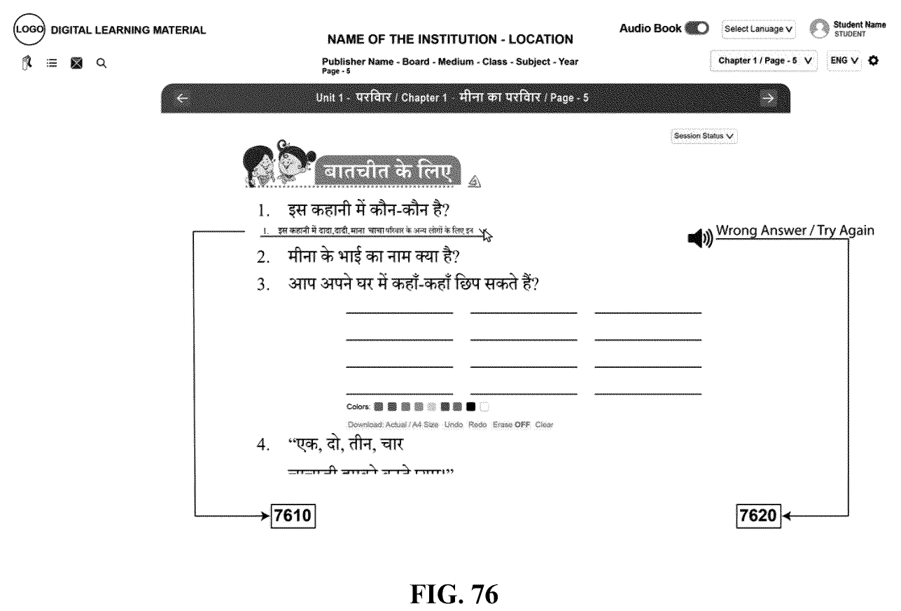

Referring to FIG. 76 the audio-visual interactive digital learning material with learning exercises and assessments (7600) includes, (7610) the answer selected by the user from the drop-down list (7620) an audio message accompanies the selection, offering guidance like “try again” or “wrong answer” for the selected incorrect answer.

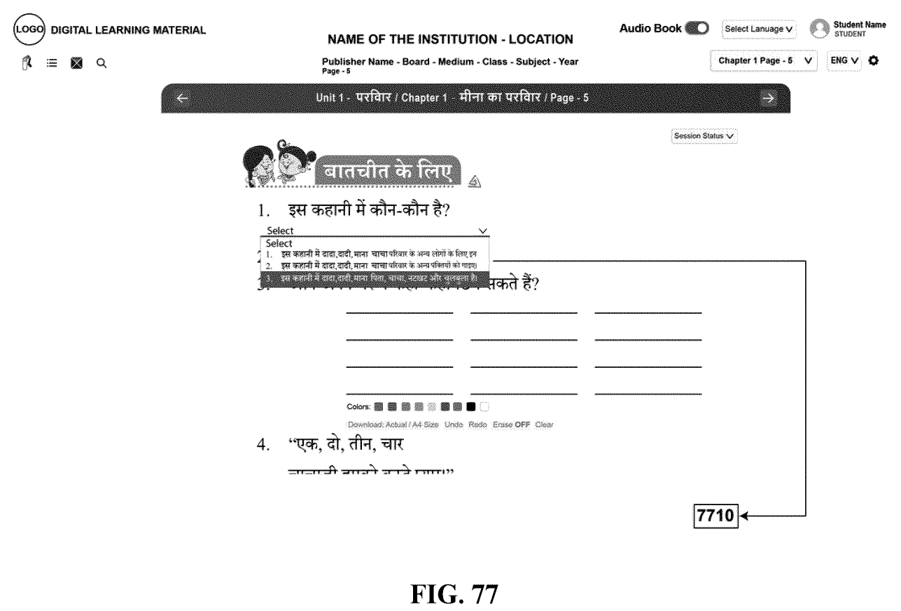

Referring to FIG. 77 the audio-visual interactive digital learning material with learning exercises and assessments (7700) includes, (7710) the student has made a subsequent attempt to select the correct answer from the drop-down list.

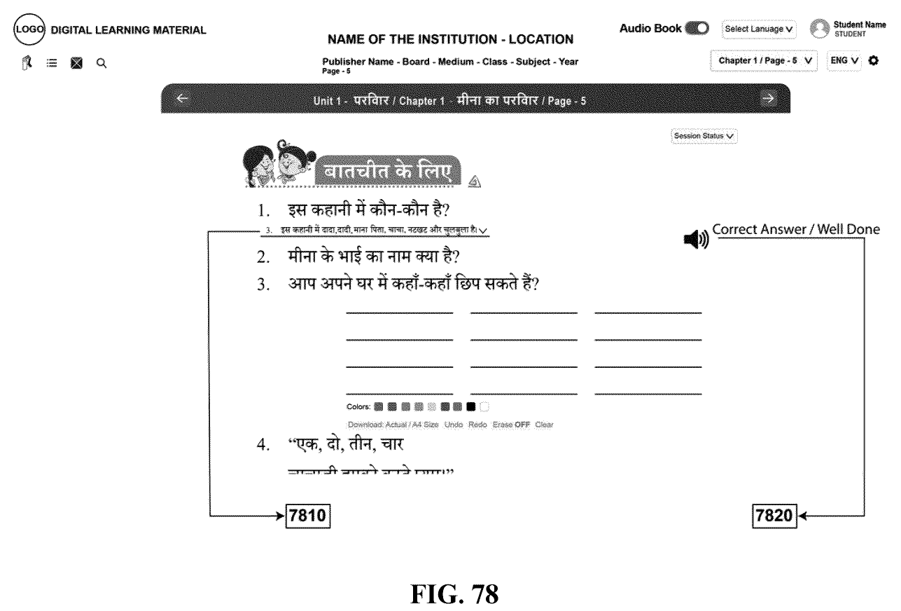

Referring to FIG. 78 the audio-visual interactive digital learning material with learning exercises and assessments (7800) includes, (7810) the answer selected by the user from the drop-down list, (7820) an audio message provides feedback, affirming correct answers with messages like “well done” or “correct answer”, thereby encouraging and reinforcing learning outcomes within the interactive educational environment.

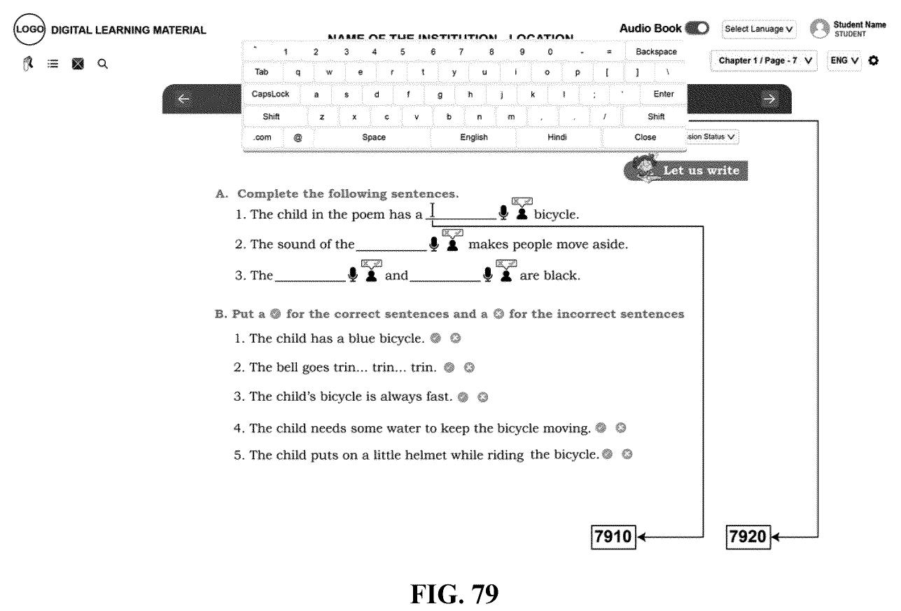

Referring to FIG. 79 the audio-visual interactive digital learning material with learning exercises and assessments (7900) includes, (7910) users opt to answer a question, (7920) the virtual keyboard embedded within the interface becomes active, facilitating direct typing of responses.

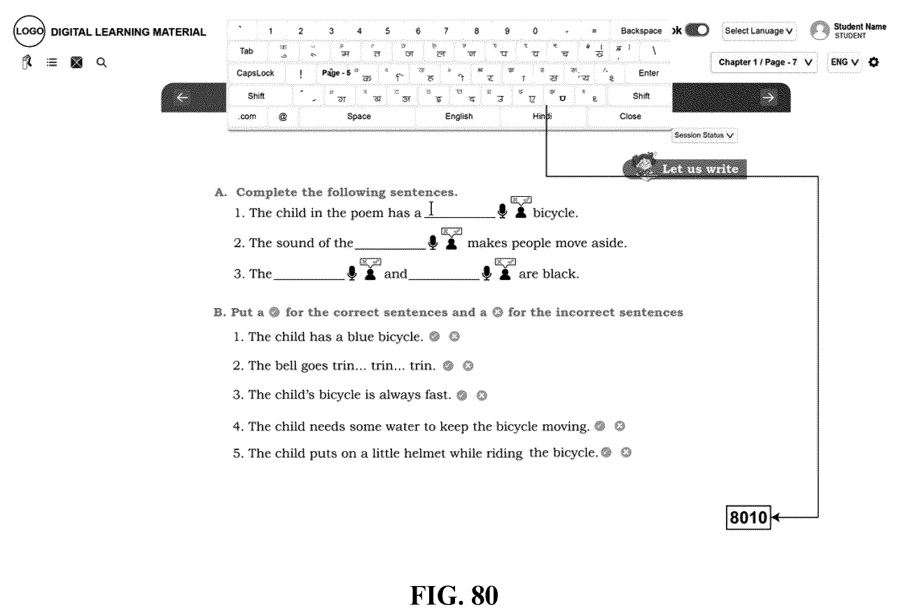

Referring to FIG. 80 the audio-visual interactive digital learning material with learning exercises and assessments (8000) includes, (8010) the user interacts with the virtual keyboard to select multiple language options for typing their answer. This feature enables users to input responses in their preferred language, aligning with the content of the digital learning material.

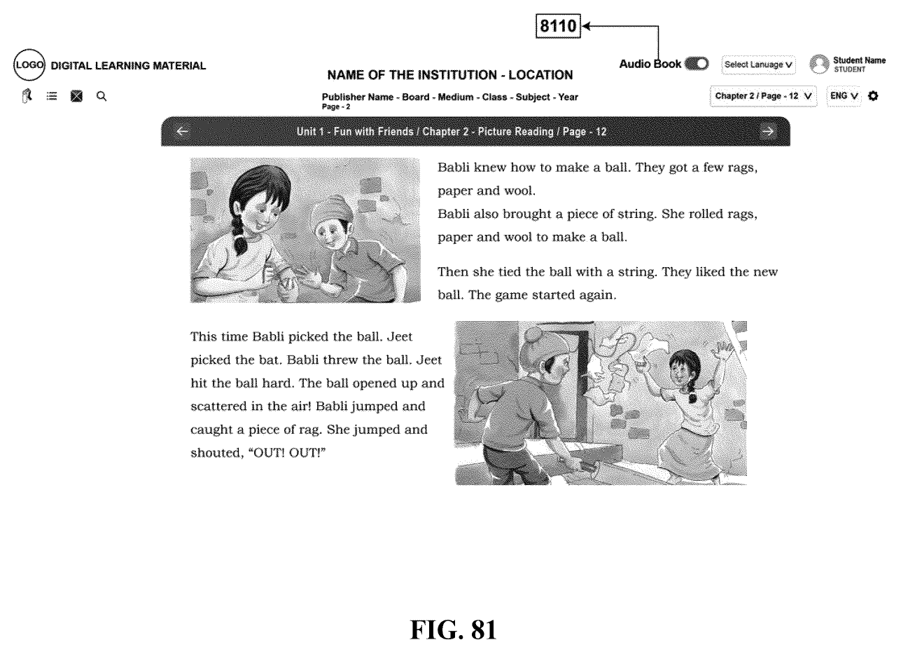

Referring to FIG. 81 the audio-visual interactive digital learning material with learning exercises and assessments (8100) includes, (8110) the digital learning material is automatically enabled with the audiobook format, indicated by the toggle button being enabled by default.

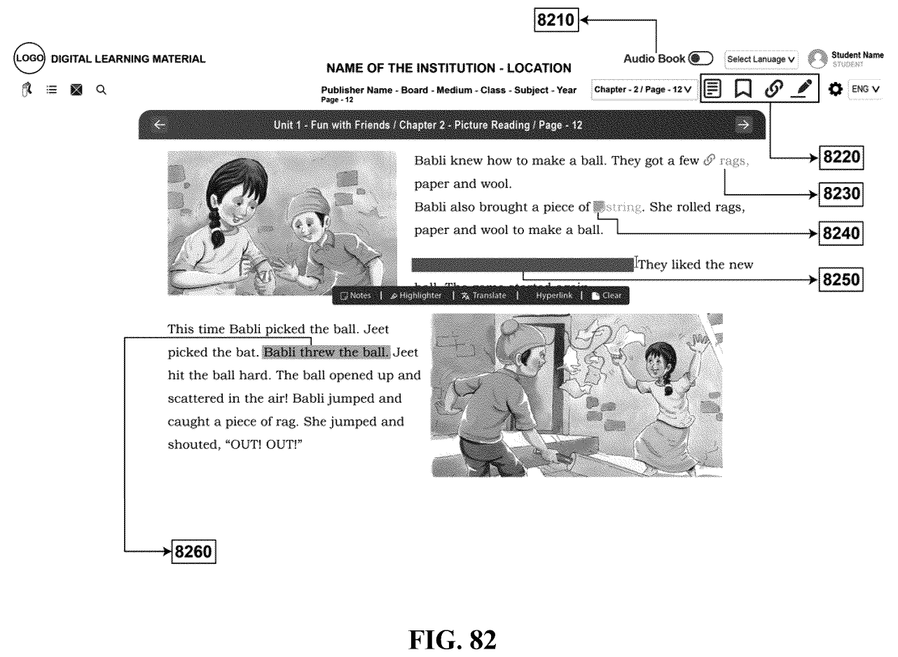

Referring to FIG. 82 the audio-visual interactive digital learning material with learning exercises and assessments (8200) includes, (8210) the user has disabled the audiobook format by turning off the toggle button and annotations gets enabled, (8220) the user can access and view the previously added annotations such as “Hyperlink,” “Highlighter,” and “Notes” by clicking on their respective icons, (8230) user can view the hyperlinked word, (8240) user can view the notes associated with specific words, (8250) new annotations can be added by selecting specific words, phrases, or sentences within the content, (8260) displays a highlighted sentence.

It will be appreciated those variations of the above-disclosed and other features and functions, or alternatives thereof may be desirably combined into many other different systems or applications. Also, unforeseen or unanticipated alternatives, modifications, variations or improvements therein may be subsequently made by those skilled in the art which are also intended to be encompassed by the following claims.

What is claimed is:

1. A method for accessing audio-visual enhanced interactive digital learning materials featuring visual elements, interactive exercises, and assessments with audio feedback, to enable an interactive learning experience, the method comprising:
storing, a multilingual audio-enabled digital learning material, accessible online or offline, said learning material comprising multiple subjects, each containing numerous sessions within units or chapters,
receiving, a user input to display the multilingual audio-enabled digital learning material, whether online or offline, and allowing the user to select by clicking or touching specific portions of text within the session,
reading, the selected portion of text from the session of an online/offline digital learning material, displayed on a user device's screen, as per the selection of the user's click or touch for the specific session content.

2. The method as claimed in claim 1, wherein the method comprises: enabling the digital learning material with an embedded audio for each session in every unit/chapter of the subject, with an option to listen to the session content of the unit/chapter, by a single click or touch of the user.

3. The method as claimed in claim 1, wherein the digital learning material comprises the interactive audio enabled exercises and assessments, where shuffled pictures, images, text, or numbers on the one side are matched to relevant content on the other side using a drag-and-drop method, with immediate audio feedback provided regarding the matches made.

4. The method as claimed in claim 1, wherein the method comprises: selecting correct answers by encircling them, where the correct answer is distinguished by a color variation of the circle and confirmed by audio feedback.

5. The method as claimed in claim 1, wherein the method comprises: providing an option to fill in the answers for questions, with an immediate audio feedback provided on the accuracy of the answers.

6. The method as claimed in claim 5, wherein the audio feedback for the answers is a customized audio feedback including responses such as “right” or “well done” for correct answers, and “wrong”, or “try again” for the wrong answers provided.

7. The method as claimed in claim 5, wherein the method comprises: allowing a user to draw and color pictures either manually or digitally, based on provided picture guidance or their own creativity and provide an option to upload manually drawn and colored pictures or to download digitally drawn images; and provide an option to the user, to color specific parts of the pictures using a drawing pad in response to questions presented in the learning material exercises.

8. The method as claimed in claim 1, wherein the method comprises providing audio-enabled learning material with a built-in mathematical calculator for performing various mathematical calculations.

9. The method as claimed in claim 1, wherein the method comprises incorporating an integrated multilingual keyboard to support the learning material with multiple language translations, along with corresponding audio proficiencies.

10. The method as claimed in claim 1, wherein the method comprises providing descriptions of pictures or images through the built-in audio reader or by triggering a video.

11. The method as claimed in claim 5, wherein the method comprises providing an option to locate words within a word puzzle depicted in a picture or an image; and an option to draw lines on the puzzle box in response to the raised question.

12. The method as claimed in claim 1, wherein the method comprises answering questions in exercises through an audio message using a microphone; subsequently, providing a response for the given answer through audio feedback, accompanied by a visual indicator denoting the status of the answer.

13. The method as claimed in claim 12, wherein the method comprises selecting the answer from a drop-down menu and the feedback for the selected answer can be given through audio message.

14. An audio-visual enhanced interactive digital learning material system for accessing advanced audio interactive learning content featuring visual elements, interactive exercises, and assessments with audio feedback, said system being configured to:
store, a multilingual audio-enabled digital learning material, accessible online or offline, said learning material comprising multiple subjects, each containing numerous sessions within units or chapters,
receive, a user input to display the multilingual audio-enabled digital learning material, whether online or offline, and allow the user to select by clicking or touching specific portions of text within the session,
read, the selected portion of text from the session of an online/offline digital learning material, displayed on a user device's screen, as per the selection of the user's click or touch for the specific session content.

15. The system as claimed in claim 14, wherein the system is configured to: enable the digital learning material with an embedded audio for each session in every unit/chapter of the subject, with an option to listen the session content of the unit/chapter, by a single click or touch of the user.

16. The system as claimed in claim 14, wherein the digital learning material comprises the interactive audio enabled exercises and assessments, where shuffled pictures, images, text, or numbers on the one side are matched to relevant content on the other side using a drag-and-drop method, with immediate audio feedback provided regarding the matches made.

17. The system as claimed in claim 14, wherein the system is configured to: select correct answers by encircling them, where the correct answer is distinguished by color variation of the circle and confirmed by audio feedback.

18. The system as claimed in claim 14, wherein the system is configured to: provide an option to fill in the answers for questions, with an immediate audio feedback provided on the accuracy of the answers.

19. The system as claimed in claim 18, wherein the audio feedback for the answers is a customized audio feedback including responses such as “right” or “well done” for correct answers and “wrong”, or “try again” for the wrong answers provided.

20. The system as claimed in claim 18, wherein the system is configured to: allow a user to draw and color pictures either manually or digitally, based on provided picture guidance or their own creativity and provide an option to upload manually drawn and colored pictures or to download digitally drawn images; and provide an option to color specific parts of the pictures using a drawing pad in response to questions presented in the learning material exercises.

21. The system as claimed in claim 14, wherein the system is configured to provide audio-enabled learning material with a built-in mathematical calculator for performing various mathematical calculations.

22. The system as claimed in claim 14, wherein the system is configured to incorporate an integrated multilingual keyboard to support the learning material with multiple language translations, along with corresponding audio proficiencies.

23. The system as claimed in claim 14, wherein the system is configured to provide descriptions of pictures or images through the built-in audio reader or by triggering a video.

24. The system as claimed in claim 18, wherein the system is configured to provide an option to locate words within a word puzzle depicted in a picture or an image; and an option to draw lines on the puzzle box in response to the raised question.

25. The system as claimed in claim 14, wherein the system is configured to provide an option of answering questions in exercises through an audio message using a microphone; and
subsequently, provide a response for the given answer through audio feedback, accompanied by a visual indicator denoting the status of the answer.

26. The system as claimed in claim 25, wherein the system is configured to provide an option to the user for selection of the answer from a drop-down menu and provide feedback for the selected answer through audio message.

27. The system as claimed in claim 14, wherein the system is device-independent and the system comprises: a server unit configured to: view and store all types of audio interactive digital learning materials with audio-visual content, exercises and assessments along with the interaction option; and a user device configured to: add the relevant audio content for the audio interactive advanced digital learning material, receive the frequently updates or notifications on the clarification raised.

28. A computer program product comprising instructions which, when executed by at least one processor, causes the processor to carry out the instructions for:
storing, a multilingual audio-enabled digital learning material, accessible online or offline, said learning material comprising multiple subjects, each containing numerous sessions within units or chapters,
receiving, a user input to display the multilingual audio-enabled digital learning material, whether online or offline, and allowing the user to select by clicking or touching specific portions of text within the session,
reading, the selected portion of text from the session of an online/offline digital learning material, displayed on a user device's screen, as per the selection of the user's click or touch for the specific session content;
enabling the digital learning material with an embedded audio for each session in every unit/chapter of the subject, with an option to listen to the session content of the unit/chapter, by a single click or touch of the user;
selecting the correct answers by encircling them, where the correct answer is distinguished by a color variation of the circle and confirmed by audio feedback;
providing an option to fill in the answers for questions, with an immediate audio feedback provided on the accuracy of the answers, wherein the audio feedback for the answers is a customized audio feedback including responses such as “right” or “well done” for correct answers and “wrong”, or “try again” for the wrong answers provided;
allowing a user to draw pictures based on either provided picture guidance or user-generated creative drawings and option to download the picture drawing from the learning material, and colouring specific parts of the pictures using a drawing pad in response to raised questions in the exercise;
providing audio-enabled learning material with a built-in mathematical calculator for performing various mathematical calculations;
incorporating an integrated multilingual keyboard to support the learning material with multiple language translations, along with corresponding audio proficiencies;
providing descriptions of pictures or images through the built-in audio reader or by triggering a video, an option to locate words within a word puzzle depicted in a picture or image;
providing an option to draw lines on the puzzle box in response to the raised question;
providing an option for answering questions in exercises through an audio message using a microphone, and subsequently, providing a response for the given answer through audio feedback, accompanied by a visual indicator denoting the status of the answer; selecting the answer from a drop-down menu and the feedback for the selected answer can be given through audio message,
wherein the digital learning material comprises interactive audio enabled exercises and assessments, where shuffled pictures, images, text, or numbers on the one side are matched to relevant content on the other side using a drag-and-drop method, with immediate audio feedback provided regarding the matches made.
